(19) United States
(12) Patent Application Publication
(10) Pub. No.: US 2024/0211840 A1
(43) Pub. Date: Jun. 27, 2024

(54) MINERAL MANAGEMENT SYSTEM AND HARDWARE/SOFTWARE IMPLEMENTED METHODOLOGIES PROVIDING USER INTERFACE ENABLED DATA ANALYSIS

(71) Applicant: NRM Solutions LLC., Bridgeport, WV (US)

(72) Inventors: Mark B. VAN KIRK, McLean, VA (US); Devin FRANZ, Bridgeport, WV (US); Randall COTTLE, Morgantown, WV (US)

(21) Appl. No.: 18/115,450

(22) Filed: Feb. 28, 2023

Related U.S. Application Data
(60) Provisional application No. 63/314,844, filed on Feb. 28, 2022.

(51) Int. Cl. G06Q 10/0637; G06F 16/25; G06Q 50/02

(52) U.S. Cl. CPC G06Q 10/0637; G06F 16/258; G06Q 50/02

(57) ABSTRACT

Disclosed embodiments provide a mineral rights management system and hardware/software implemented methodologies that provide user interface enabled data analysis of associated data to facilitate owner and analyst understanding of data input from disparate data sources and in disparate data formats.

### CROSS REFERENCE AND PRIORITY CLAIM

This patent application claims priority to U.S. Provisional Patent Application No. 63/314,844 filed on Feb. 28, 2022, the disclosure of which being incorporated herein by reference in its entirety.

### FIELD

Disclosed embodiments relate to the area of mineral rights management analysis.

### BACKGROUND

Conventionally, landowners have been entering into oil/gas leases with organizations that operate to remove that material (“operators”) for over one hundred years. The meaning of terms of these leases and their interpretation, however, is not uniform across the oil and gas industry or geographical areas. This is true internationally and also true within US, wherein controlling regulation, practices and nomenclature are state and region specific.

Mineral rights may encompass many different substance types found in the ground but for the purposes of this disclosure, mineral rights at least include rights associated with oil, natural gas (methane) and Natural Gas Liquids (NGLs, e.g., ethane propane, butane, etc.). When the natural gas produced at a wellhead is almost entirely methane, it is commonly referred to as “dry” gas. When the natural gas is extracted and includes a combination of heavier hydrocarbon molecules such as ethane, propane and butane, for example, it is often referred to as “wet” gas. These hydrocarbon molecules condense to liquid at certain temperatures and/or pressures, hence the name Natural Gas Liquid.

Conventionally, it is known that an owner of a piece of land, ranging from acres to thousands thereof, may sign an agreement with an operator, e.g., a drilling company, and receive production royalties from the wells drilled on the owner's property. Such agreements may be for extracted oil, gas, NGLs or some portion thereof.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

Disclosed embodiments provide a mineral rights management system and hardware/software implemented methodologies that provide user interface enabled data analysis of associated data to facilitate owner and analyst understanding of data input from disparate data sources and in disparate data formats.

### BRIEF DESCRIPTION OF THE FIGURES

These and other features of the present disclosure will become more apparent from the following description of the illustrative embodiments wherein.

FIG. 1 illustrates an example of one potential configuration of backend components of the inventive system provided in accordance with the disclosed embodiments.

FIGS. 2a-11 illustrate various examples and exemplary functionality associated with an analyst dashboard, and a main user dashboard of a user interface provided in accordance with the various disclosed embodiments of the innovative system.

FIGS. 12-14 illustrate various examples and exemplary functionality associated with an annual income screen provided in accordance with the various disclosed embodiments of the innovative system.

FIGS. 15-20 illustrate various examples and exemplary functionality associated with checks and deductions provided in accordance with the various disclosed embodiments of the innovative system.

FIGS. 21-26 illustrate various examples and exemplary functionality associated with map data provided in accordance with the various disclosed embodiments of the innovative system.

FIGS. 27-93 illustrate various examples and exemplary functionality associated with analytics functionality provided in accordance with the various disclosed embodiments of the innovative system, in particular:

FIGS. 27-38 directed to analytics and output of improved data functionality provided on a county basis,

FIGS. 39-51 directed to analytics and output of improved data functionality provided on a district basis,

FIGS. 52-66 directed to analytics and output of improved data functionality provided on a producer basis,

FIGS. 67-80 directed to analytics and output of improved data functionality provided on a well basis,

FIGS. 81-93 directed to analytics and output of improved data functionality provided on a property basis.

FIGS. 94-96 illustrate various examples and exemplary functionality associated with production analytics functionality provided in accordance with the various disclosed embodiments of the innovative system.

FIGS. 97-108 illustrate various examples and exemplary functionality associated with reporting functionality provided in accordance with the various disclosed embodiments of the innovative system.

FIGS. 109-11 illustrate various examples and exemplary functionality associated with automated notification functionality provided in accordance with the various disclosed embodiments of the innovative system.

### DETAILED DESCRIPTION

The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Various embodiments and embodiment variations may be used to assists an oil and gas owner with the management of his or her oil and gas property and royalties. For example, to effectively assist oil and gas owner or customers, the disclosed embodiments make a system that is implemented on a front end as one or more user interfaces that include at least an analyst dashboard user interface and an owner dashboard user interface, as discussed herein and illustrated in the figures.

It is not uncommon for royalties to be set at different rates for the different minerals. For example, when wet gas is extracted, it requires separating out the NGL products from the gas extraction stream. Thereafter, each of the NGLs and the natural gas are processed differently off property. As a result, processing costs associated with the various components of materials affects the production royalties owed to the owner. However, understanding this data is, often, beyond the expertise of the landowner. Accordingly, it is difficult, if not impossible for an owner to determine whether an agreement is the best deal that the owner may achieve in a given market and also whether the production royalties are being paid consistent with the agreement.

To further complicate the situation, the interpretation of such agreements, the nomenclature used in such agreements and industry standards referenced in such agreements, and associated government regulation, are not uniform across the United States, or even within the constituent states. Nevertheless, it is not uncommon for a landowner to own property across multiple counties and multiple states.

As a result, an owner, or analyst assisting the owner, may be required to have a detailed understanding of disparate terminology and legal and tax regulatory requirements to determine how to effectively analyze royalty streams to effectively manage their royalty stream for maximum profit and transparency.

As a result, it is generally impossible, conventionally, for landowners to understand and compare the value of their minerals relative to each other and within their own portfolios. At best, royalty streams are conventionally estimated and highly inaccurate because of the dynamic market driven processing differences present at any given time.

At best, conventional royalty calculators assume an average well yield, e.g., in millions of cubic feet per day. However, as indicated above, processing costs resulting from operator activity vary widely and the extracted mineral components vary widely depending on the geographic location of the well. Thus, the real value of a well depends on, for example, not a single component being extracted, e.g., natural gas, but NGLs as well, provided the NGLs are subject to separate royalty streams in an agreement (which may or may not be the case historically).

Still further, technical aspects of the oil and gas industry further complicate and frustrate the ability for landowners to analyze, understand and forecast yield and, thereafter, royalties. For example, natural gas wells are known to produce at a very high rate during their first few months of production, but fall off thereafter to lower rates.

With all of these issues in mind, disclosed embodiments provide a mineral rights management system and hardware/software implemented methodologies that provide user interface enabled data analysis of associated data to facilitate owner and analyst understanding of data input from disparate data sources and in disparate data formats.

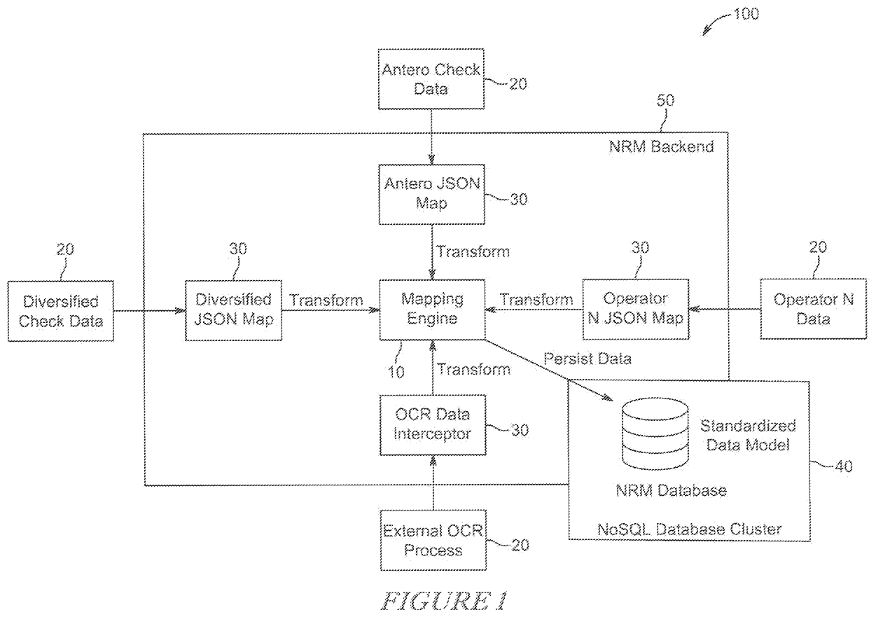

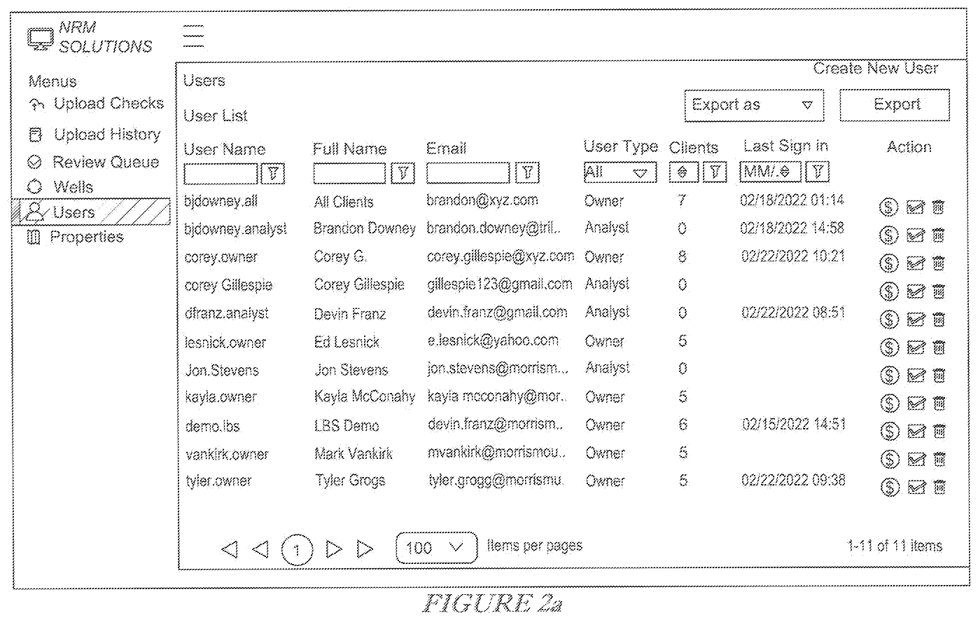

As shown in FIG. 1, a mapping interface engine 10 may serve as a central processing module for a backend to the mineral rights management system 100. That mapping engine 10 may receive input data from various sources 20 (e.g., an external OCR processing module, a diversified check data module, an antero check data module, an operator N data module). Following preprocessing of that data provided by those sources 20 by various preprocessing modules 30 that are specific to the data provided by those sources, the mapping engine 10 analyzes the data to produce a standardized data model implemented database module 40 that provides database structure to store associated data in a structured and consistent manner, regardless of the initial data source or its associated formatting or structural specifics.

As a result of this functionality by provided by the system backend 50 (encompassing the functionality of preprocessing modules 30, mapping engine 10 and database population functionality 40, the stored data may then be used to populate the various dashboard interfaces and their constituent user interface screens disclosed elsewhere herein. Thus, it should be understood that the system 100 includes the hardware and software illustrated in FIG. 1 as well as the hardware and software illustrated in the remaining figures to enable a user to access one or more web-sites, web-site screens, and software applications (either server based or mobile application based) that enable access to, analysis of, and manipulation of the data and functionality illustrated in the figures.

Thus, it should be understood that the disclosed innovative mineral rights management system 100 provision of a front end, e.g., dashboard user interfaces that provide meaningful analysis is the result of both an innovative backend component 50 and an innovative front end component. That backend component 50 receives input data from disparate sources and formats to provide a standard data model based database structure 40 populated with data provided from the various interfaces 20. The innovative front end component leverages that standardized and organized data to provide full picture, understandable and detailed data regardless of the county or region a property or well is located and regardless of the product contributions produced.

As discussed herein, the presently disclosed mineral rights management system and hardware/software implemented methodologies are implemented, at least in part, via computer software code. The attached Appendix includes a subset of that code, which is provided to further illustrate and enable the disclosed functionality.

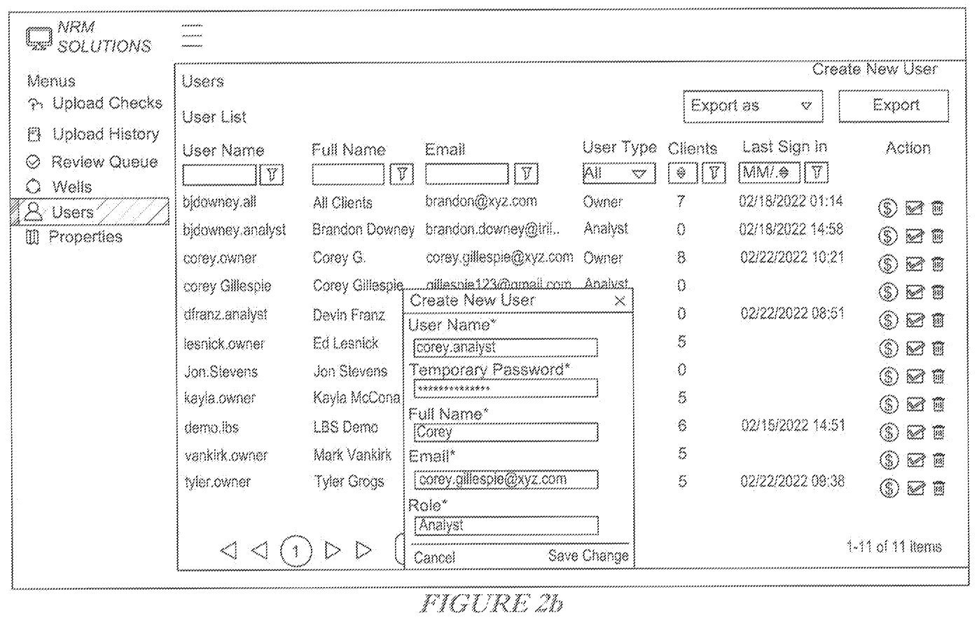

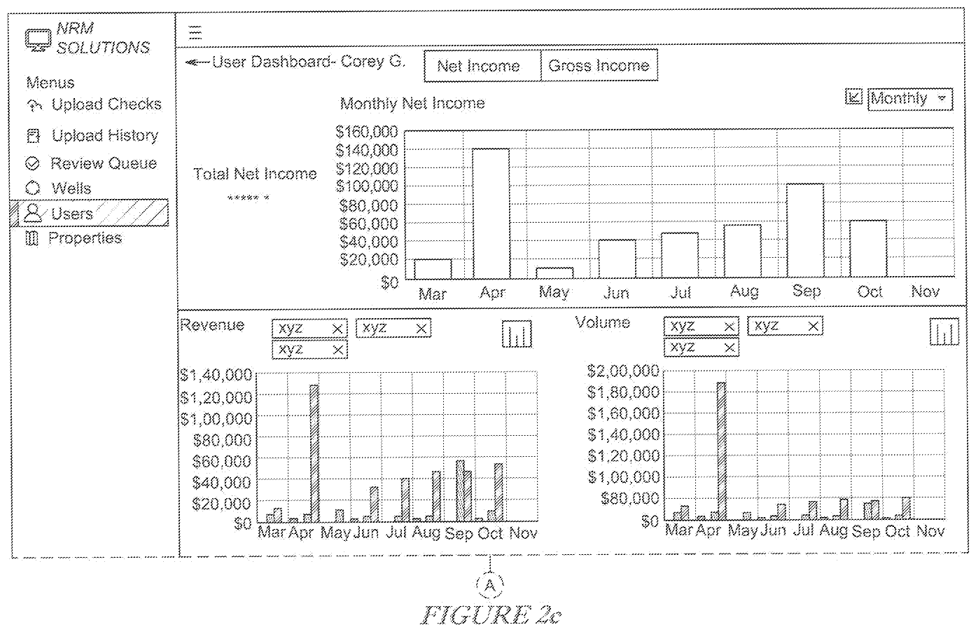

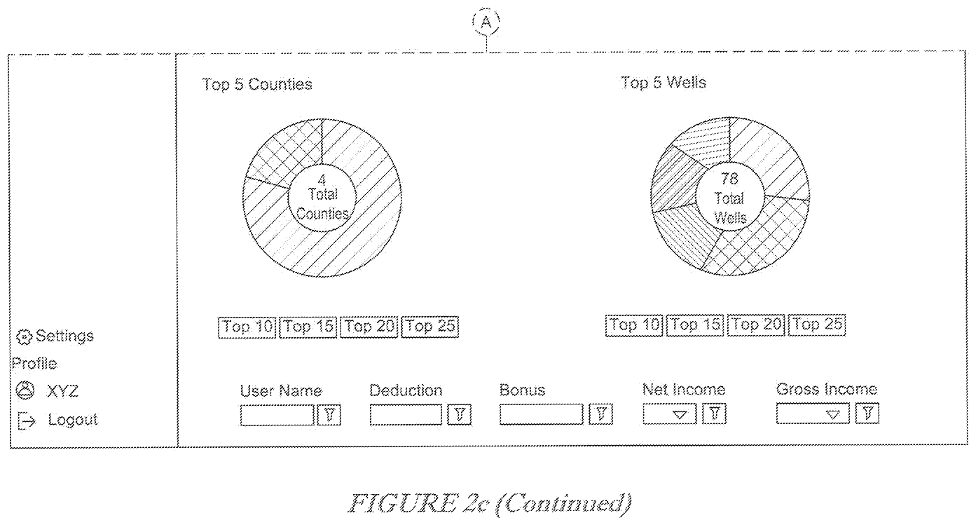

Turning to the description of the figures, it should be understood that, in some disclosed embodiments, there may be different types of dashboards depending on functionality required for analyzing the displayed data. For example, as illustrated in FIGS. 2a-2c an analyst dashboard user interface may enable one or more users (e.g., analysists and administrators) to perform administrative and analytical operations to facilitate the input, processing and output of data associated with mineral production, e.g., oil and/or gas production, on one or more properties.

For example, the functionality provided by the analysis dashboard interface may enable the ability to analyze and help manage oil and gas properties and royalties for an property owner. Accordingly, it should be understood that the analyst dashboard user interface could be used by mineral rights management personnel or even a sophisticated oil and gas owner who does not need such personnel to assist with the management of his or her minerals. Thus, as explained in US Provisional Patent Application No. 63/314,844 filed on Feb. 28, 2022, the disclosure of which being incorporated herein by reference in its entirety, an analyst dashboard user interface may contain separate menu items, for example, upload checks, review queue, upload history, wells, users, and properties. Each menu item in the analyst dashboard may be configured to enable the analyst to add, delete, or manipulate the data the owner may see on the front end of the system (i.e., the owner dashboard user interface discussed in greater detail herein) in accordance with the disclosed embodiments.

Accordingly, such analyst dashboard user interfaces may be configured to provide an upload check feature that enables the analyst to upload a royalty or lease bonus check to the system. To properly upload a check, the analyst may select the producer or oil and gas royalty owner who sent the royalty check. The analyst may then drag and drop the file into the system for data ingestion.

Once the analyst or owner uploads a file, the uploaded file may populate in a review queue that contains various columns within its user interface screen: (1) file name, (2) uploaded by, (3) upload date, (4) producer, and (5) check amount.

Similarly, in an upload history user interface screen, each column in the review queue user interface screen may contain a filter and search feature. After the file is in the review queue, the analyst may approve or delete the file. Once the analyst approves the file, the file data may populate in the owner user interface screen.

The upload history provides a historical ledger of documents that have been uploaded to the mineral rights management system. The upload history tab may contain various columns: (1) file name, (2) upload date & time, (3) producers, (4) uploaded by, and (5) status. Each column may also contain a filter and search feature. The status column may provide a drop-down feature. The drop-down feature may enable the analyst to see if the file is in the review queue, is processing, is saving to the database, or if the file has been successfully uploaded to the software database. The status may also enable the analyst to see if the upload has started, failed, or completed.

The wells user interface screen may contain the well information from the owner's royalty check. Thus, the wells user interface screen may include various data columns including associated data, e.g.: (1) API (American Petroleum Institute) ID, (2) well name, (3) producer, (4) product, and (5) last production date. The API ID is the well's unique identifier. The American Petroleum Institute provides the unique identification for the well and no two wells have the same API ID. The well name is the name the oil and gas company or operator assigns to the well. The producer is the oil and gas company who operates the well. The producer generally pays the royalty to the oil and gas owner, in which case, the products would be oil, gas, and/or NGLs. The last production date is the production on which the operator pays the owner the royalty. This user interface screen also enables the analyst to edit or delete any data within a column.

The properties user interface screens are similar to the wells user interface screens, but deal with the owner's property or properties. Accordingly, the wells user interface screen may contain the various column headers: (1) asset ID, (2) client id, (3) status, (4) state, (5) county, (6) district, (7) current operator, (8) gross acres, (9) net acres, (10) number of wells, and (11) due tax. The first two columns may be unique identifiers for the properties (assets) and user, e.g., an analyst's clients. The status lists whether the property is open to lease, under lease, or held by production. The state, county, and district provide the location details of the property. The current operator is the oil and gas company who operates the oil and gas well. The gross acres are the total tract acres. The net acres represent the owner's proportional ownership interest in the gross acres. The next two columns, being the number of well and due taxes provide details about the number of wells on the property and the taxes due on the property. Like the well user interface screen, the property user interface screen enables the analyst to edit or delete any of the information.

The users user interface screens enable the analyst to view the owner and other analysts within the mineral rights management system in accordance with the disclosed embodiments. Here, the analyst can see when another person signs into the software. Further, this user interface screen enables the analyst to reset, edit, or delete another analyst or owner.

The analyst function of mineral rights management system enables the software to properly function. Further, the analyst function enables a sophisticated mineral owner or mineral manager the ability to manage data for a lay mineral owner, which may be critical to the effectiveness of the mineral rights management system provided in accordance with the disclosed embodiments.

For example, the analyst functionality enables the input and analysis of well, property and tax data input to the system to provide meaningful and understandable report data output to the user, as illustrated in various figures of U.S. Provisional Patent Application No. 63/314,844, the disclosure of which being incorporated herein by reference in its entirety but also in alternative examples disclosed herein.

More specifically, in accordance with at least some disclosed embodiments, a main dashboard screen(s) for a user (who may be a mineral rights owner, analyst or other related personnel) may include income revenue and volume data illustrated in a variety of different formats with details regarding top producing geographic locations and wells as illustrated in FIG. 2c.

Thus, user dashboard screens may be formulated to provide details that are of interest to the owner for financial planning purposes, e.g., the annual income check information, optionally with reference to geographic location.

FIGS. 3-11 illustrate various examples and exemplary functionality associated with a main user dashboard of a user interface provided in accordance with the various disclosed embodiments of the innovative system disclosed herein. As shown in these figures, the dashboard may be considered to be the landing screen for the disclosed mineral rights management system, e.g., in an implementation of the system where the front end of the system is accessed via the Internet or via software application on a cloud based system. As a result, a user would be required to log into the system in order to view the displayed dashboard. The dashboard provides what may be considered to be a 10,000-foot view of the information associated with the mineral rights and other associated data pertinent to the user, e.g., information regarding the user's mineral rights associated income, taxes, and production volumes.

It should be understood that all graphs shown in the user interface can be switched between a bar or a line graph. To change the graph, one only needs to click on the red box in the upper right corner that contains the graph symbol. Additionally, one can filter all information in the system with the filter tab in the top right corner of the screen. A user can filter by time or custom range of time; and can search by check or individual clients.

One optional feature of the disclosed system provides technical utility by providing search functionality via a search bar at the top of the dashboard. This search bar enables searching for and locating any data point stored within the database of the system. For example, if a user wants to search for a depository note, i.e., a check, that contains the number “37,” the user simply enters the number value “37” into the search bar field and actuates a search to trigger a search for and display of all checks, wells, producers, and counties that contain the number “37.”

When viewing the user dashboard, e.g., the examples illustrated in FIGS. 2-11, one of the first items a user may see is the total income section of the dashboard. The Total Income Section may be implemented to provide, for example, the gross income, the net income, and the margin or the gross income divided by the net income in a percentage. Generally, the reason why a user, e.g., property owner, would not have a 100% margin is because an oil and gas operator who pays the property owner a royalty takes deductions from the owner's royalties. However, understanding the impact of such deductions enables the user or analyst to make informed decisions about the effect of such deductions on the royalty stream provided based on the mineral rights for the property.

On the examples illustrated in the figures, adjacent to the total income section, is a tax section, which is configured to display the total taxes due and the taxes paid. This data may be provided by performing a software implemented extraction, e.g., data scrape, to pull the tax information from each county's tax website on a periodic, e.g., monthly, basis.

It should be appreciated that tax information may be particularly important to user's managing their mineral rights portfolios because it is not uncommon for owners of such rights to have acquired their interests through tax sale purchases somewhere during the history of the ownership of the rights. This helps ensure that property owners do not lose the property the way that a user or a user's predecessor acquired the property. In addition, because tax regulations for mineral rights can differ between counties, the user interface screens of the disclosed system may also enable analysis and display of data as it pertains to different counties in which producing property is located.

As illustrated in FIGS. 3 and 3a, below the overview information may be a trailing twelve-month summary of royalties, e.g., oil and gas income revenue. As shown in FIG. 3, this chart summarizes the monthly income by net income, gross income, and the margin based on a user's gross income divided by net income. As shown in FIG. 3a, the displayed data may be displayed in different periods, e.g., monthly or quarterly, and potentially may also be displayed on an annual basis in other implementations.

The table has the ability to toggle between production dates and check dates. Additionally, one can add or remove the gross, net and margin bars enabling the ability to view the information in a way that is preferable to the user.

Optionally, a user can toggle between the check date and the production date because the check date generally trails the production date by a period of time, e.g., two months. Furthermore, when a new horizontal oil and gas well comes online, the operator may generally hold the initial payment for six to eighteen months. Therefore, a user may receive a large sum of money in the first month that they receive a royalty check and the revenue drastically decreases in their next check. If the user selects the revenue by production date, the software may optionally enable the user to see the months of production from that initial check. This enables the user to better understand the decline curve of the well or depletion. Further, it may help a user know whether a user should contact an operator about interest payments that fall outside the statutory requirements for timely royalty payments.

In accordance with various embodiments, on the main dashboard screen, below the bar chart may be displayed a revenue by operator chart, which is also sortable by check and production date. A user can add and subtract operators to the chart as well. For example, if a user wanted to display data associated with the operator HG Energy, the user can use the filter to remove all operators except for HG Energy. Furthermore, one can filter the rest of the operators and. if the user would like to add them back, the user can select the operator and click the box next to the operator's name.

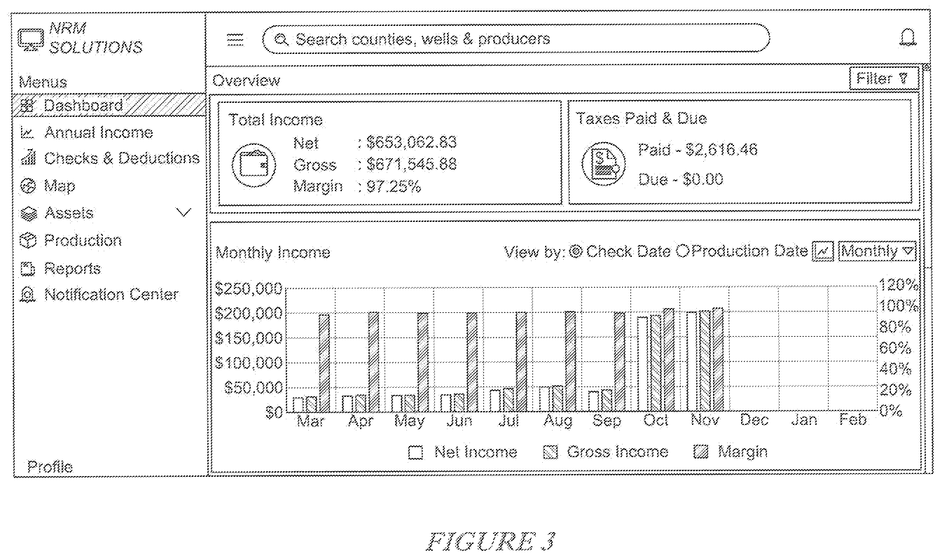

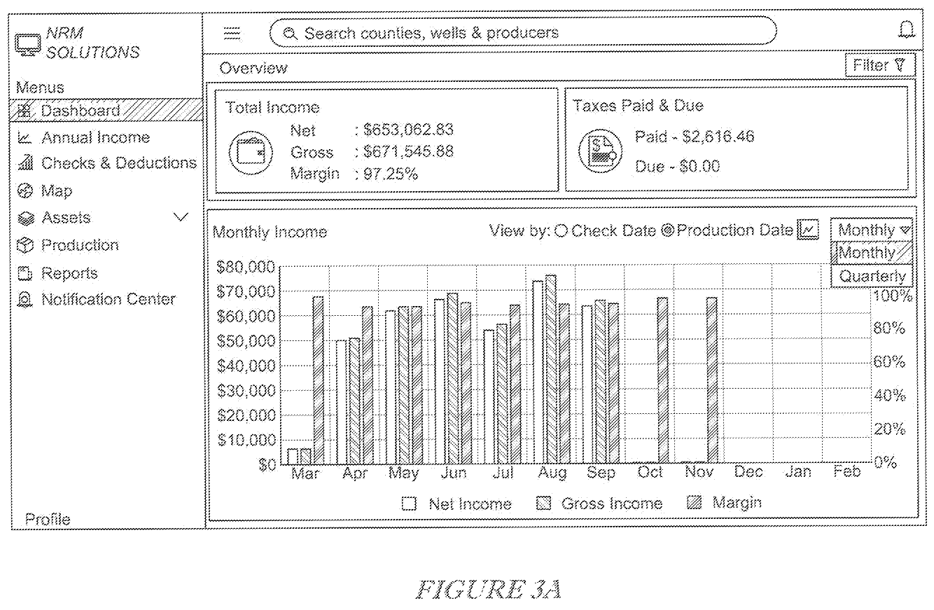

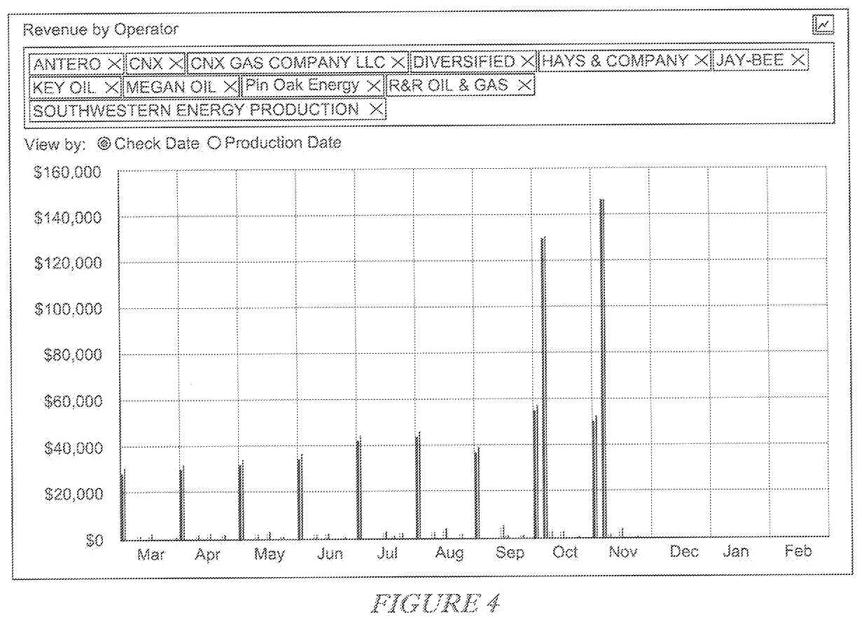

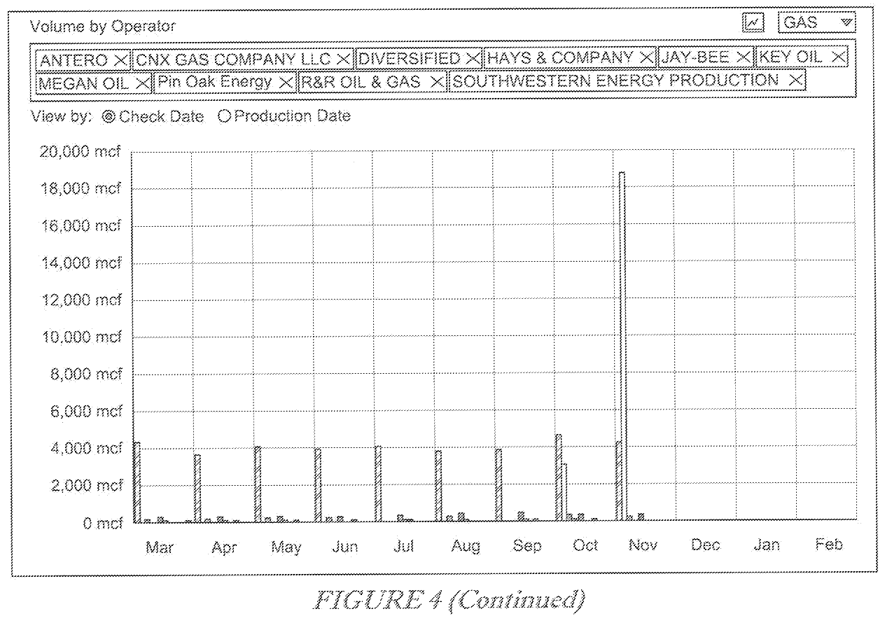

Beside the revenue by operator chart, the main dashboard screen may also include a volume by operator chart, also shown in FIG. 4. The user has the ability to toggle between check and production date and add and subtract operators in the same way that the revenue by operator chart is customizable. In addition, the chart may be customized to differentiate by the product type. For example, one can use the dropdown menu in the upper right hand corner of this section to select gas, NGL, or oil, which may trigger display of that volume data in the chart.

As illustrated in FIG. 5, the main dashboard screen may also include data related to top performing at the bottom of the dashboard, including a display of a pie chart with information for user's top five counties and top five wells. Optionally, if a user hovers (e.g., using a mouse or stylus or other object) over a portion of the pie charts, this may trigger display of associated or constituent revenue data as shown in FIGS. 7 and 8. Directly to the right of each chart, a summary of the user's top five counties (counties in which the user's properties are located) or top five wells and the revenue contribution percentage of each county or well.

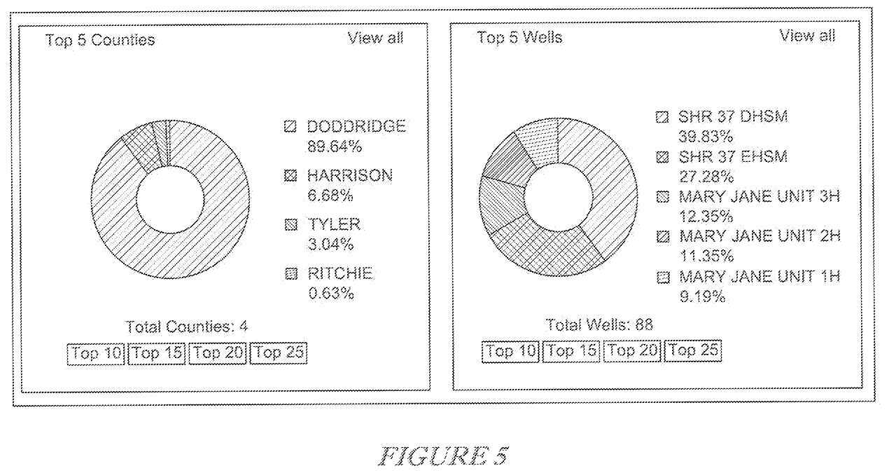

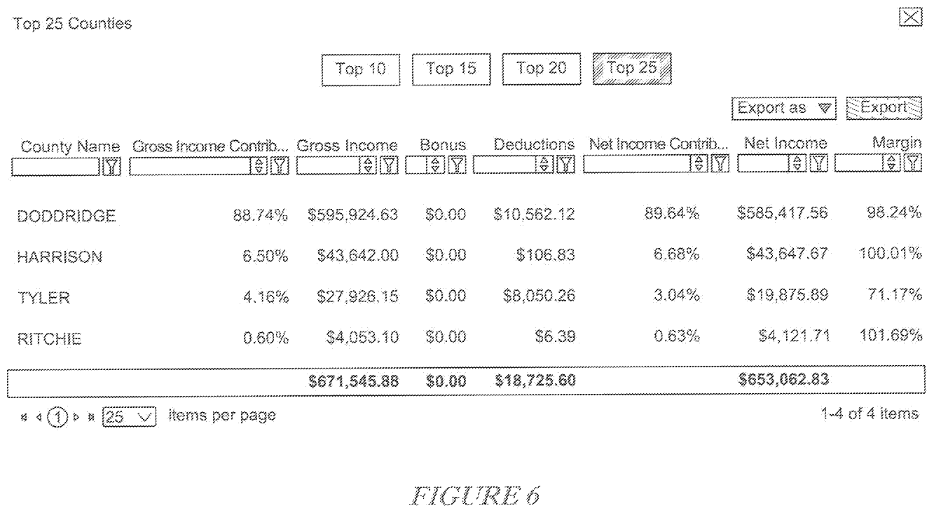

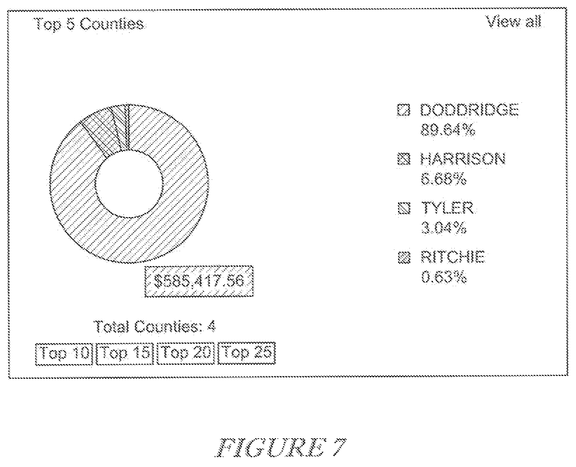

Of note, this portion of the main dashboard screen may be further configured to switch the chart from top five to top ten-fifteen-twenty or twenty-five, an example of which being shown in FIG. 6. Thus, when a user opens the top twenty five option, the user can quickly sort the information by clicking on the column header. In this way, a user can quickly identify the well the paid the most gross income or net income. Moreover, the detail shown in this portion of the main dashboard screen may also be used to identify non-performing properties or counties, e.g., Marshall County displayed in the listing of FIG. 9.

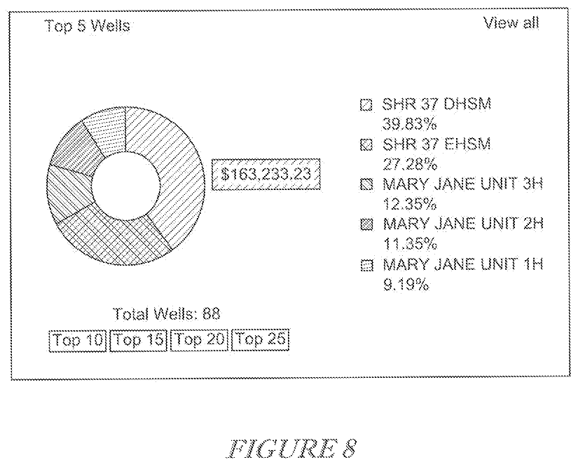

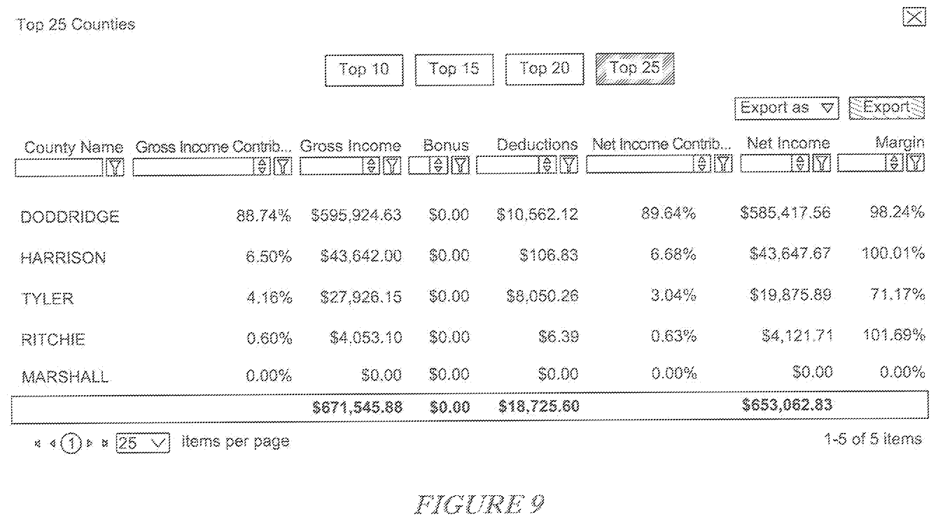

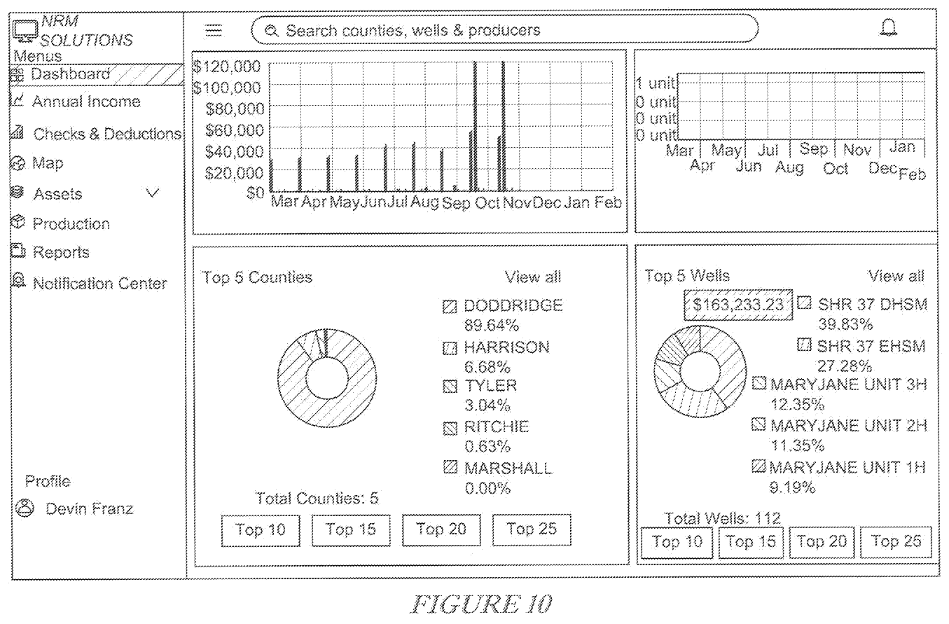

As a result, a composite overview of top performing areas and wells may be provided in addition to historical data indicating trends and data points for those properties as shown in FIG. 10.

Still further, this section of the main dashboard screen can be used provide data details regarding the top five/ten/fifteen/twenty/twenty-five wells, as shown in FIG. 11.

Additionally, a user can quickly export this information by the user clicking the export drop down menus shown in the upper right hand corner of this section of the main dashboard screen. It should be appreciated that this displayed data may be exported in a variety of formats for subsequent use including as a PDF document on in a Microsoft™ Excel spreadsheet. The export may provide the timeline at the top of the screen along with data for the top twenty five counties or wells that the user requested.

Finally, as shown in the right hand side of FIG. 2, the various screens provided via the system that are accessible to users are listed and may be accessed by interacting with the names associated with those listings. That listing is provided as a navigation mechanism to move between the various constituent screens of the front end of the system.

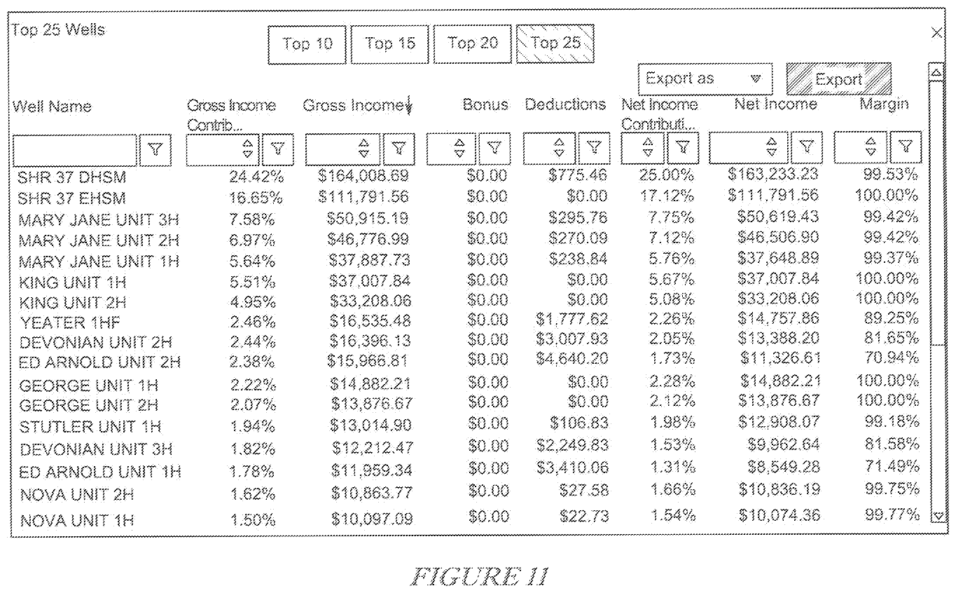

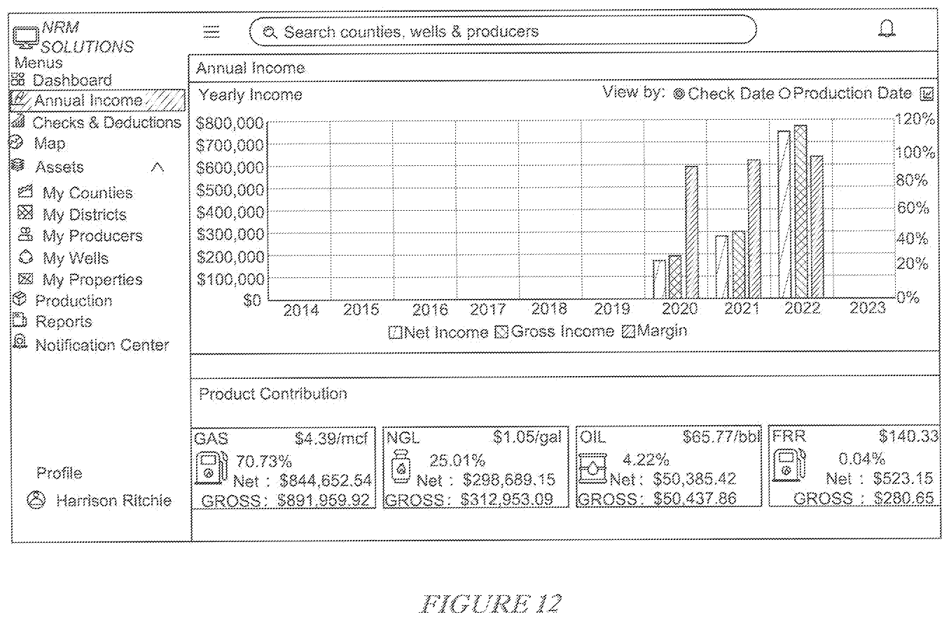

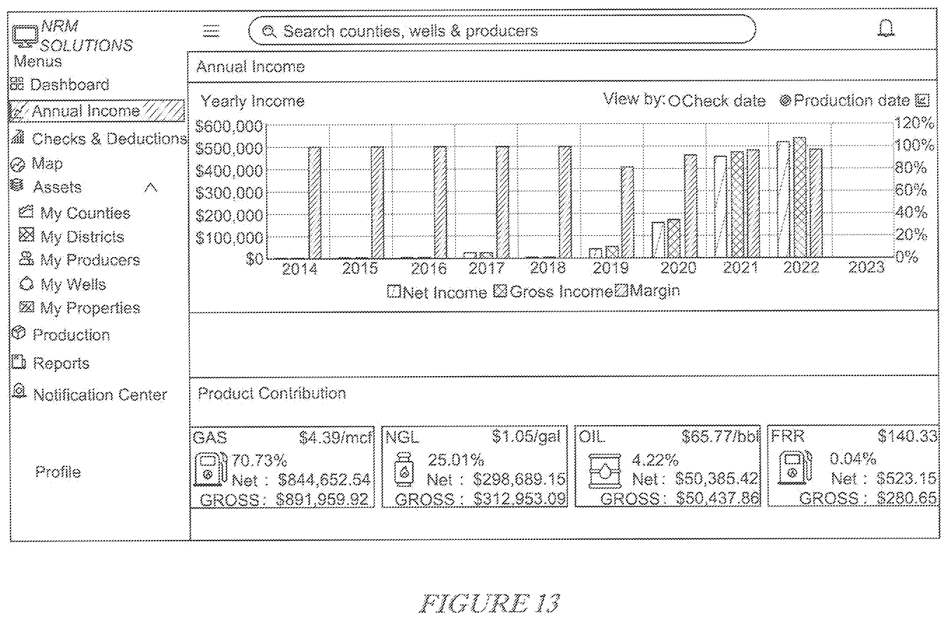

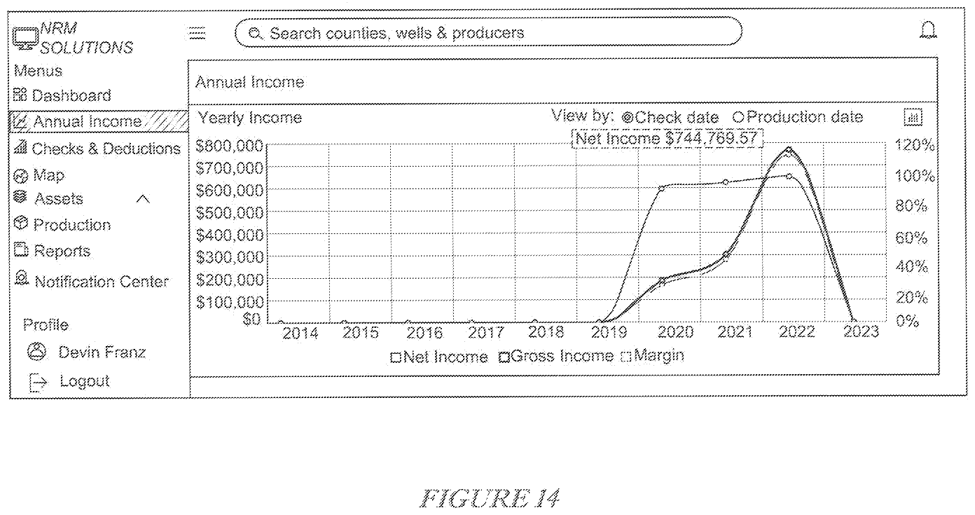

Thus, as shown in FIG. 12, an annual income dashboard screen example is shown. The annual income dashboard screen is configured to display a user's revenue information year over year. The data displayed may be displayed in a number of different ways, for example, it can be toggled by check (see FIG. 12) or production date (see FIG. 13) and changed from a bar graph to a line graph (see FIG. 14). Like various examples of other charts in the inventive system, a user can switch between a bar chart or line graph at their preference. Additionally, a user can add and remove displayed data, e.g., gross income, net income, and margin from the chart.

As shown in FIG. 12, below the annual revenue summary, various product contribution data may be listed along with a section for each specific product. For example, a user may see a section for gas, a section for oil, and a section for NGLs. Each product section provides the user with data regarding the average price received per unit for each product. In addition to this, the gross income and net income for each production may be displayed. This enables the ability for the user/property owner/analyst to meaningfully understand the effect of operator deductions that can significantly effect a royalty stream. Thus, access to such data via the user interface screens also enables analysis and display of data as it pertains to particular operators with which agreements are in place. Furthermore, as shown in FIG. 12, indication of the percentage of a user's royalty revenue derived from gas, oil, NGLs, etc., may be displayed.

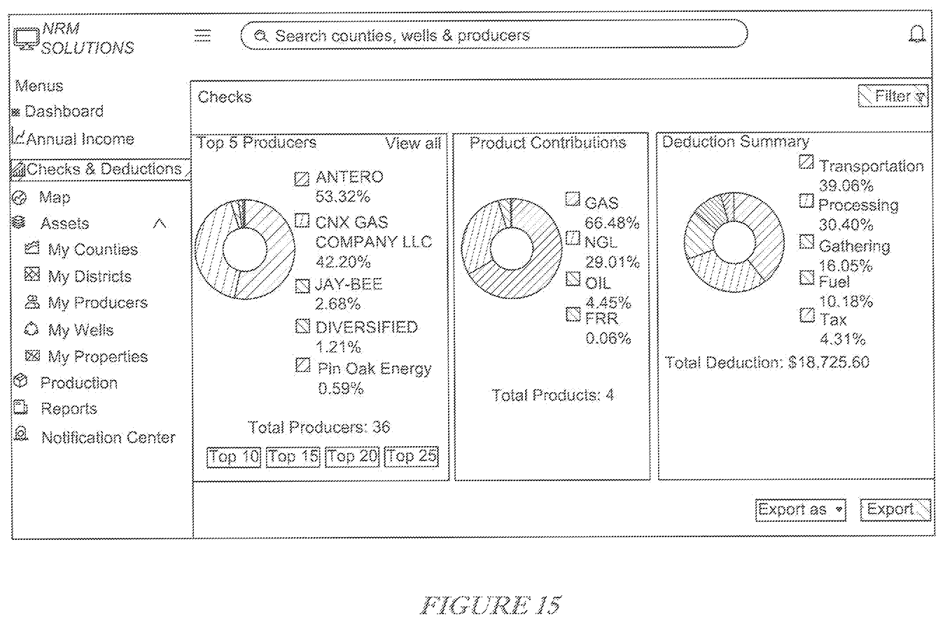

Various disclosed embodiments of the system may provide user interface screens that enable review of data that enable an owner to understand how much they are being paid and what the basis for that payment is. Thus, as shown in FIGS. 15-20, various different types of information regarding checks and deductions received in association with the user's wells, properties and counties in which properties are located.

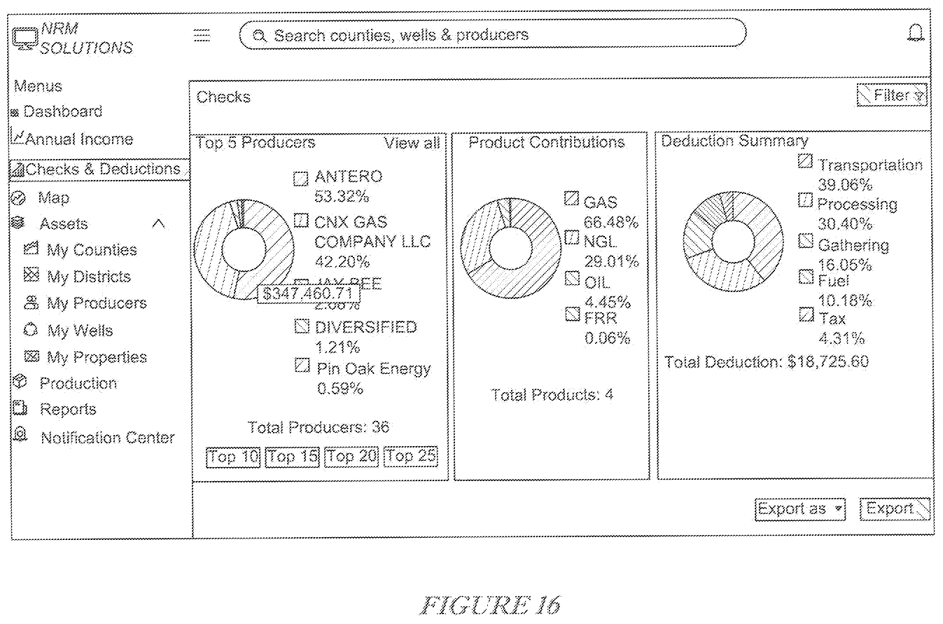

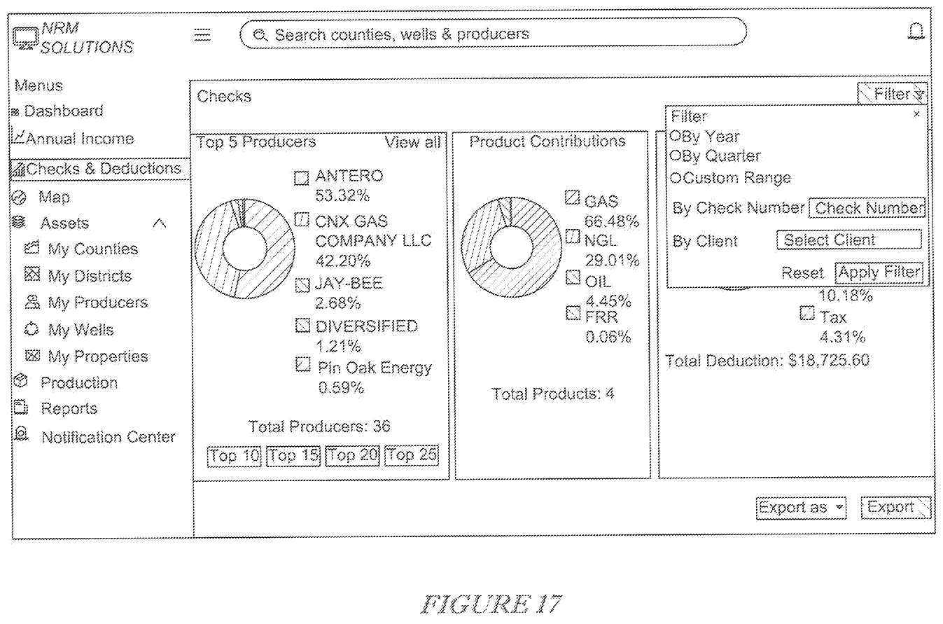

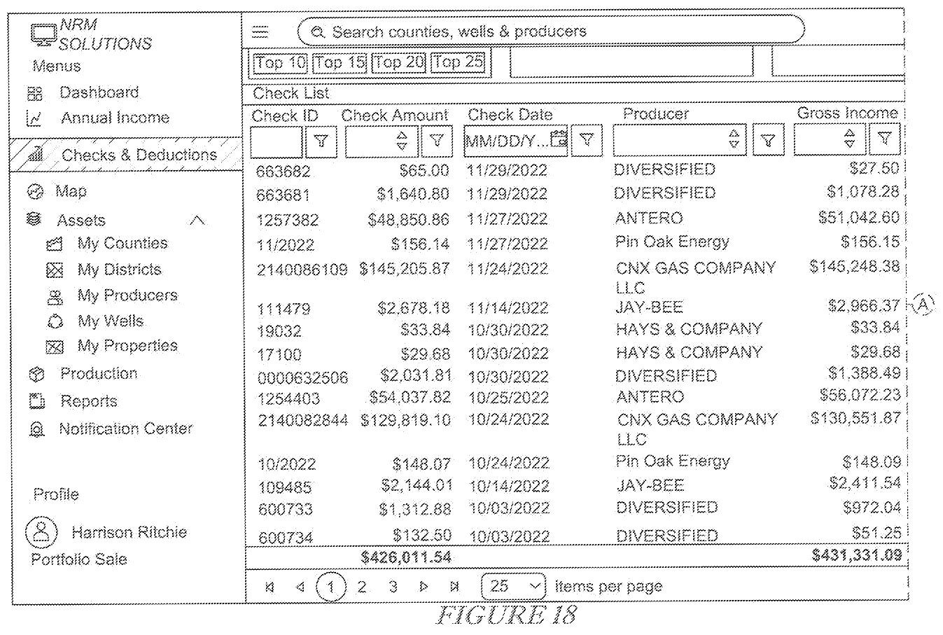

As shown in FIG. 15, an example of a checks and deductions screen is provided that includes, for example, three sections: (1) top five producers (referring to operators), (2) product contributions, and (3) deduction summary. Each section may contain a pie chart and provide the contribution percentage to the user's portfolio. Like the other pie charts provided by the inventive system, the screens provide revenue and/or fiscal detail information when a user hovers over a portion of the pie chart (see FIG. 16). In addition, it should be understood that the displayed data may be filtered by year, quarter or a custom range, by check number, as discussed above, or a particular user, using the filter function triggered by clicking on the filter icon in the upper right hand corner (see FIG. 17).

Below the top producer, product contribution and deduction summary sections, a “check list” may be provided that includes a list that contains data on all checks that a user has entered into the system for analysis. In this regard, it should be understood that the system backend discussed above with regard to FIG. 1 pulls publically available data from various sources but also is configured to receive data from users, e.g., property owners, analysts and/or persons provided access to the system by the user/property owner or system provider (e.g., administrators).

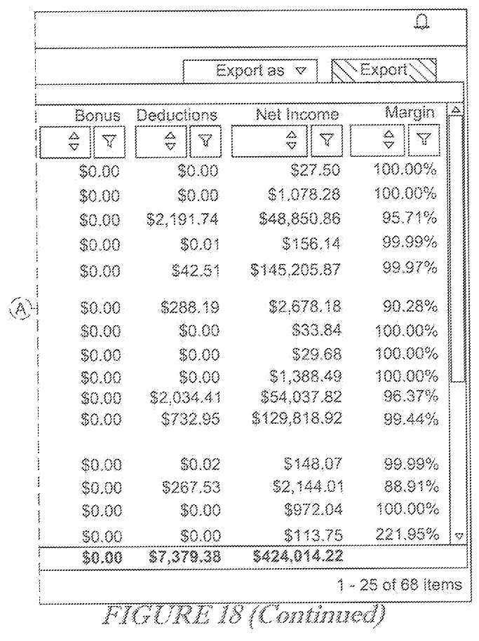

The check list (see, for example, FIG. 18) may contain various header columns: (1) check ID, (2) check amount. (3) check date, (3) producer, (4) gross income, (5) bonus for lease bonus, (6) deductions, (7) net income, and (8) margin. Like other charts in this system, one can quickly sort from greatest to least by clicking on the column header. Additionally, a user can leverage the search bar under each column to search for specific information.

As shown in FIG. 18, the bottom of the check list may include a summation of the revenue or monetary (deduction) information that displays on the screen.

Of particular utility, the system screen(s) enables a user to quickly sort the displayed information by operator and/or by time period, e.g., month. This enables the user or their service provider, e.g., analyst, to verify that an operator has paid the user properly on a monthly basis. If analysis determines that a discrepancy or monthly missing check from an operator has occurred, the user or their service provider can quickly contact the operator and request the missing royalty payment.

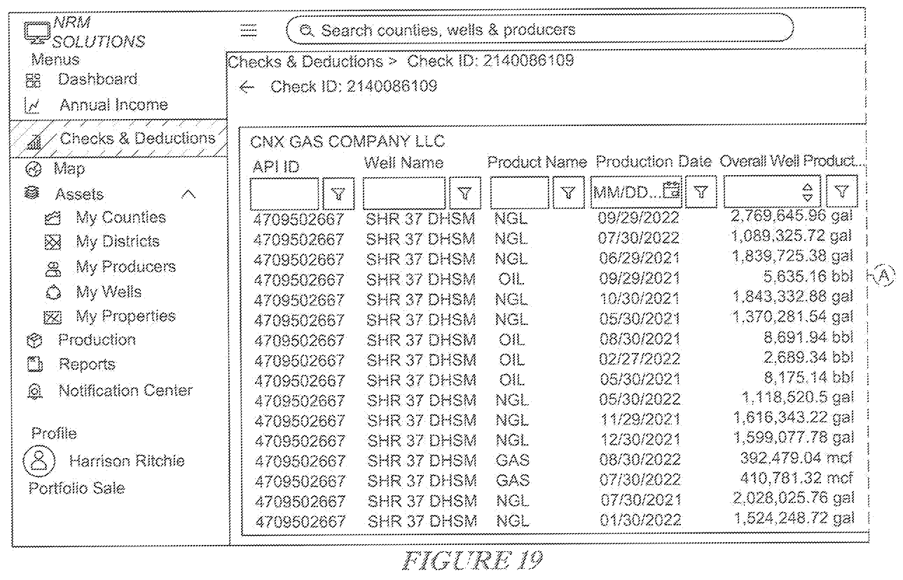

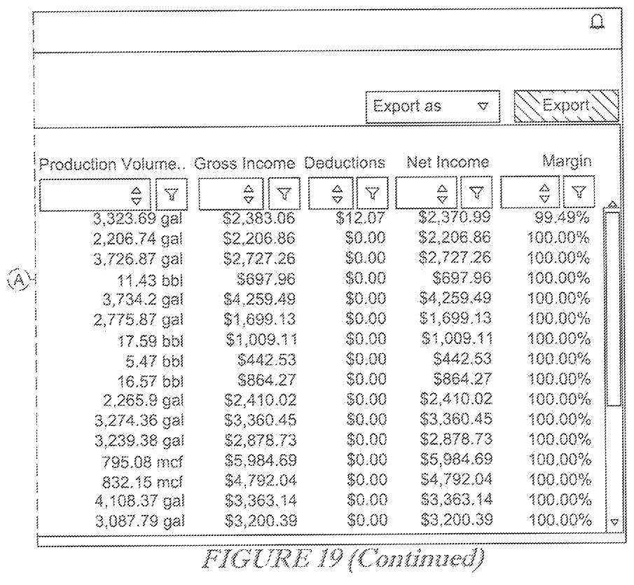

From the checks and deductions screen, a user can drill down further into date data. For example, if a user clicks on a particular check, various granular information for the specific selected check may be displayed. Here, a user may be presented with a comprehensive list of oil and gas wells that have generated royalties on that check along with a breakdown of every product contribution. Further, the screen may display the API ID for each well, the production date, overall well production volume, owner production volume, gross income, deductions, net income, and margin associated with the selected check (see FIG. 19).

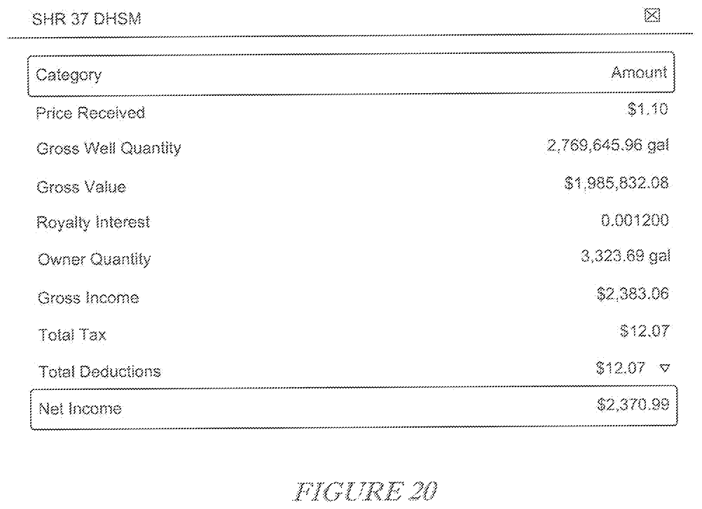

This display of data further enables the ability for a user to click on a specific well and product contribution line to trigger generation of a summary that provides the price received for production along with the aforementioned information (see FIG. 20).

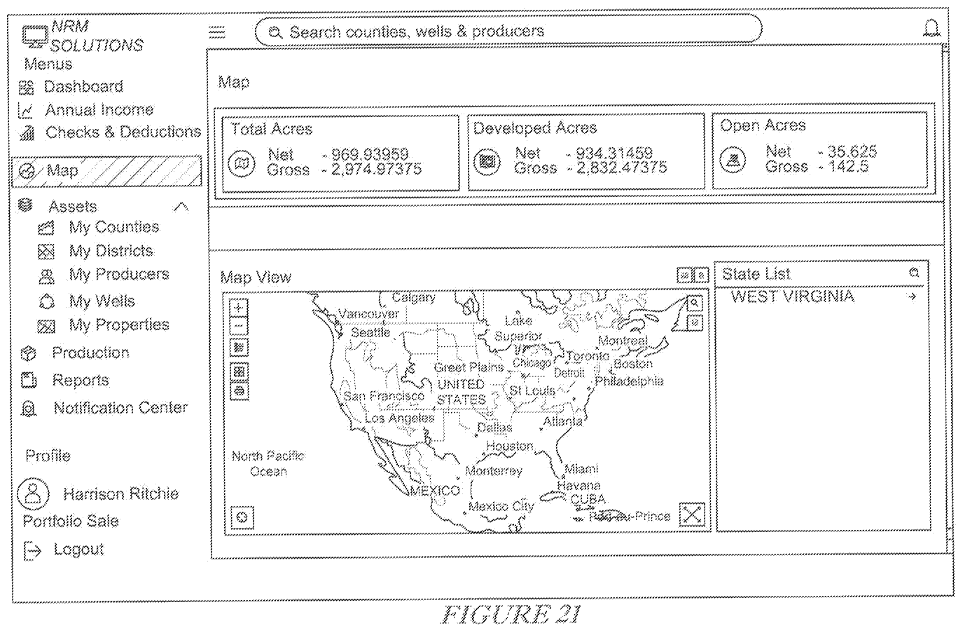

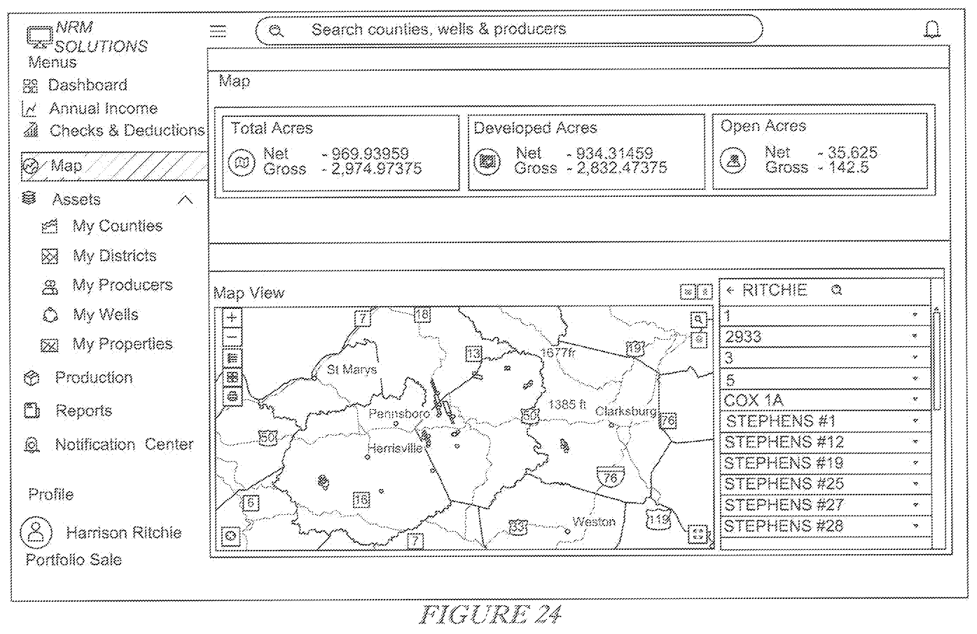

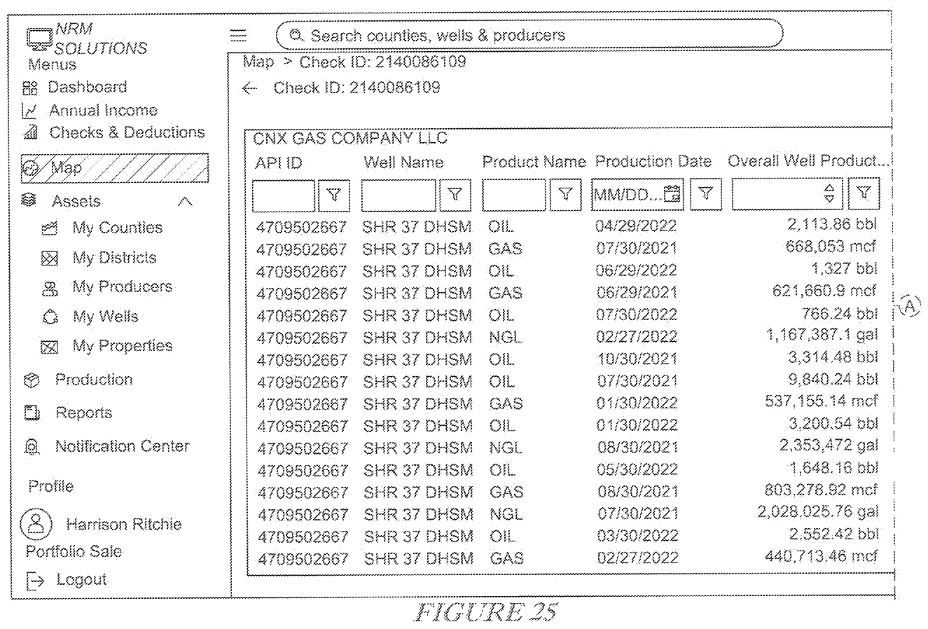

As discussed above, the various disclosed embodiments of the system may provide user interface screens that enable review of data that enable an owner to understand how much they are being paid and what the basis for that payment is for various wells on various properties located in multiple counties and states. Thus, as shown in FIGS. 21-26, various different types of information regarding the geographic location of the user's wells, properties and counties in which properties are located may be provided on one or map screens in accordance with the disclosed embodiments.

In one example of such a map screen, shown in FIG. 21, three sections may be displayed from left to right: (1) total acreage, (2) developed acres, and (3) open acreage. Each section may summarize the gross acreage amount and net acreage amount. The definition of a developed acre may be, for example, a property where a well encumbers the property or the property is under the primary term of an oil and gas lease. An open acre may be, for example, a property that is available to lease to an oil and gas operator.

As indicated above, the system provided by the disclosed front end, back end, source feed combination provides technical utility in that it enables aggregating and analyzing publicly available but inconsistent format/structured data as well as data input by a user and/or their service provider, e.g., an analyst. Accordingly, it should be understood that the user or their designated representative is able to populate information for the map screen(s) provided they have ownership reports, title opinions, or assets books that tie (relate) the user's acreage information to each property. In this way, the inventive system is then able to summarize and display acreage information on the map screen for review and analysis by the user or their service provider.

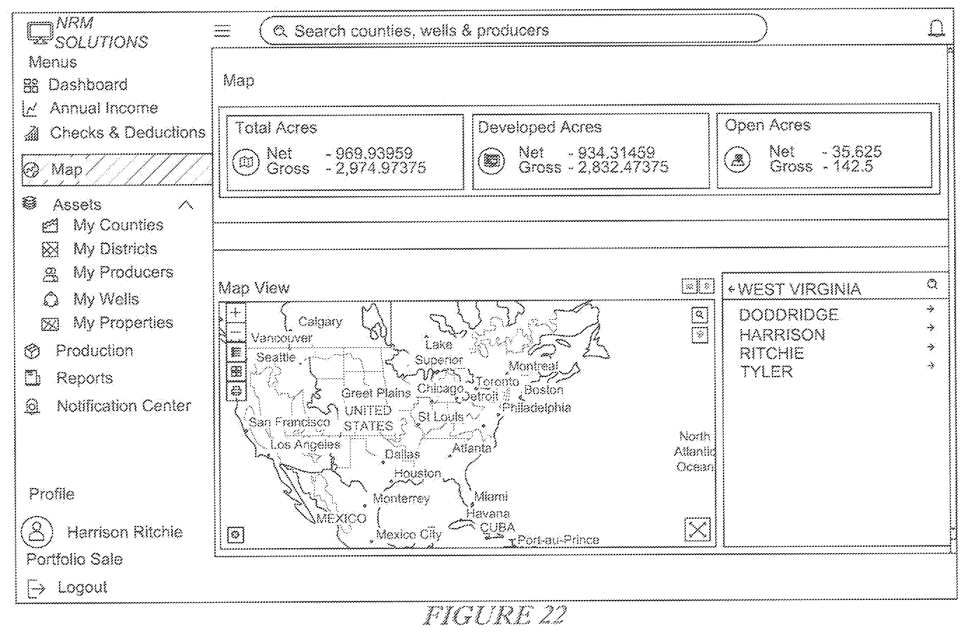

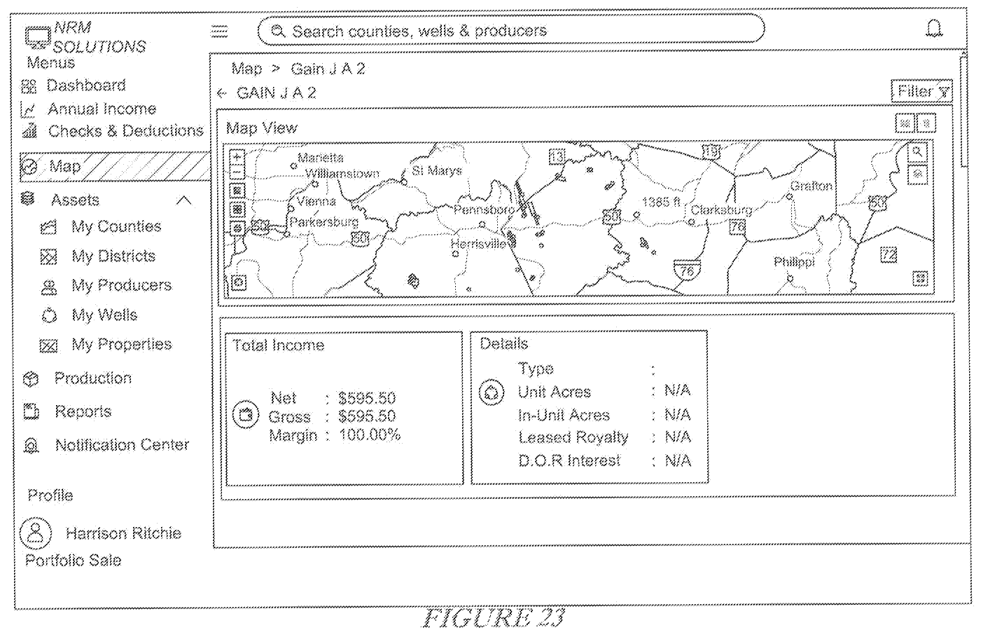

As shown in FIG. 21, below the three map sections is a view of the map screen, which may include a map illustration of the location of the user's properties along with the wells that encumber their properties and the unit boundaries. As discussed above, the inventive system may source data from local courthouse documents to build unit boundary shape files. Thus, the displayed data may be displayed at the state level (FIG. 21), county level (FIG. 22) or sub-county level (FIGS. 22-23)/

Additionally, data may be gathered, formatted, analyzed and displayed that identifies the top hole, bottom hole, and landing point of each horizontal well (see FIGS. 23-34) to provide a true depiction of the horizontal well and enable the user to accurately identify the properties that the well encumbers.

Furthermore, the inventive system pulls in and aggregates all tax map parcels, vertical wells, pipelines, and storage fields within a particular state, e.g., the state of West Virginia. As a result, the state list to the right of the map (e.g., FIG. 21) enables the user to zoom in on individual states and individual counties (e.g., FIG. 22).

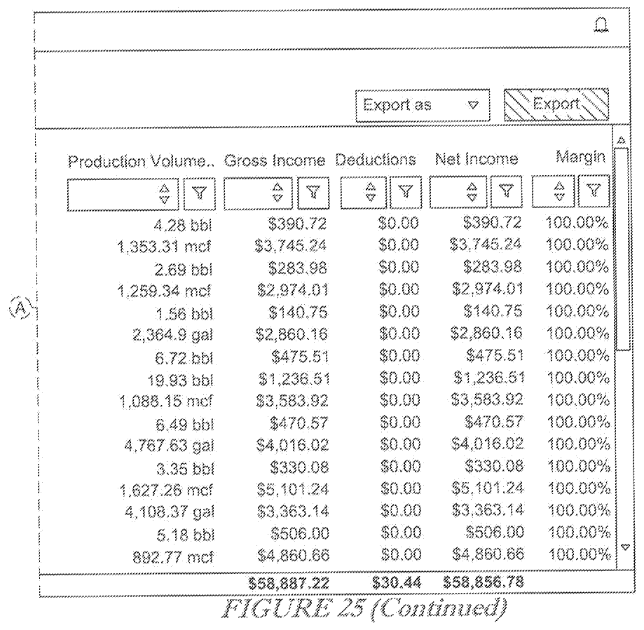

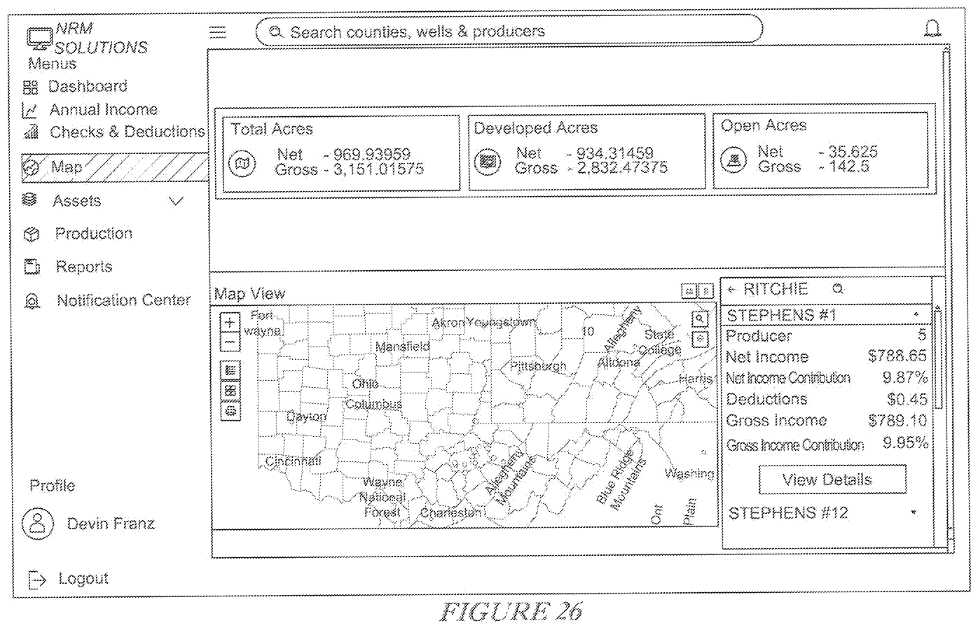

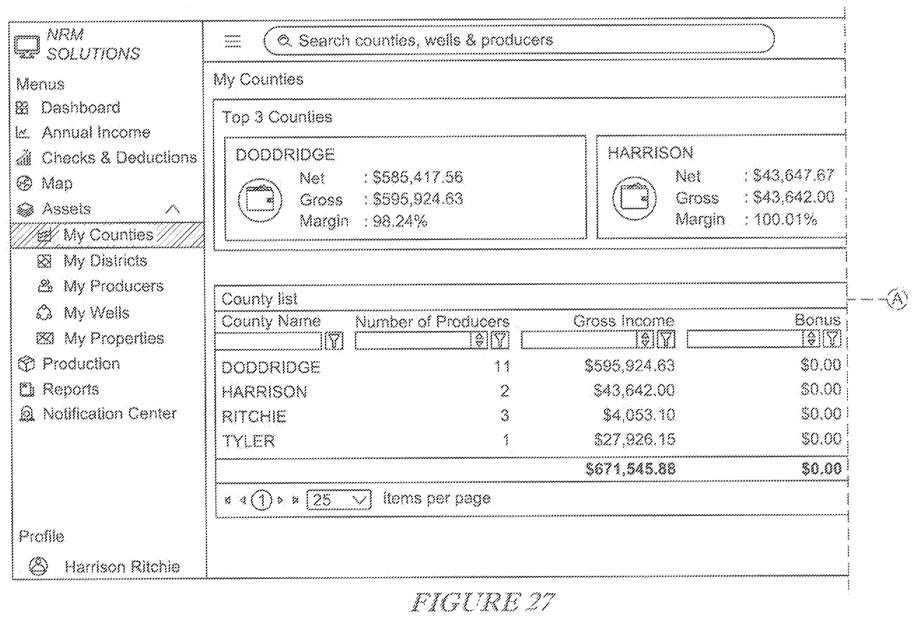

By clicking on a county, the user is able to trigger a display of data pertaining to all the wells a user has within that county. By clicking on a well, the user is able to trigger display of data pertaining to details within that well, which may include the user's producers, income, deductions, etc. (see FIGS. 25-26).

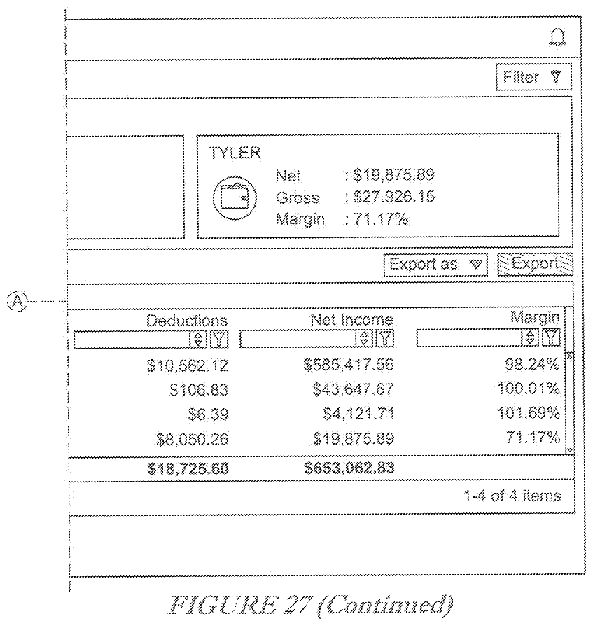

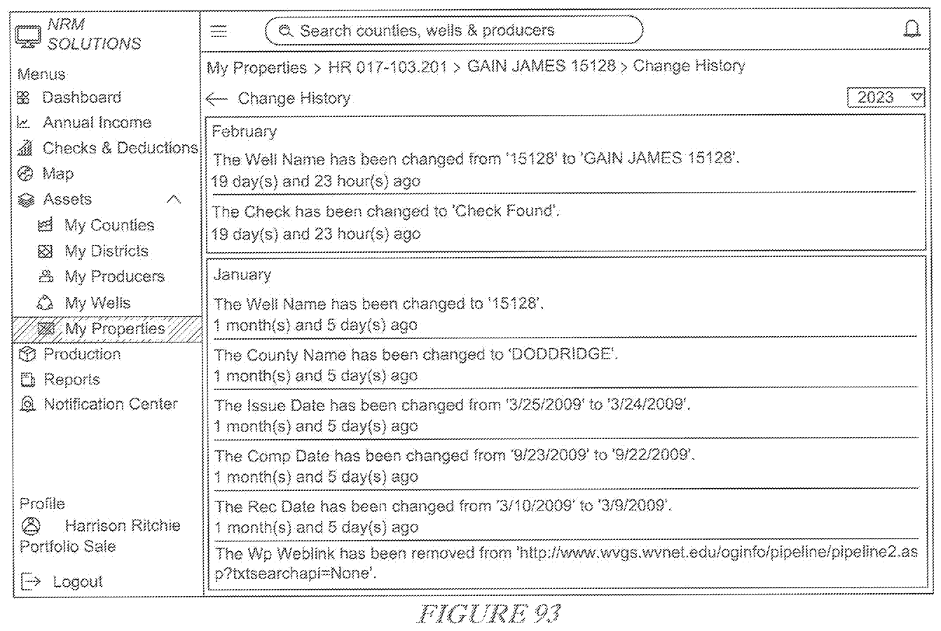

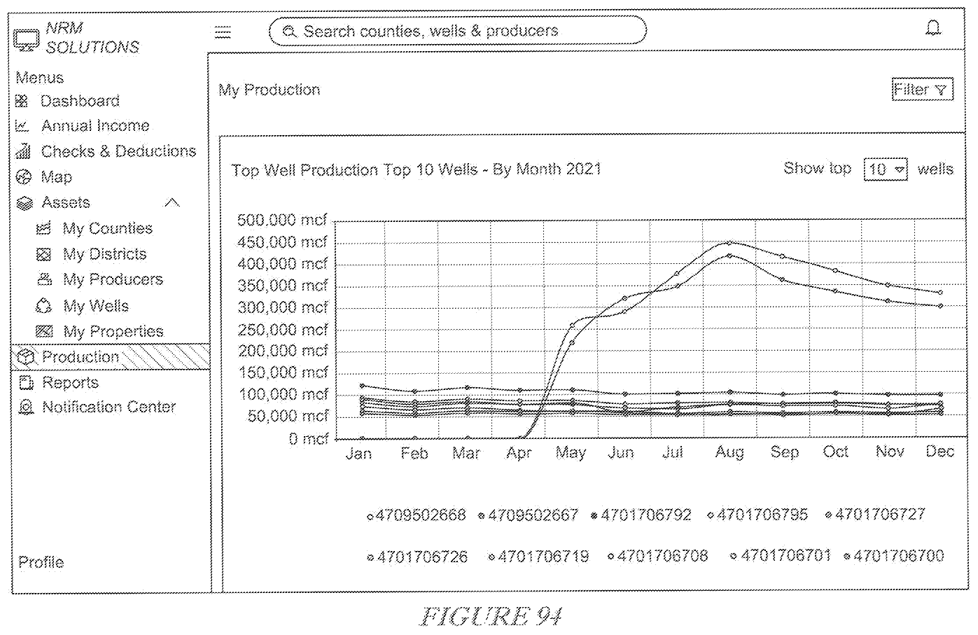

Thus, various disclosed embodiments of the system may provide user interface screens that enable review of data that enable an owner to understand how much they are being paid and what the basis for that payment is. Thus, as shown in FIGS. 27-93, various different types of information regarding a user's assets at various different levels of analysis, e.g., by county, by district, by operator/producer, by well and by property. Thus, assets data may be displayed in a number of different ways associated with subcategories: (1) my counties, (2) my districts, (3) my producers. (4) my wells, and (5) my properties.

The asset screen(s) may contain granular information that a user need to answer specific questions about a user's properties and royalties. This information allows a user to hold the oil and gas company accountable for any payment issue or acreage discrepancy.

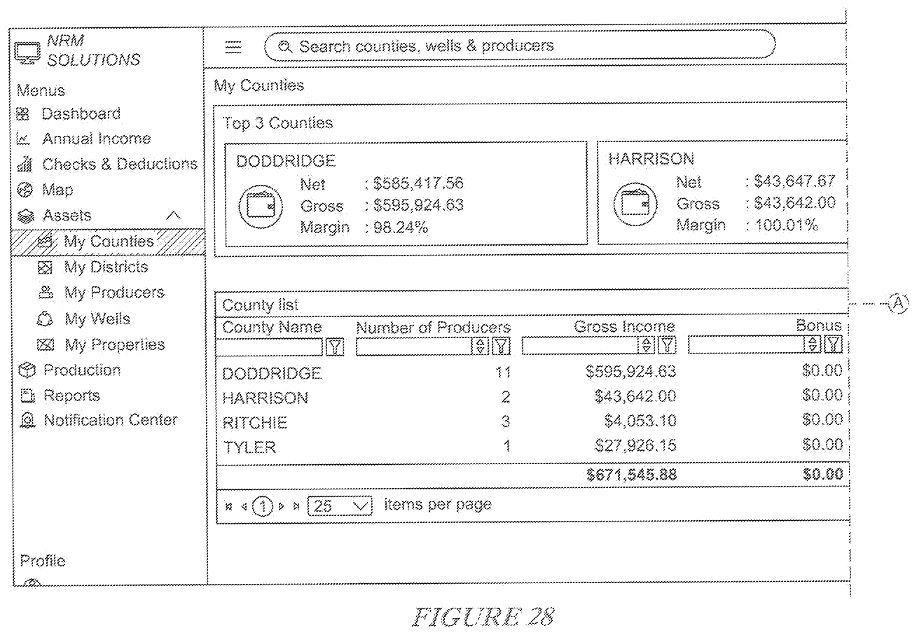

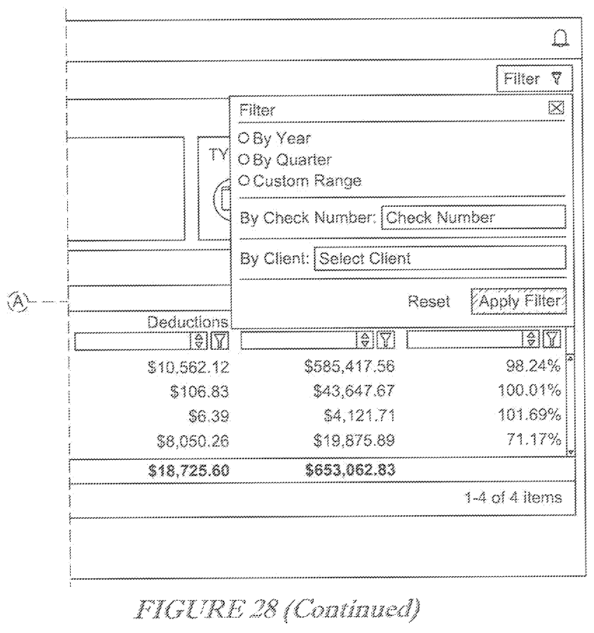

The first subcategory under the assets screen(s) is the my counties screen(s) (examples shown in FIGS. 27-38). At the top of the my counties screen, a user may see three sections. The three sections summarize, for example, a user's top three counties by revenue. Again, a user may find the gross income, net income, and margin information for each of the top three counties. As shown in FIG. 28, the displayed data may be filtered using the filter functionality provided in the upper right hand corner of the screen. Below the top three counties is a county list that may provide a user the name of every county where a user receives royalty income, the number of producers in the county, the gross income from the county, the lease bonus, the deductions associated with wells in the county, the net income for the county, and the margin. At the bottom of the list, a summation of the numerical information may be provided.

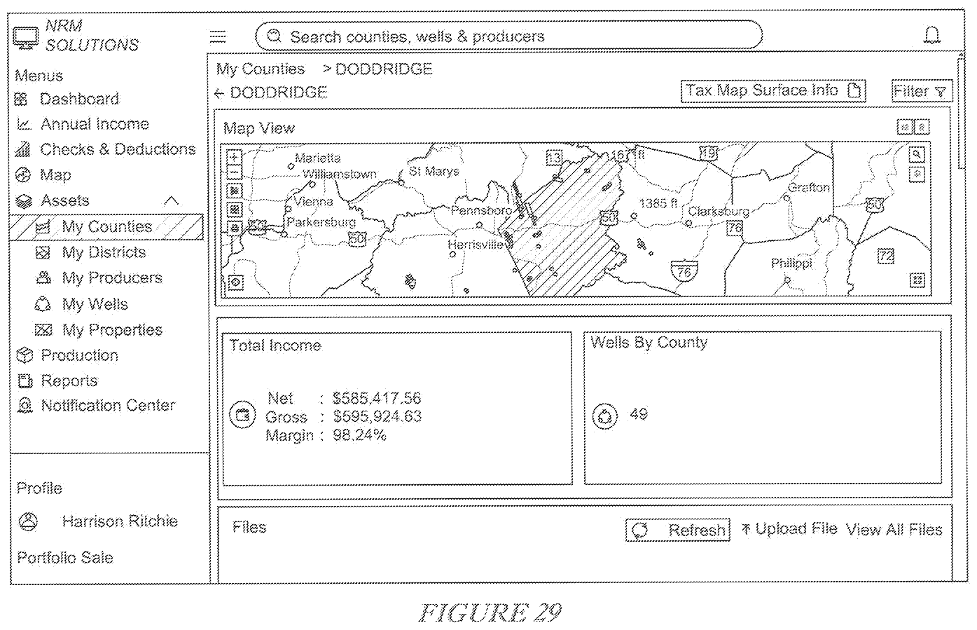

If a user selects a county, then the software may direct a user to a map and highlight the county as shown in FIG. 29. The map may display each property within the county along with each well that encumbers a property a user owns. Below the map, a user may see a section for a user's total income for that county along with a section that displays the numbers of wells that encumber the user's properties within the county. Moreover, a user may find monthly income chart similar to the chart on the main dashboard screen. Again, the chart may provide the user with a trailing twelve month revenue or income information by net, gross, and margin.

Moreover, the well list may provide the user with the API ID, well name, producer name, gross income, lease bonus, deductions, net income, and margin for all the user's wells. If a user clicks on a well from this listing, the system may take the user directly to that specific well on a map. This may illustrate the location of the well along with the direction for the horizontal. Further, a user may see the property that the well burdens.

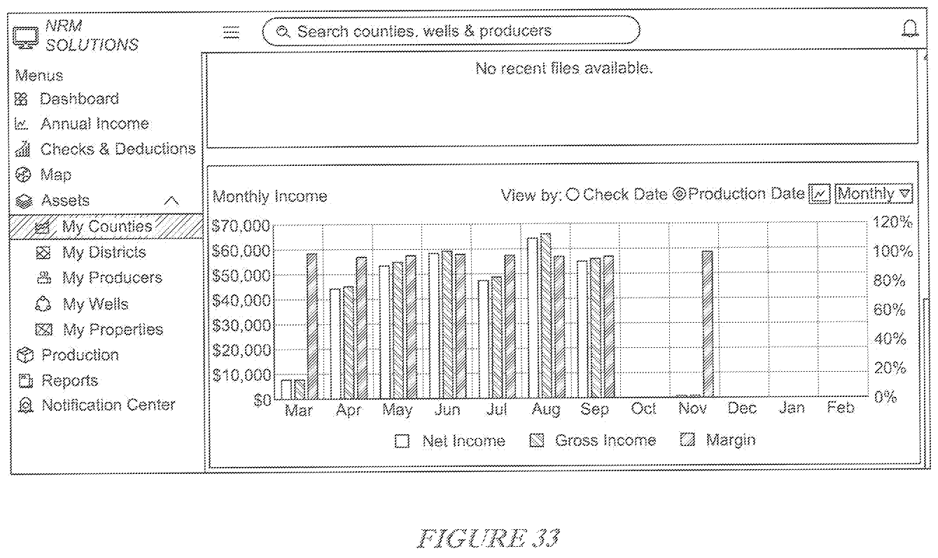

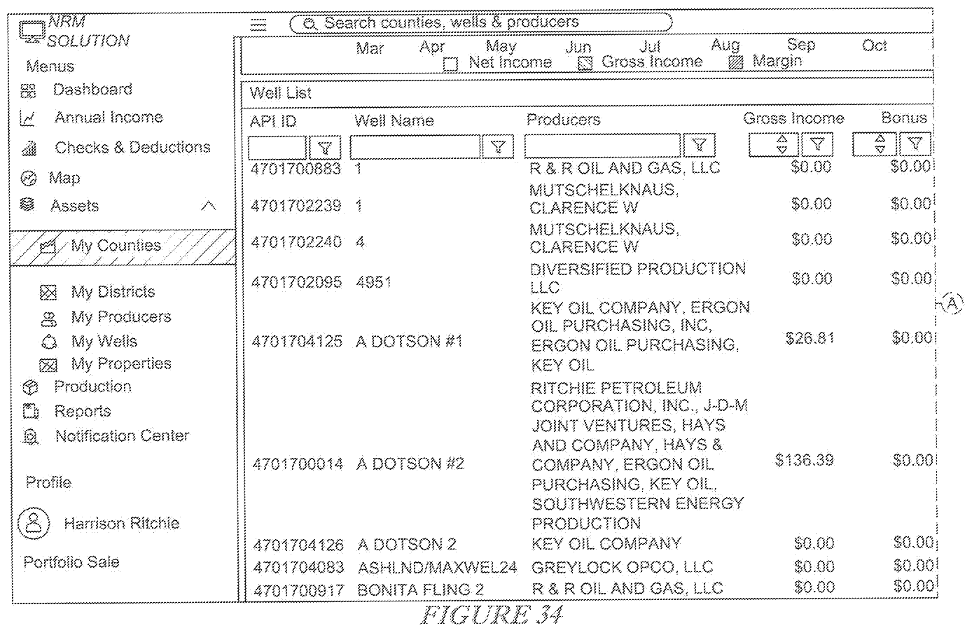

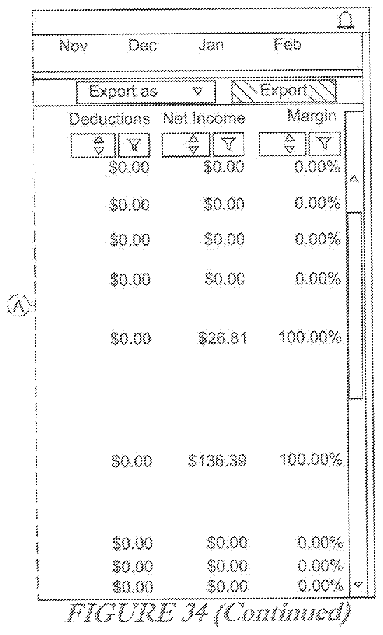

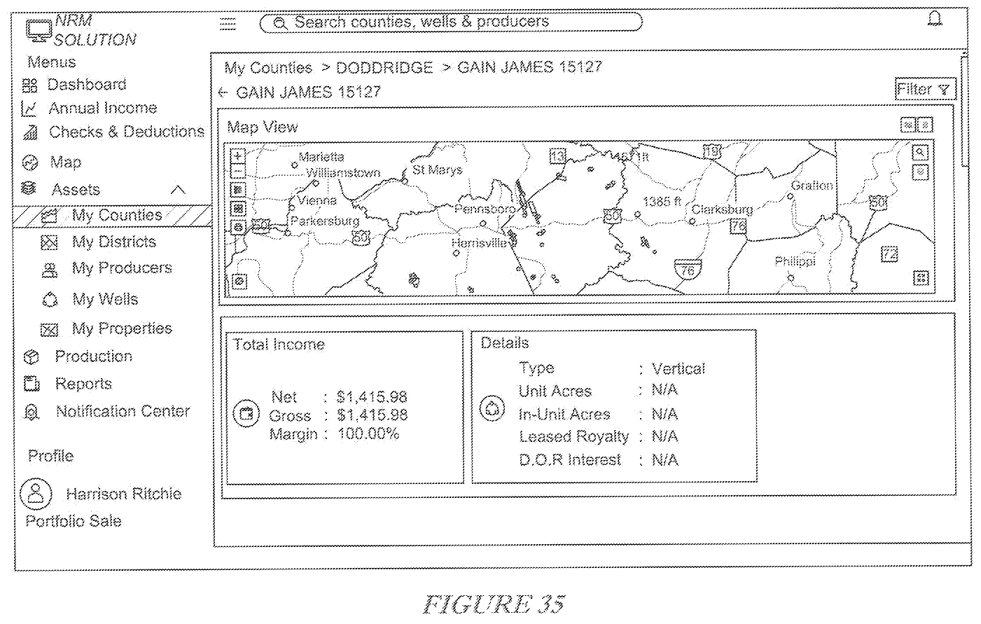

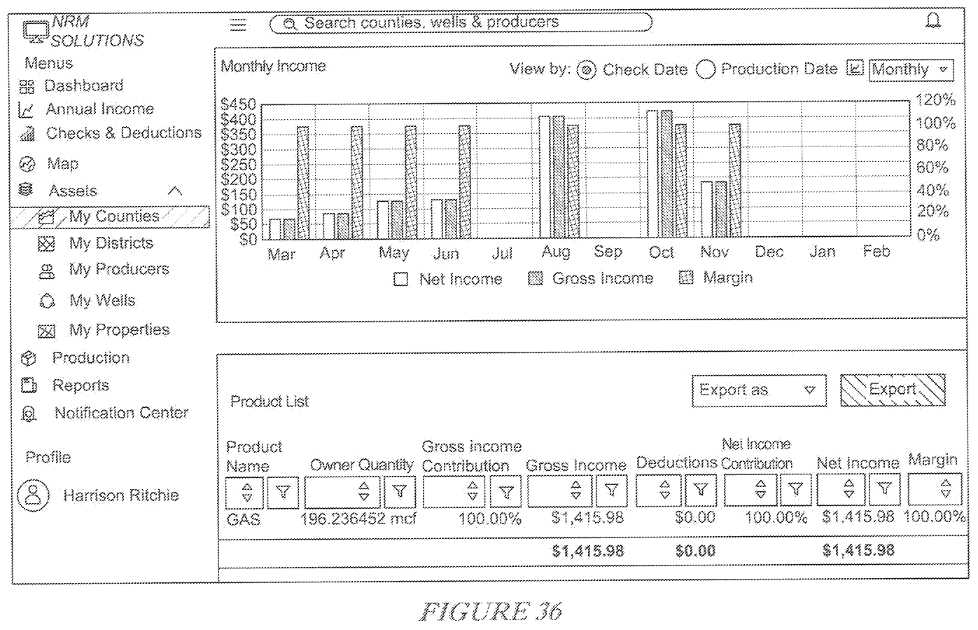

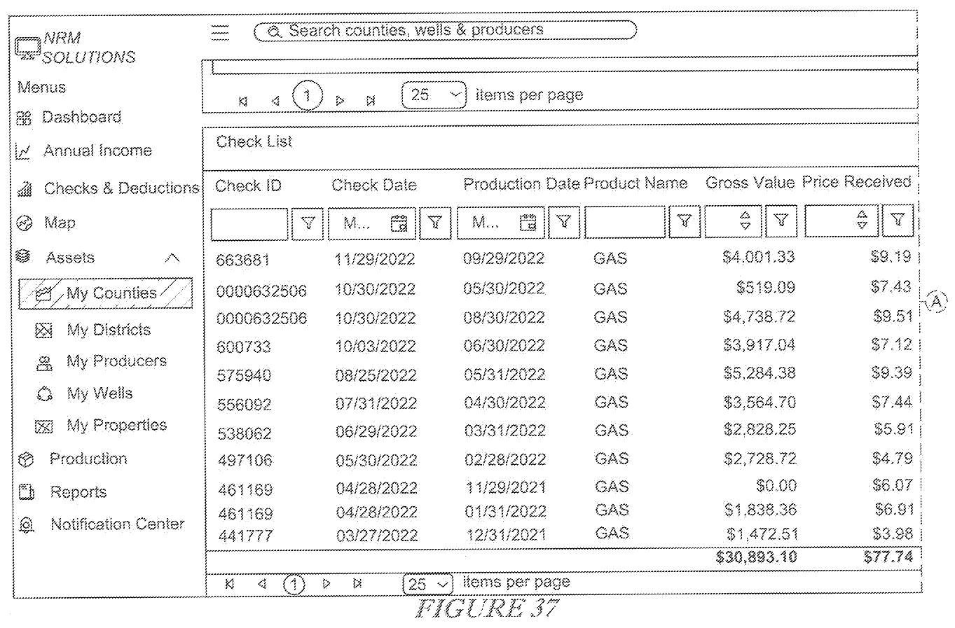

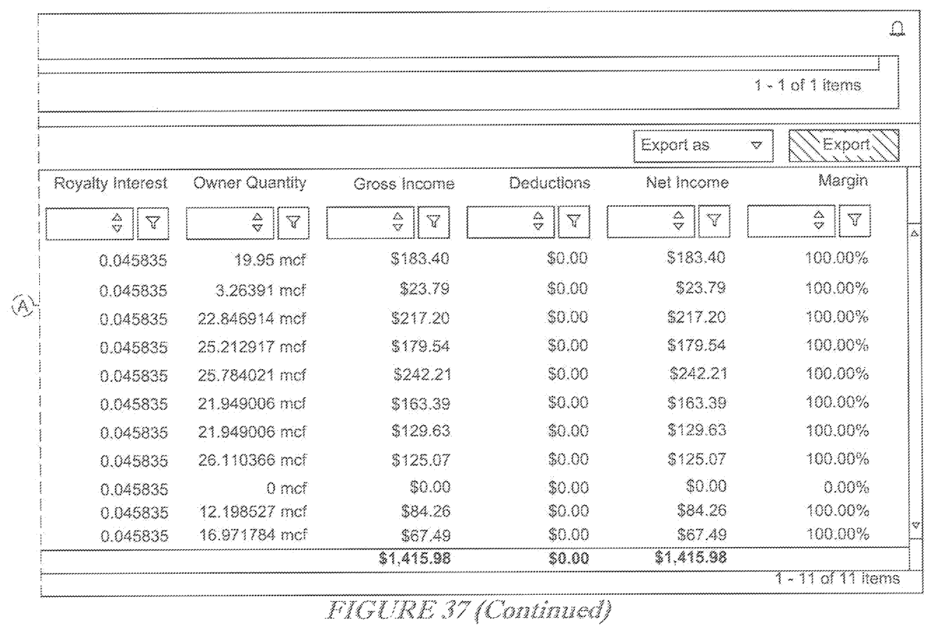

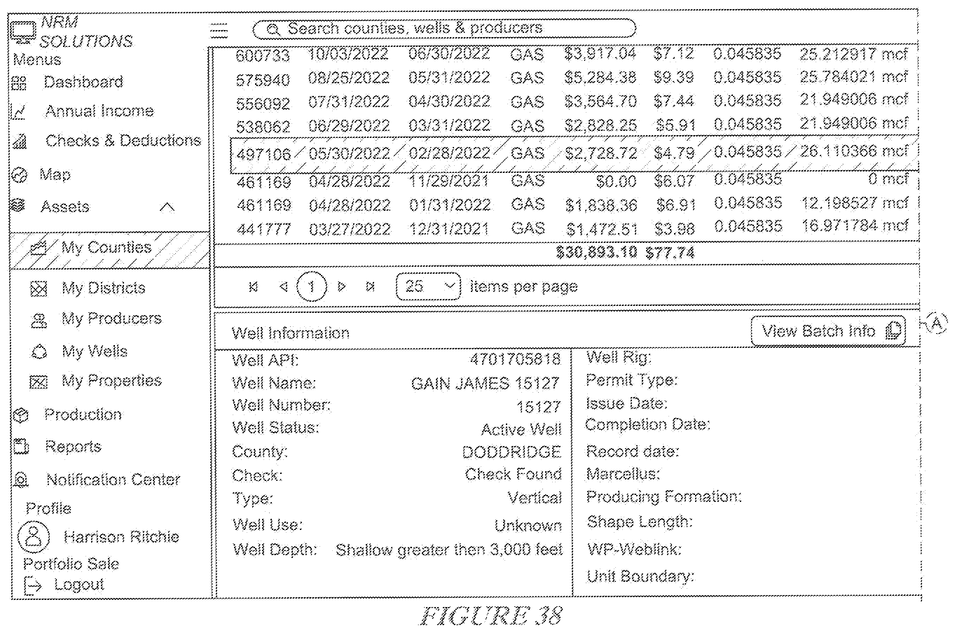

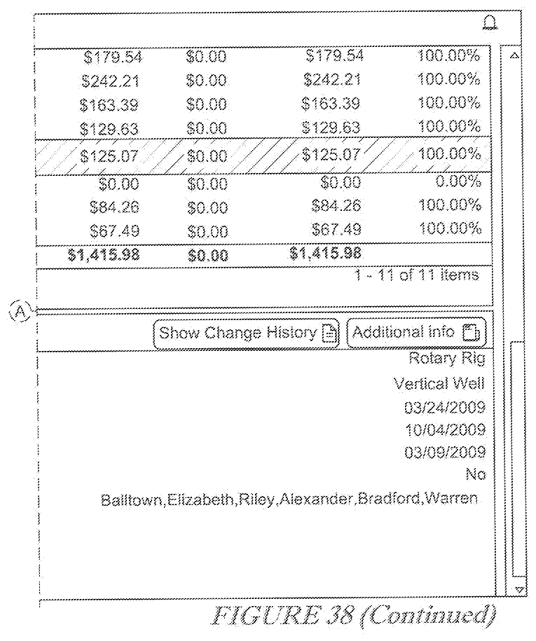

The my counties screen examples, monthly income may displayed in chart form as illustrated in FIGS. 32-33. Likewise, selection of data within the displayed data may trigger display of a well list providing details of all wells in a particular county, as shown in FIG. 34. This, in turn, also enables display of a geographic map location associated with each listed well (see FIG. 35) as well as a product list and historical data associated with the county (see FIG. 36) and associated well data (sec FIGS. 37 and 38).

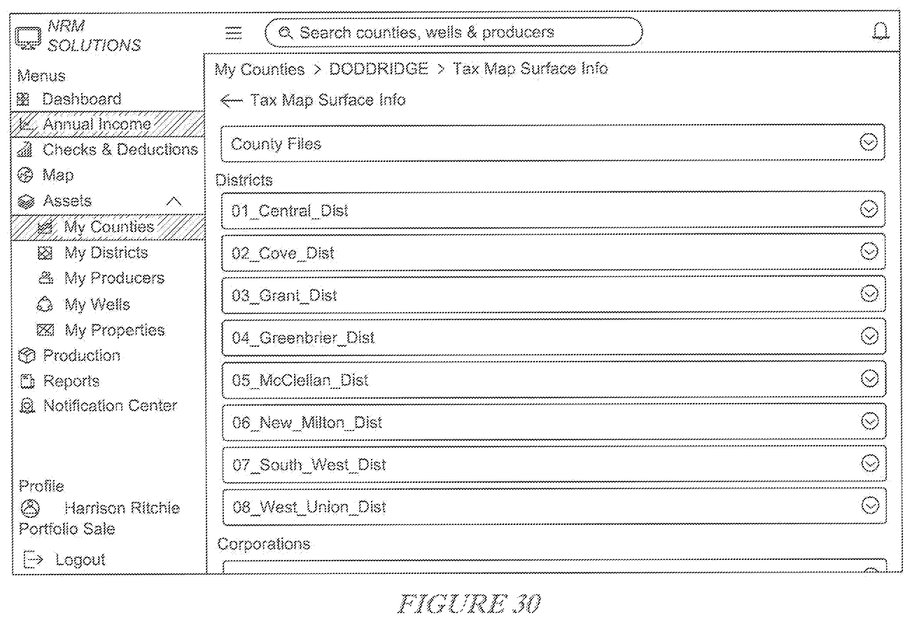

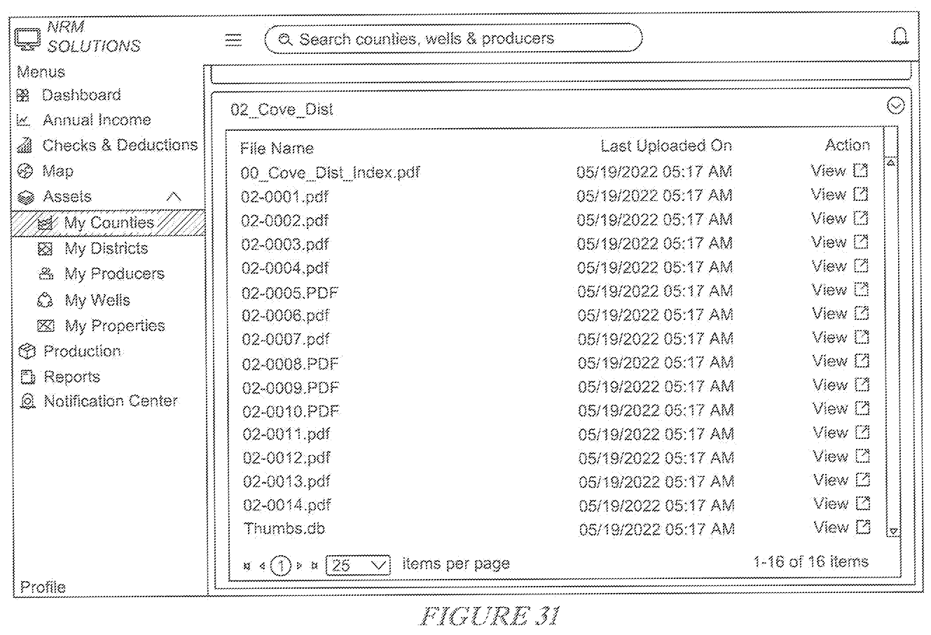

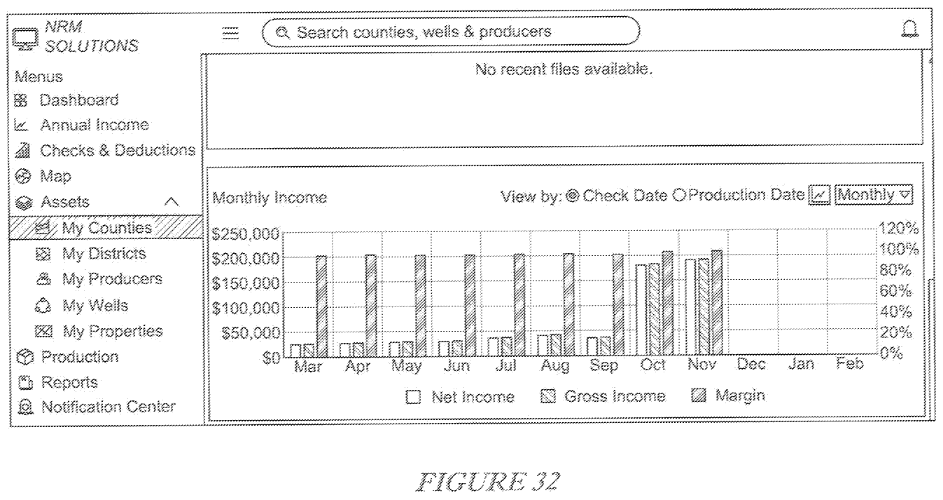

In addition to the my counties drop down menu is the my districts screen drop down menu. The my districts screen(s) operate the same as the my counties screen(s) with the exception that the district data pertains to each district within a county rather than the county itself. Again, the screen will display, for example, top three districts at the top of the screen and the user's individual districts at the bottom. A user may also be able to click on each district and review the summary information for each district (see FIG. 30). From there, a user can again click on a specific well where the software may take a user directly to that specific well on a map. In more detail, the districts may be listed in a district list (FIG. 30), selection of entries therein may list files associated with the particular district (see FIG. 31).

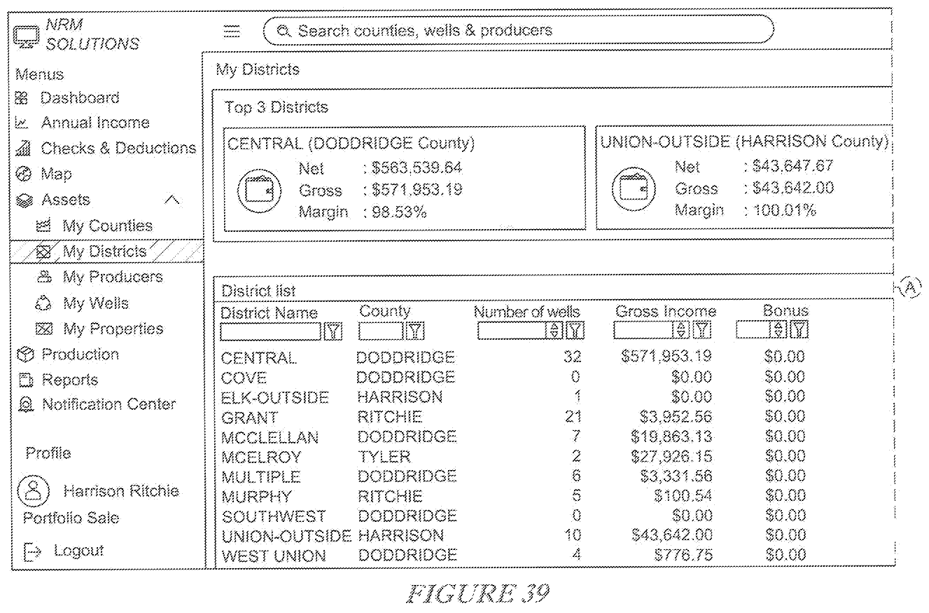

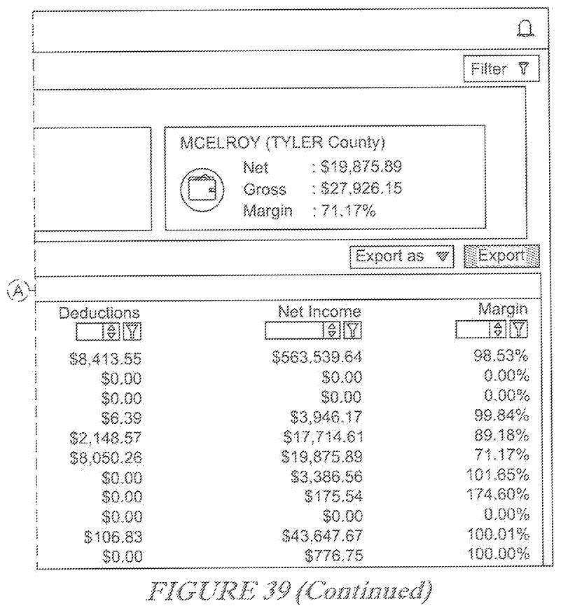

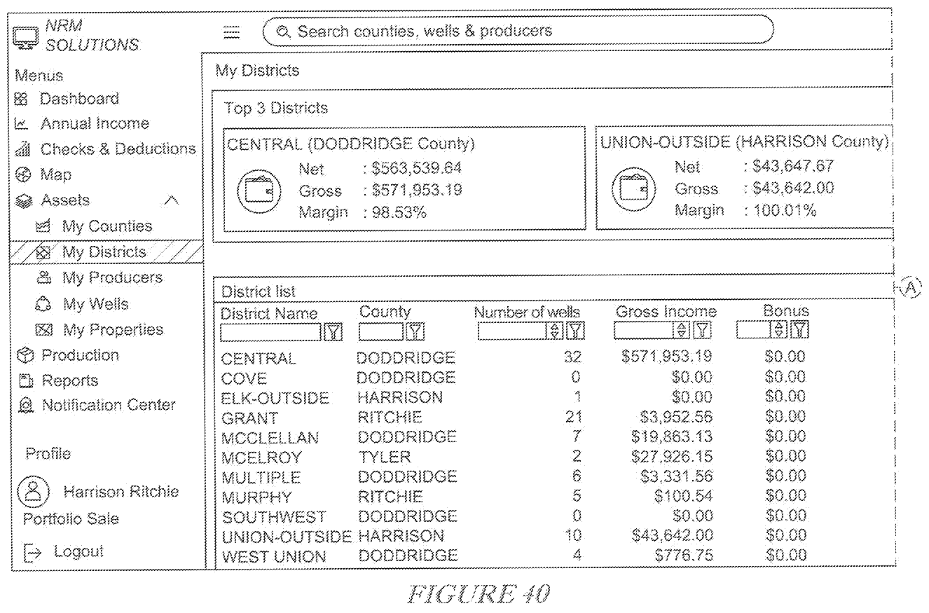

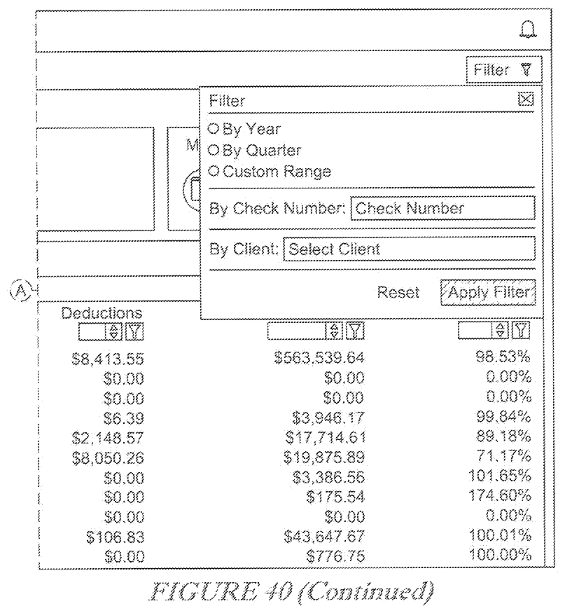

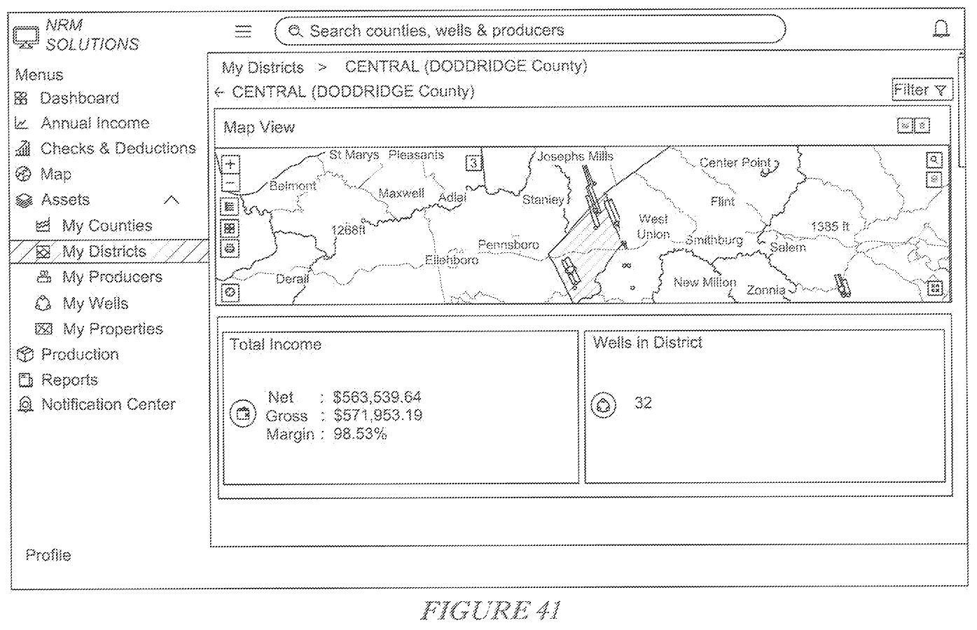

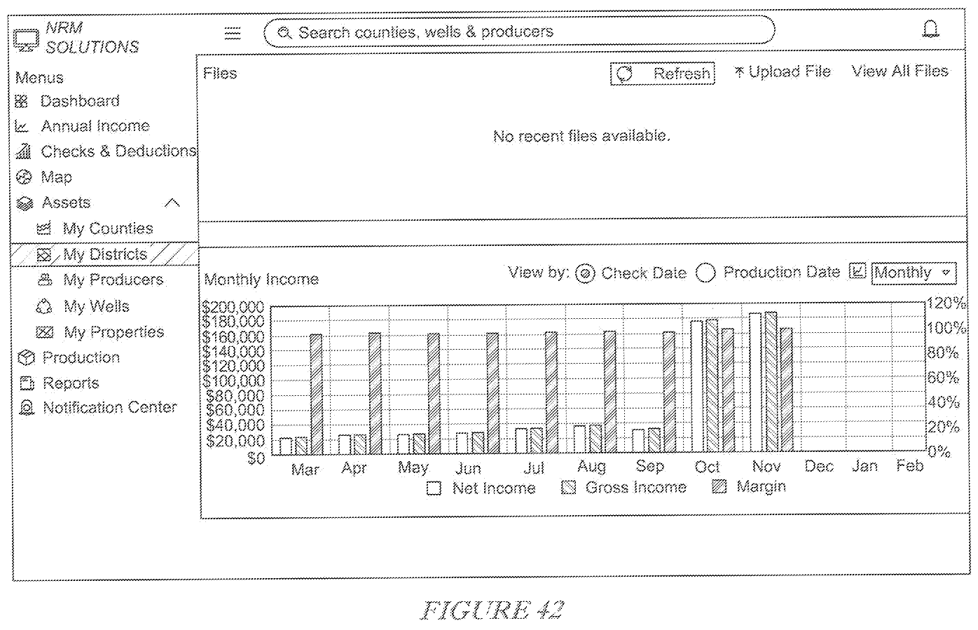

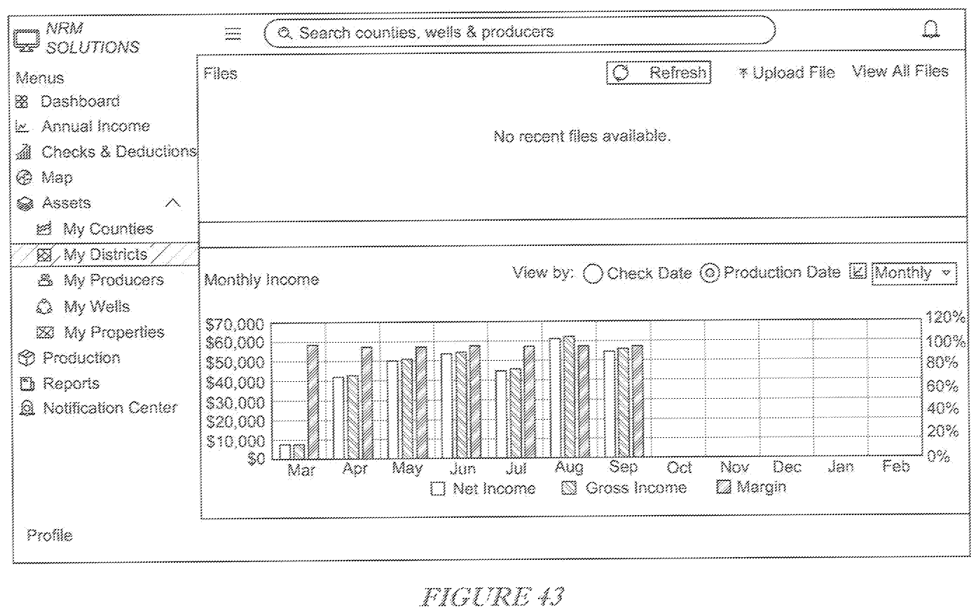

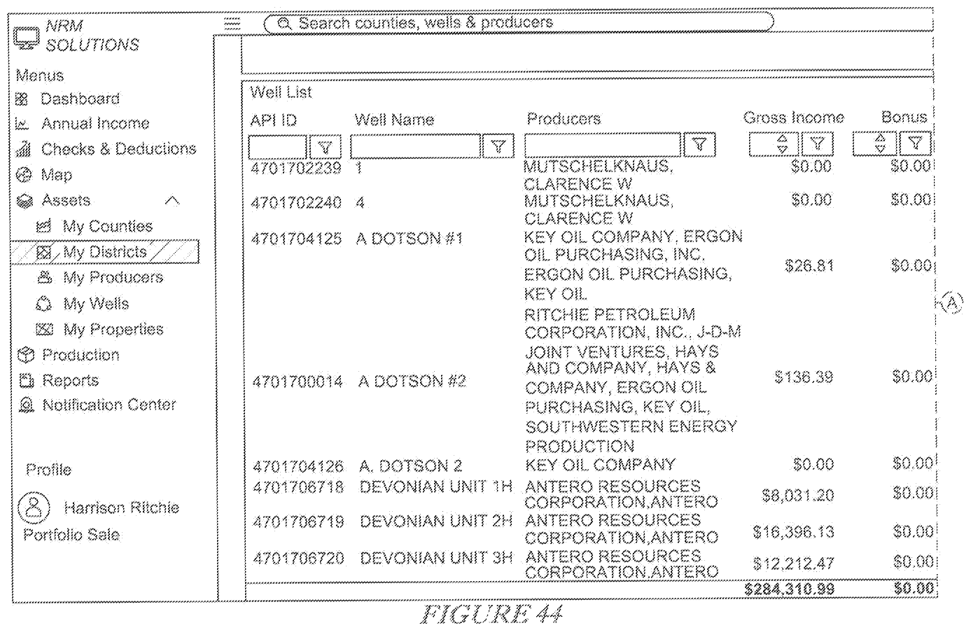

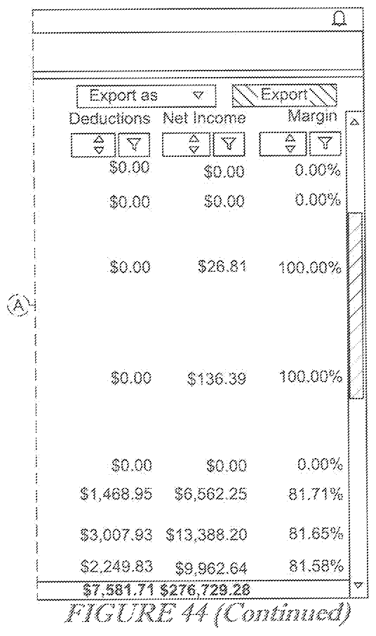

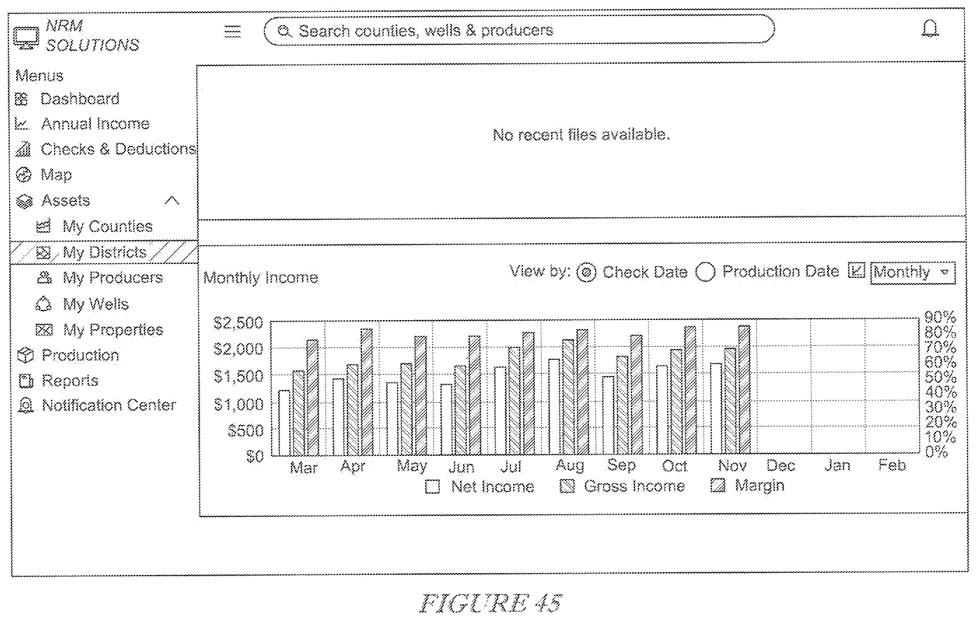

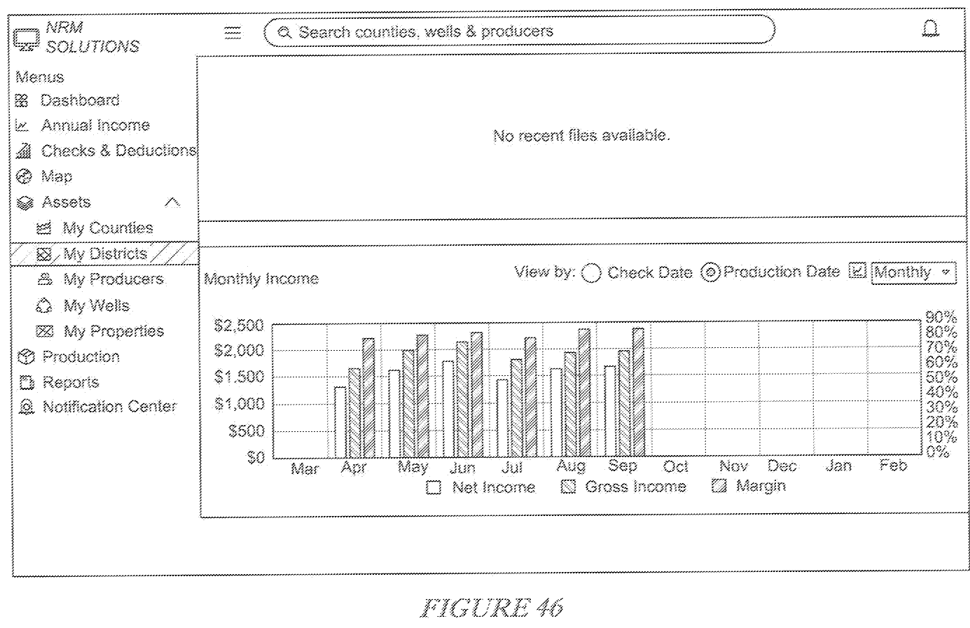

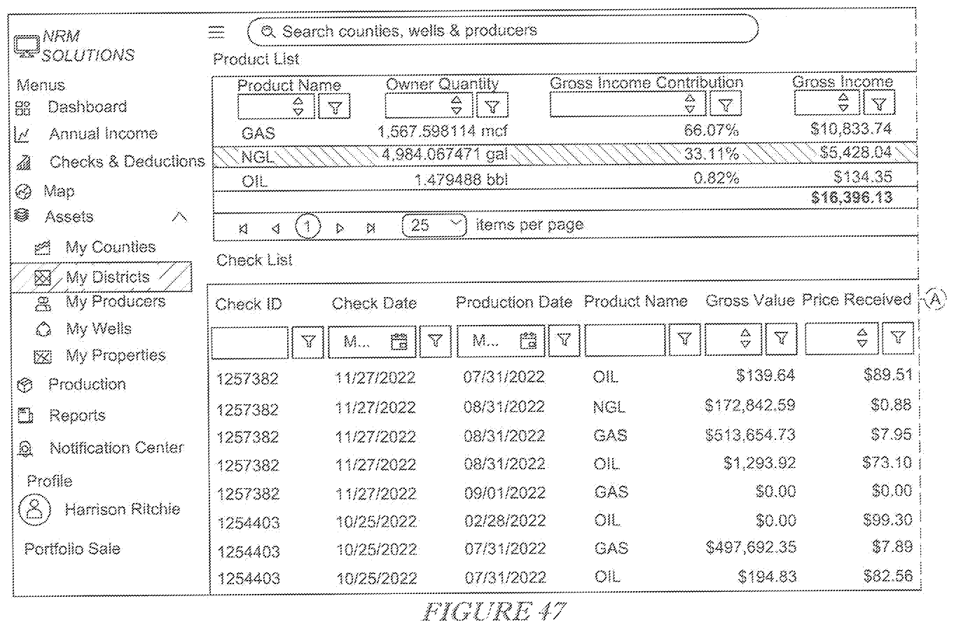

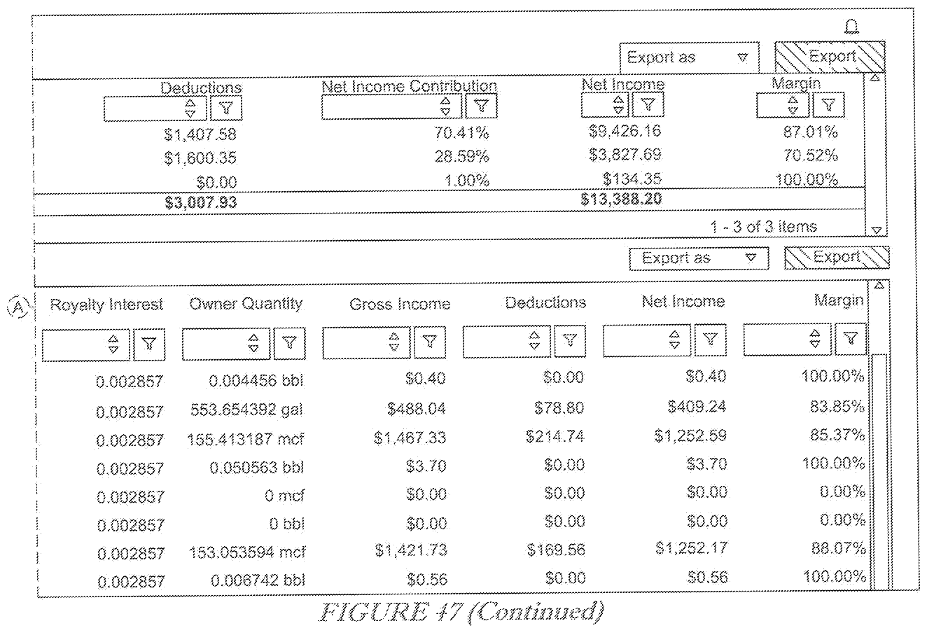

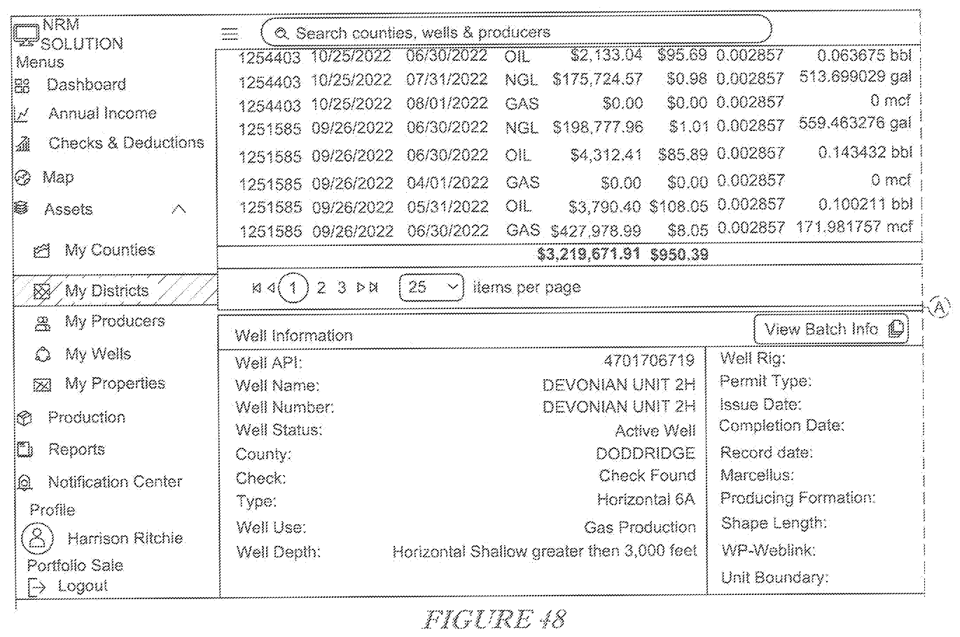

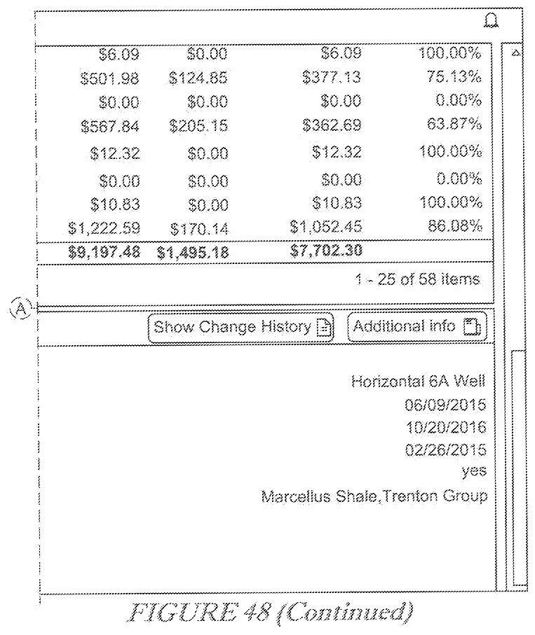

The districts screens may include various types of information including summary data for the top three districts as well as detailed information about all the districts in which the user has properties/wells (see FIG. 39). The displayed data may be filtered using the filtering functionality included in the upper right hand corner of the screen (see FIG. 40). The user may trigger display of geographic map data associated with particular districts from that screen (see FIG. 41) and periodic, historical income data both on a check date basis (see FIG. 42) and a production date basis (see FIG. 43). Moreover, selecting or hovering on constituent data therein may trigger additional detail for each well in the district as shown in FIG. 44, with historical data also accessible as shown in FIGS. 45 and 46), with constituent product detail listings (FIG. 47) and other associated well information (FIG. 48).

Of particular note, selection of particular well entries enables display of revenue details associated with the well (see FIG. 49).

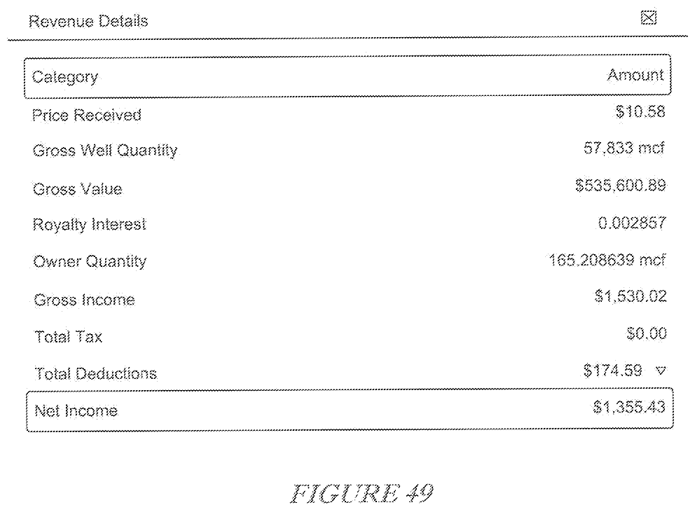

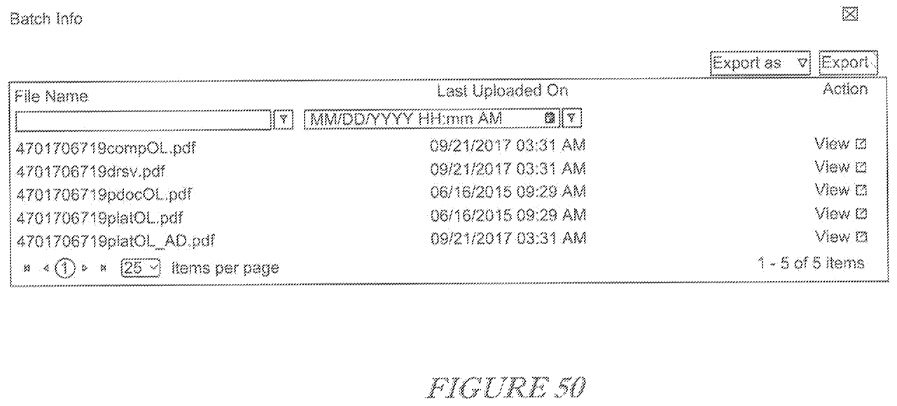

As discussed above, the system provides the ability to analyze and display data associated with particular properties within an owner's portfolio may be analyzed at the property level (particularly including associated tax data) and the well level. In addition, the system provides a mechanism for uploading and storing but also exporting data associated with the portfolio by uploading files that are relevant and provide that data. Thus, as shown in FIG. 50, the system provides the ability to export stored files, e.g., PDF, Excel or other format files analyzed and referenced by the system to pull data from and populate the database structure as discussed with reference to FIG. 1. In addition, the storage/document inventory function may also provide the ability to track changes in stored data with associated details including timing and personnel associated with such changes as shown in FIG. 51.

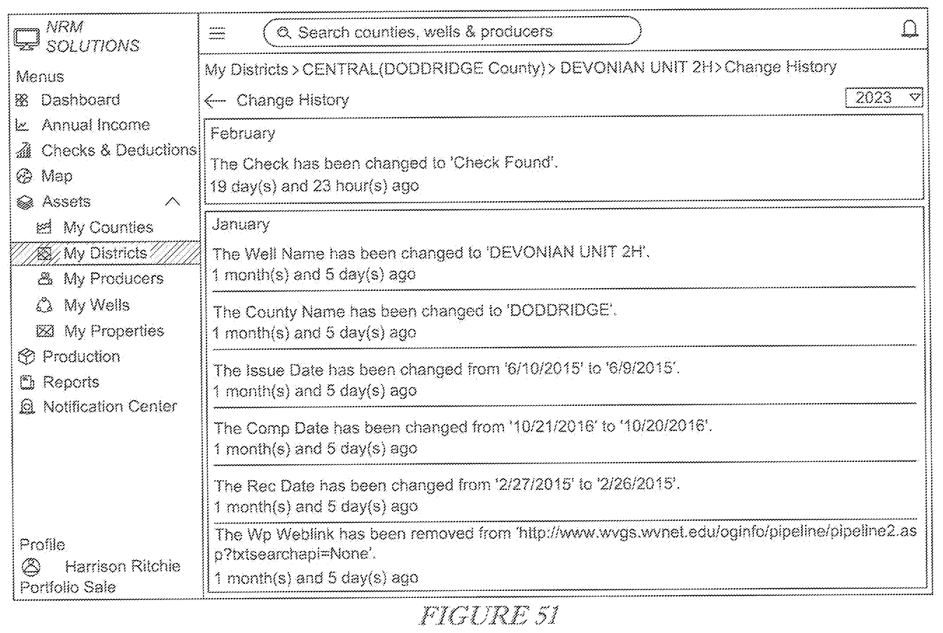

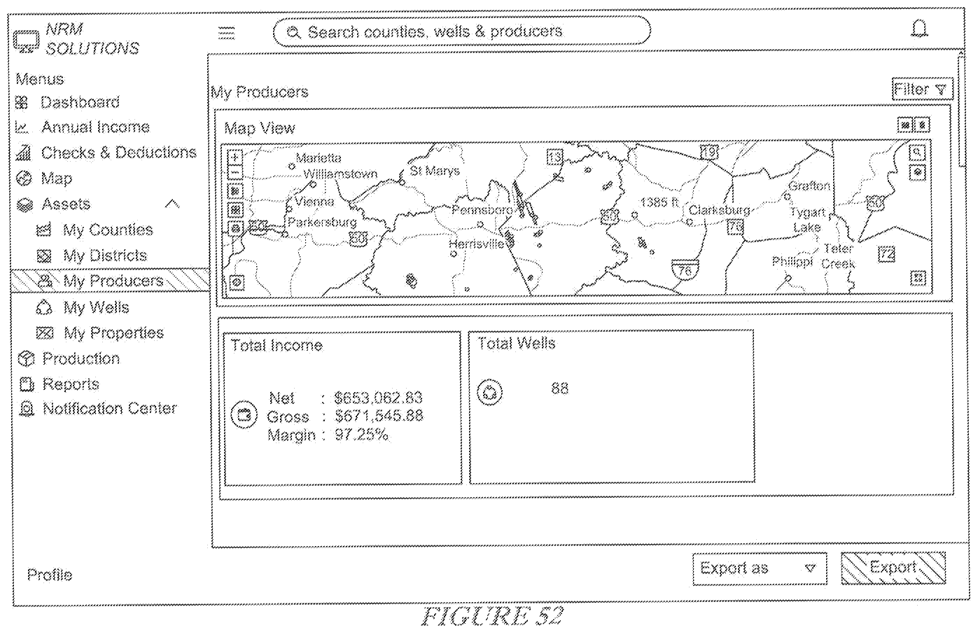

As illustrated in FIG. 52, a my producers screen (which also corresponds to operators drilling and removing materials from a user's property by operation of wells) may provide a user with a map overview of a user's properties and the wells that burden a user's properties. The screen(s) may also include a total income section with a user's total income information by gross, net, and margin. The screen may also include a total wells section that lists the total number of wells on a user's properties.

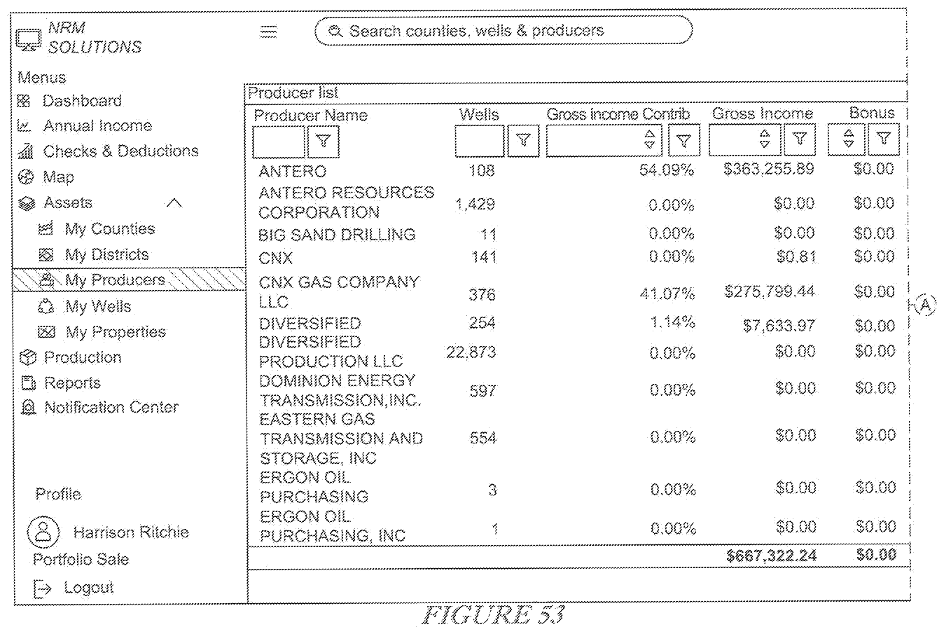

Optionally below the total income and total wells section may be a display of a producer list (see FIG. 53) that includes a comprehensive oil and gas operator that links to a well that burdens a property a user owns. Such a list may contain each producer name, the number of wells the producer operates, the gross income contribution percentage from that operator, the gross income from the operator, the lease bonus, deductions, net income contribution, net income, and margin.

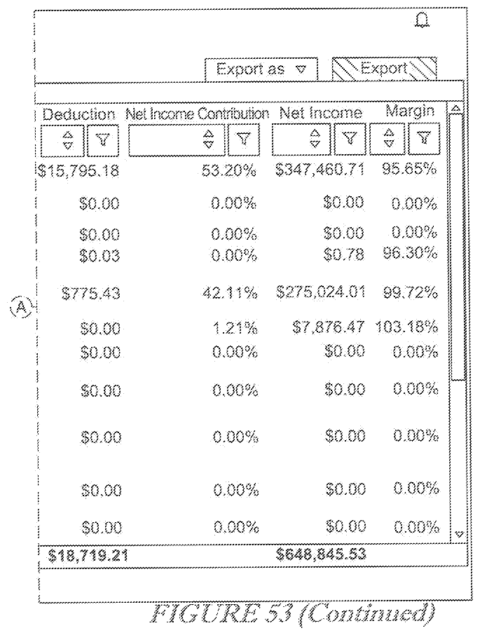

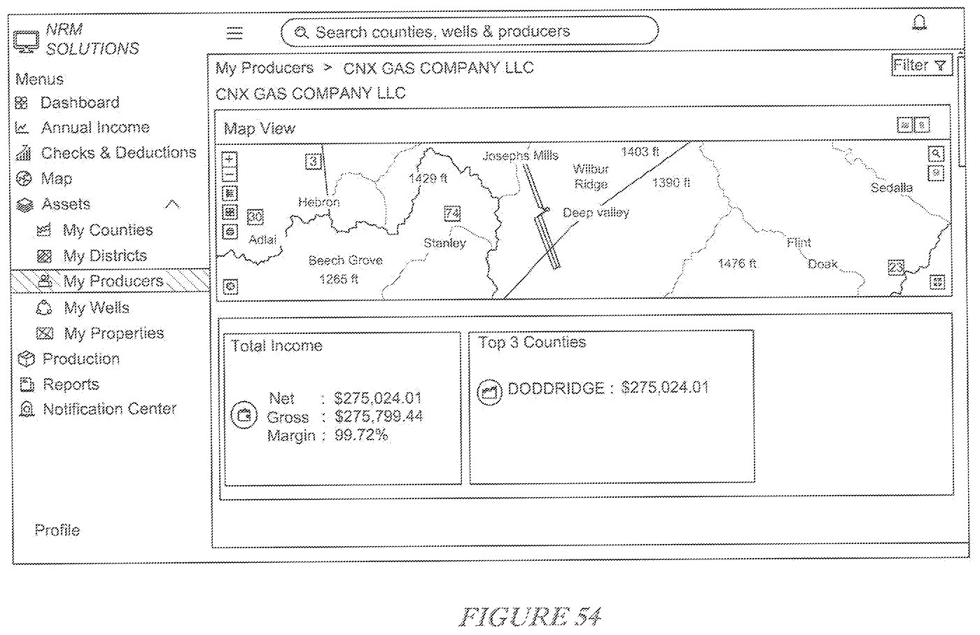

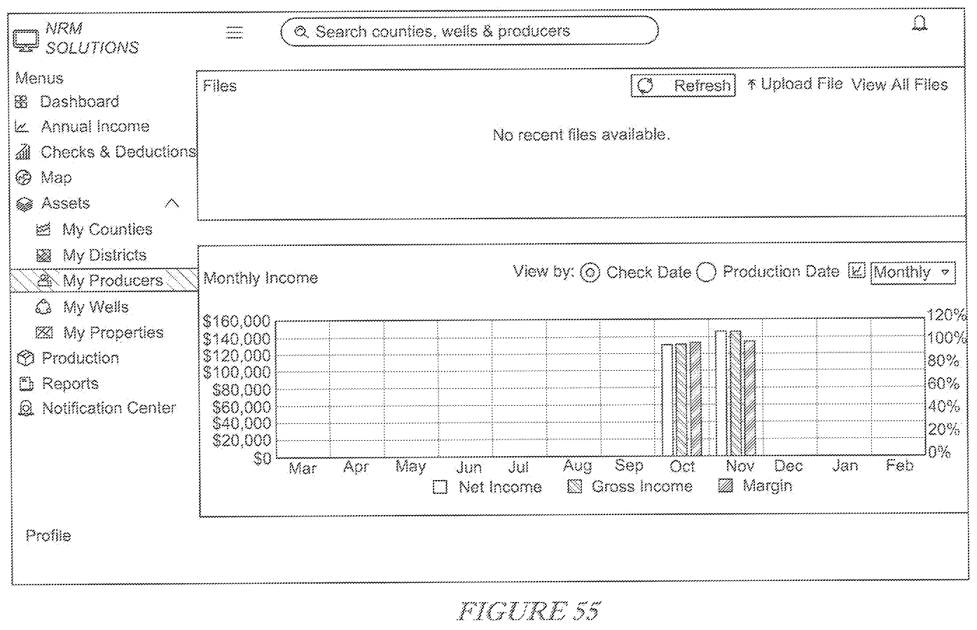

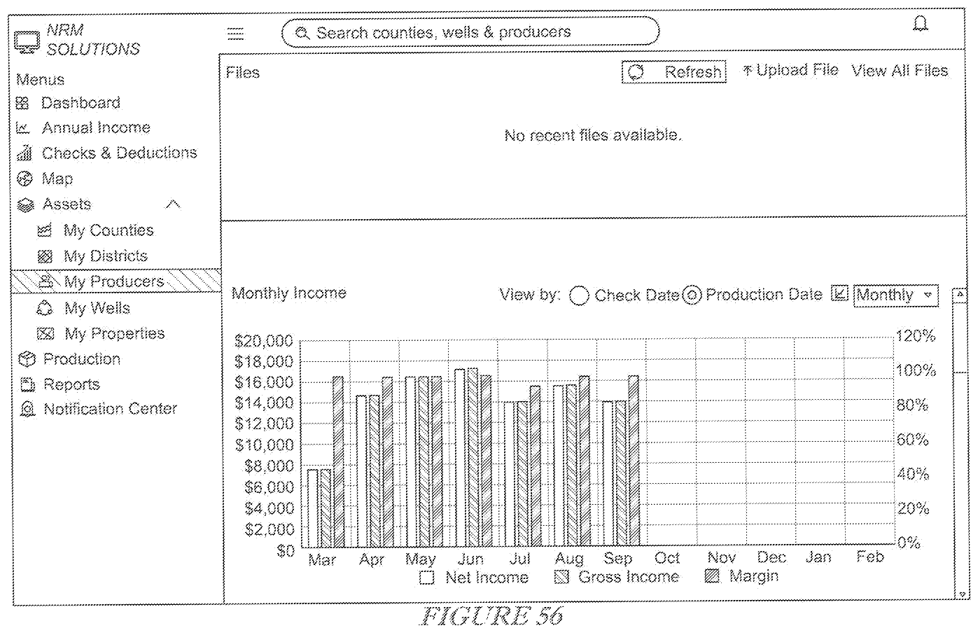

In response to a user selecting a specific operator, a new screen may appear that may include a map, a total income section, and a top three counties section for that specific operator (see FIG. 54). Such a map may be particularly unique because it only displays the wells that the chosen producer operates for the particular user. Therefore, this map removes the noise of all other wells and shows a user exactly what a specific operator is to pay a user for on a monthly royalty basis. Below the maps and sections may be another monthly income chart that displays the trailing twelve-month income information for the chosen operator or producer for the user (see FIG. 55 (check basis) and FIG. 56 (production date basis)).

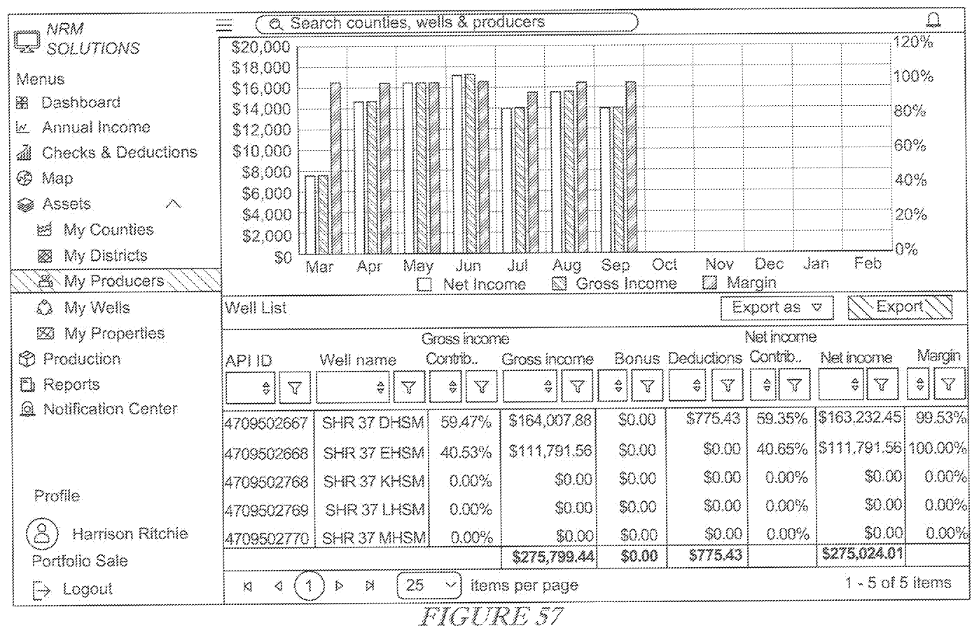

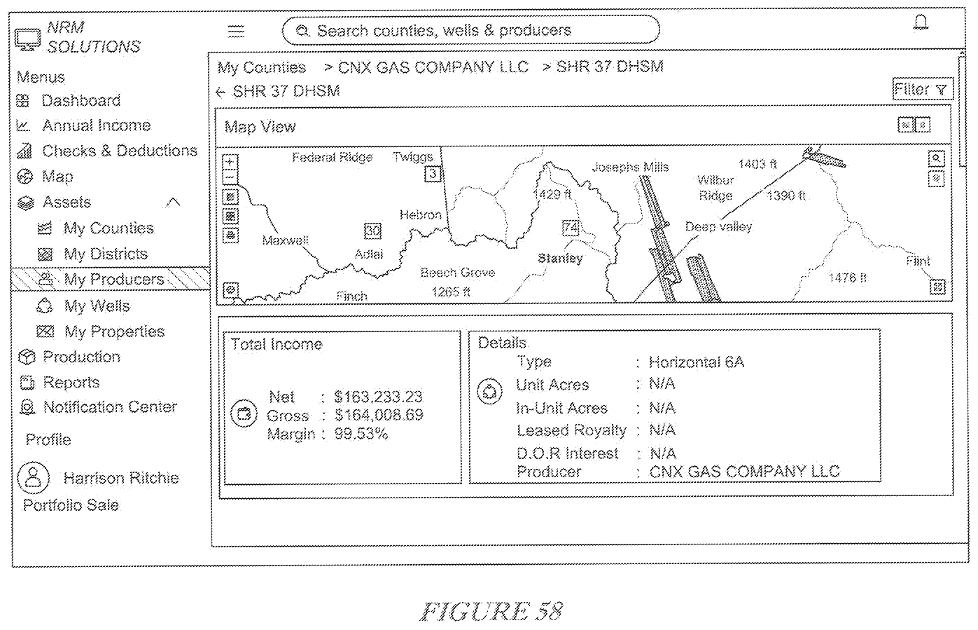

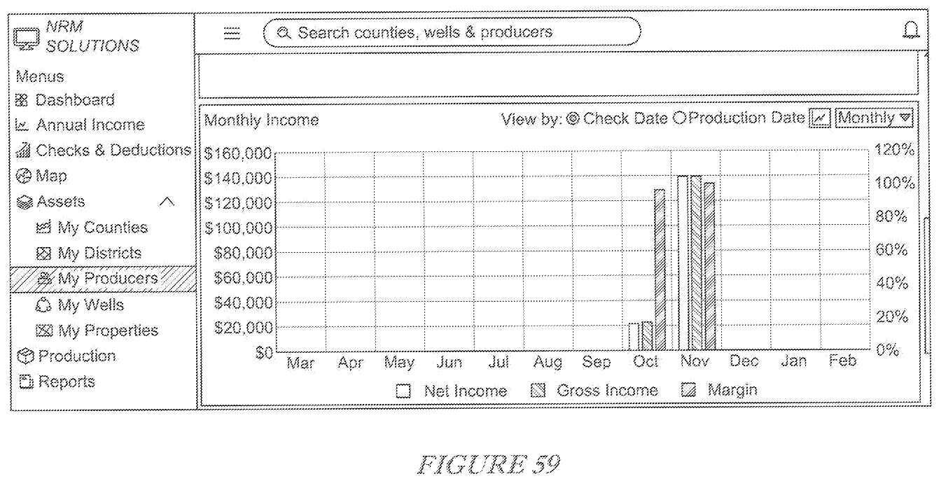

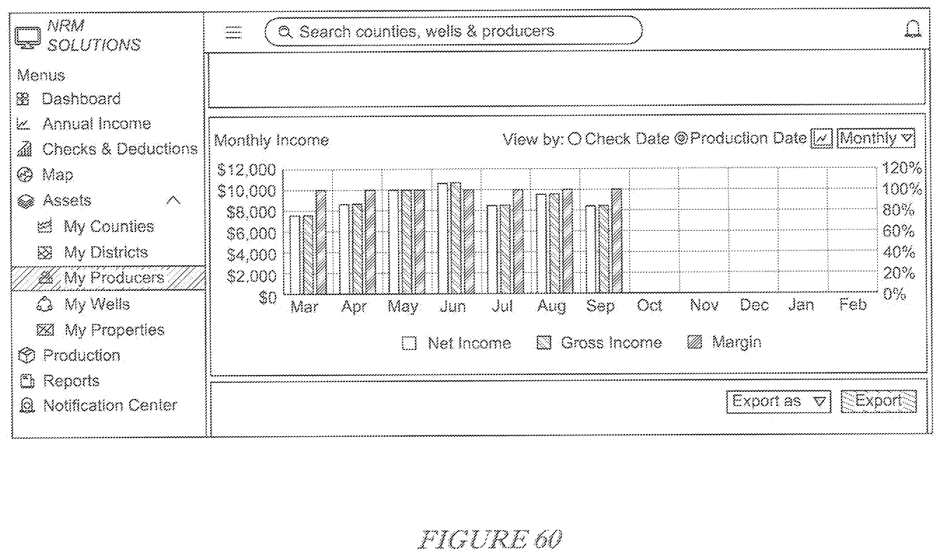

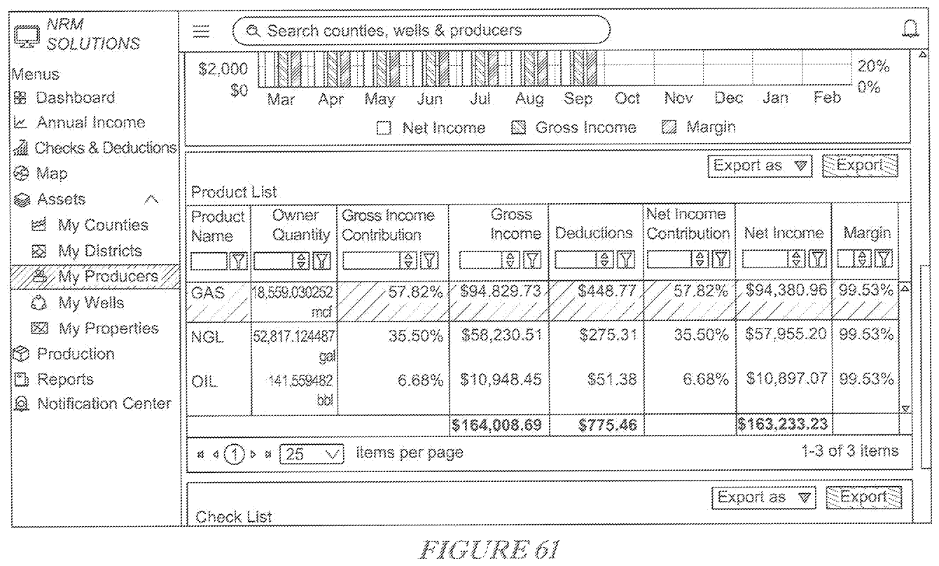

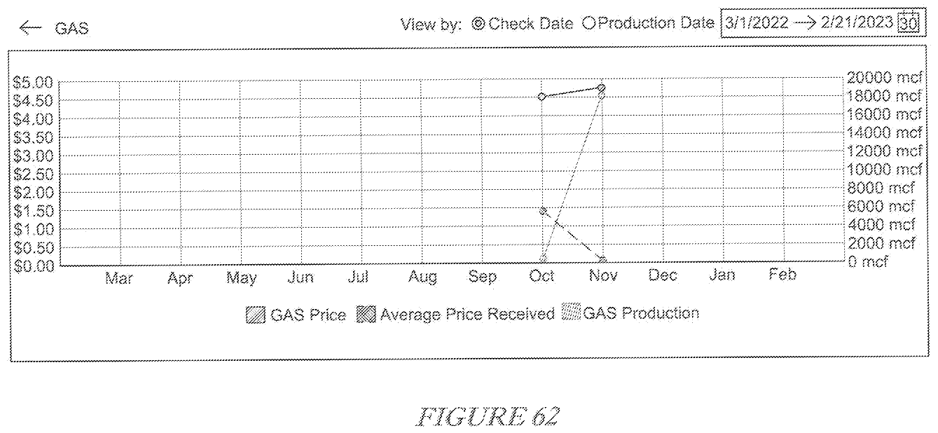

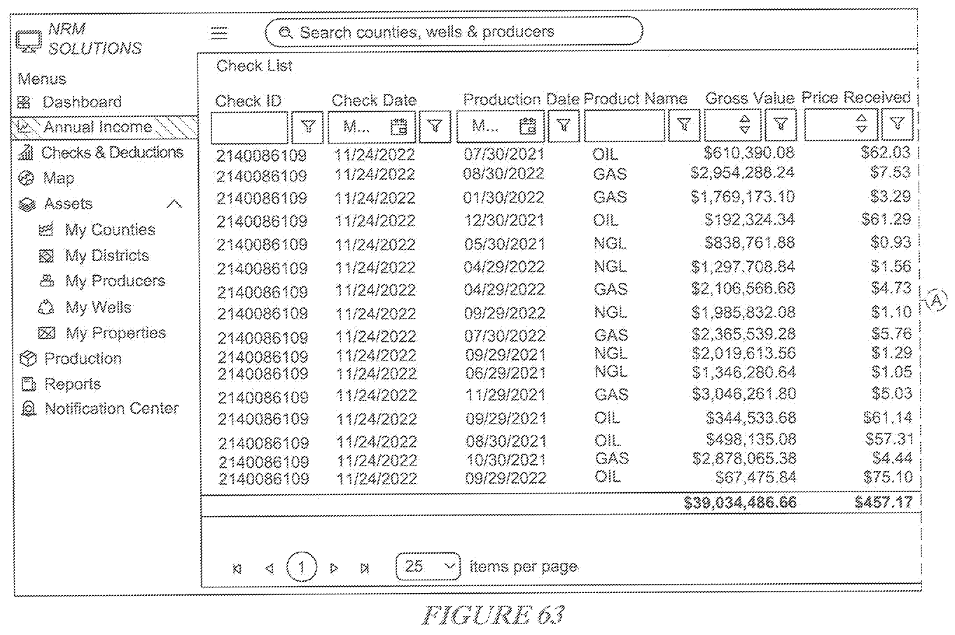

Below that chart may be a comprehensive list of all oil and gas wells that the chosen producer operates and pays royalties for to the user (see FIG. 57). This well list may be the same as the other well lists in the system; however, in response to the user clicking on a specific well, the system may direct a user to a new screen and immediately highlight the well on a map and the property the well encumbers (see FIG. 58) and also provide access to the monthly historical income provided by the well (see FIG. 59). Still further monthly income data may be listed on a historical basis (FIG. 60) with the ability to review displayed product contribution to overall revenue (see FIG. 61) and the ability to graphically chart the product contributions on an individual basis (sec FIG. 62).

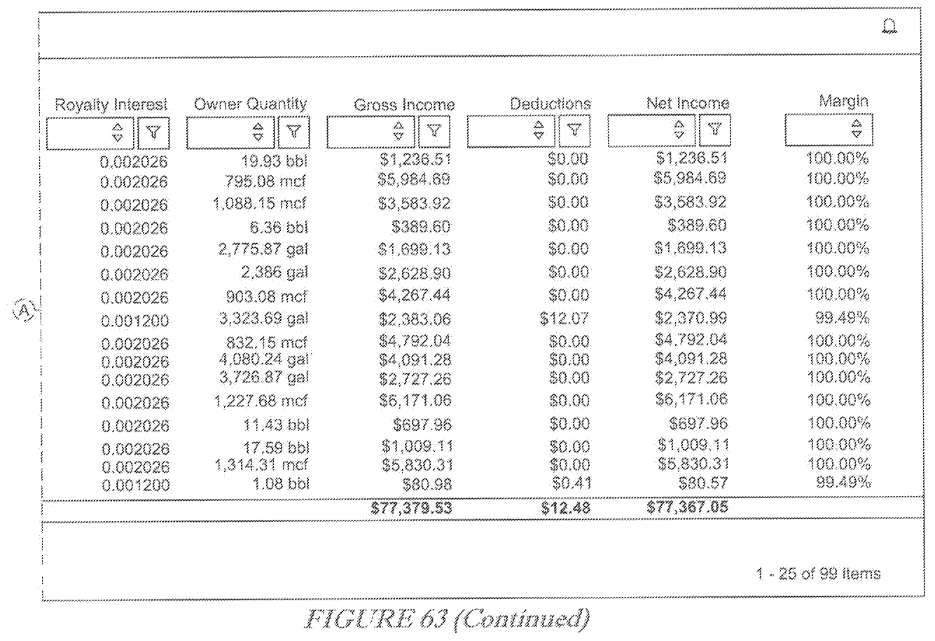

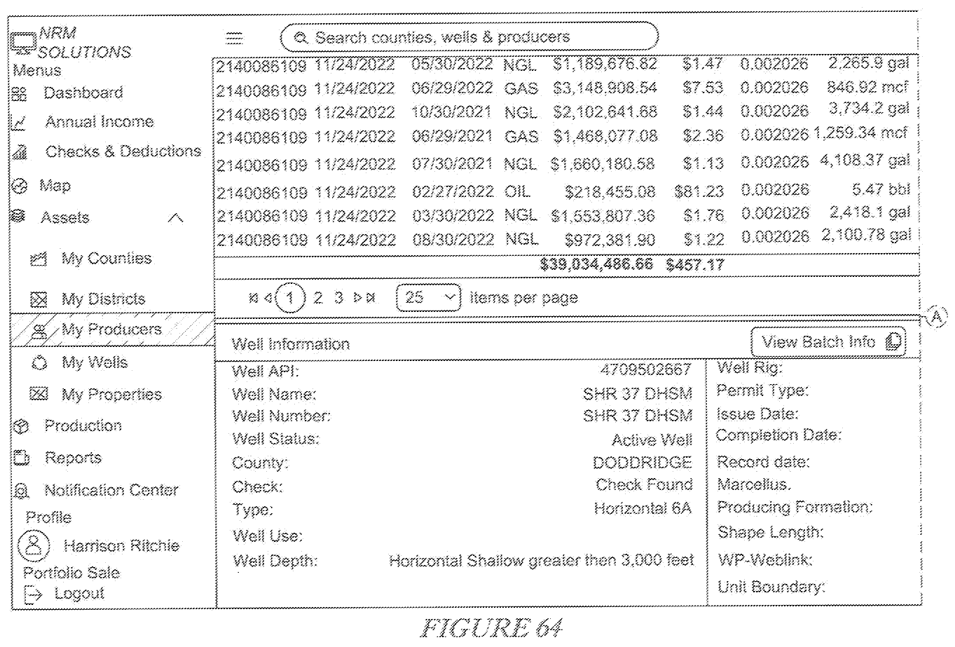

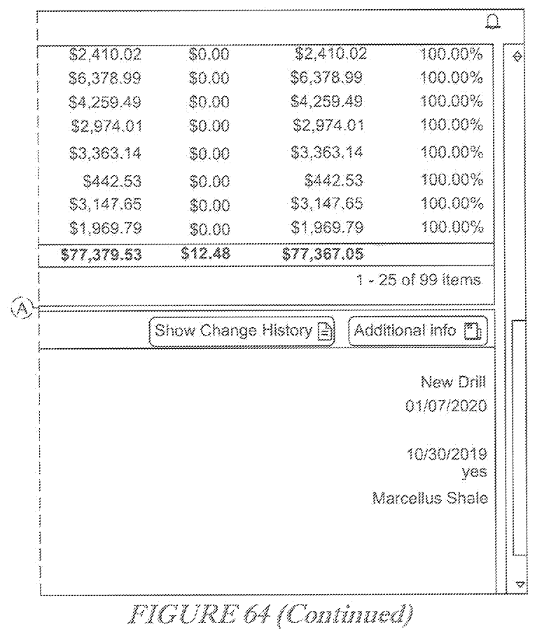

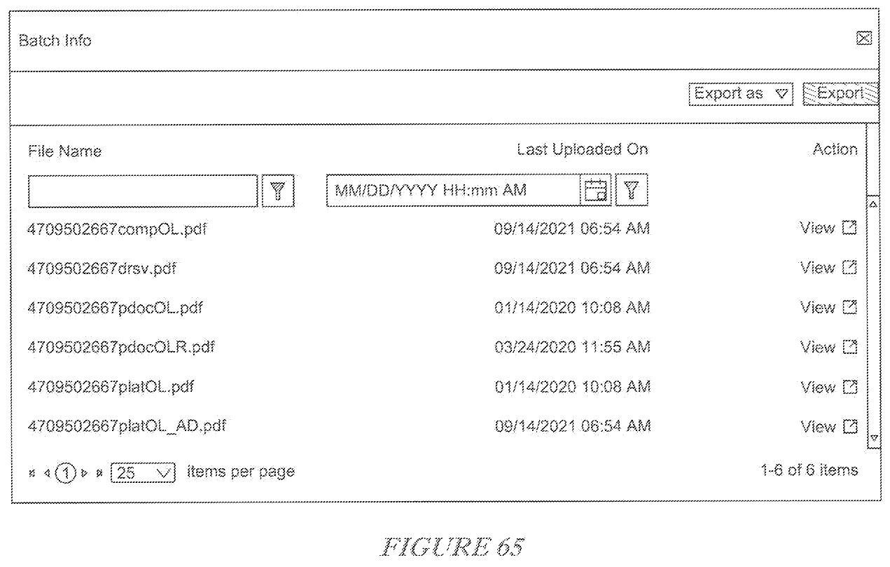

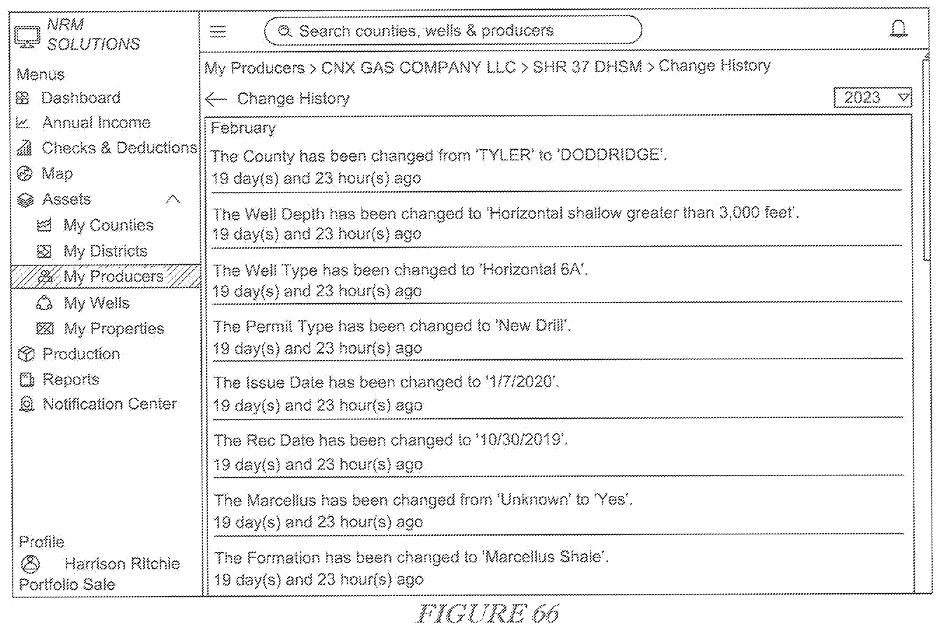

In addition, the producer screen(s) may be configured to display a comprehensive list of all checks issued to the user by the producer with associated detail data (FIG. 63), associated well information (FIG. 64), associated documentation of payments, etc. exported from to the system (FIG. 65), and change history with dates and personnel data (FIG. 66).

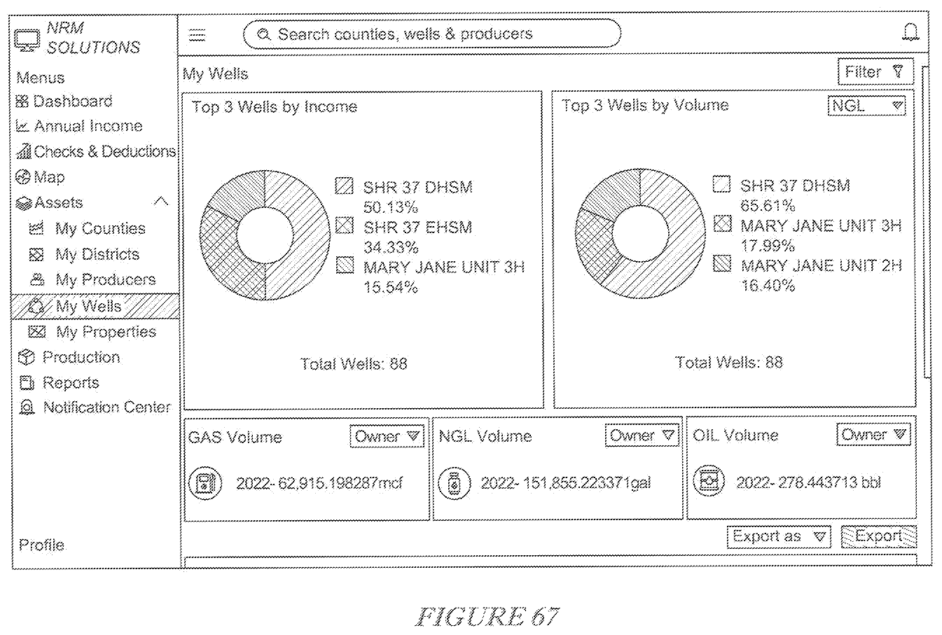

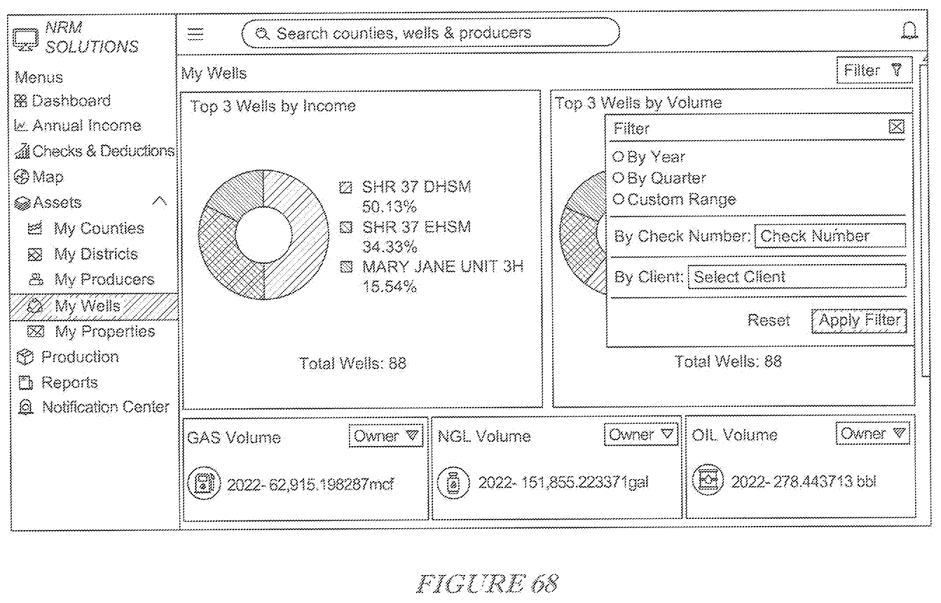

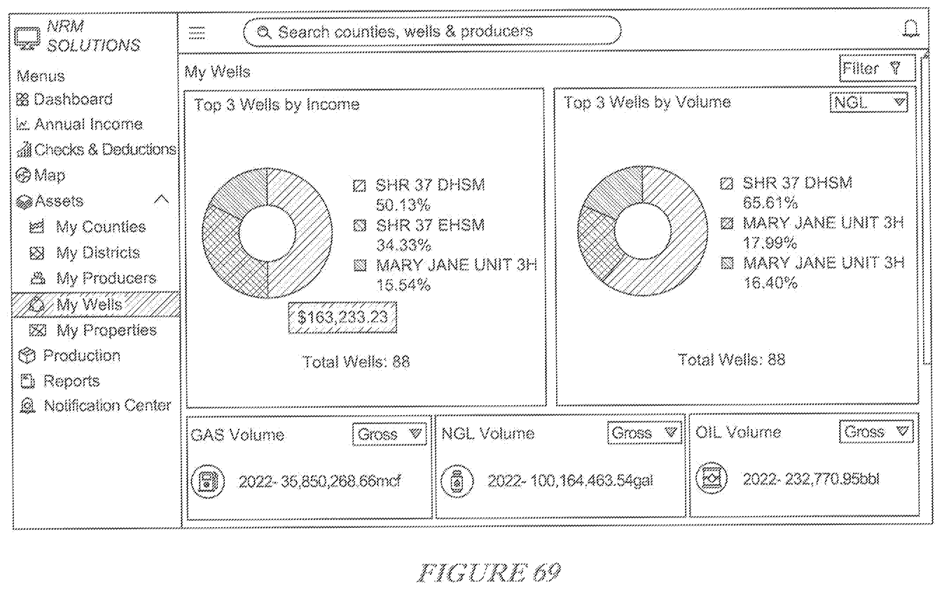

As explained above, various disclosed embodiments of the system may provide user interface screens that enable review of data that enable an owner to understand how much they are being paid and what the basis for that payment is. Accordingly FIGS. 67-80 provide examples of screens that are configured to provide additional detail regarding data on a well-level. As shown in FIG. 67, at the top of my wells screen example, a top three wells by income section may be displayed on the left and a top three wells by volume section on the right. As a result, a user can sort the top three wells by volume by product type. Displayed data may be filtered as shown in FIG. 68. Like the other sections that contain pie graphs, a user can hover over a portion of the graph and view the revenue information (sec. FIG. 69).

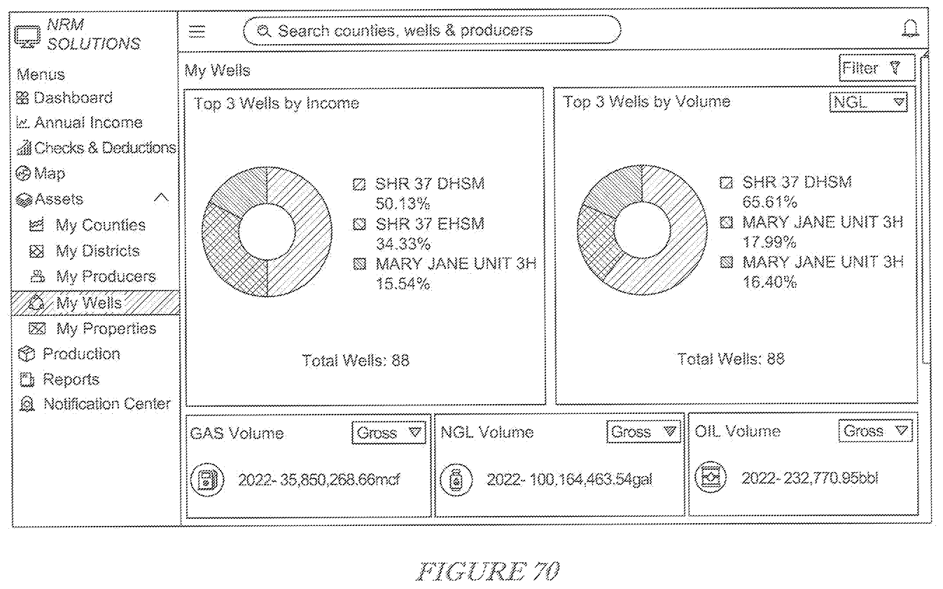

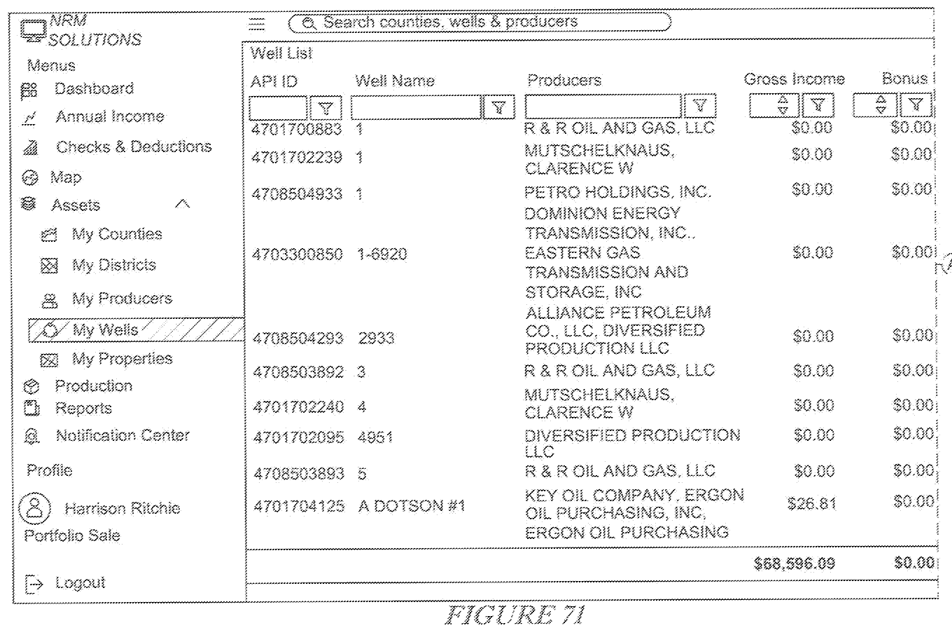

Below the two pie chart sections, the screen may include data sections associated with (1) gas volume, (2) NGL volume, and (3) oil volume (see FIG. 70). Each section may display volume information and overall total production volume from the wells in a user's portfolio including gross, net or margin information for a particular period of time, e.g., a particular year.

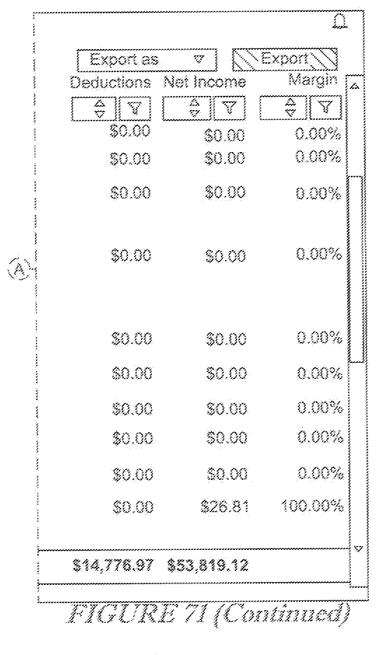

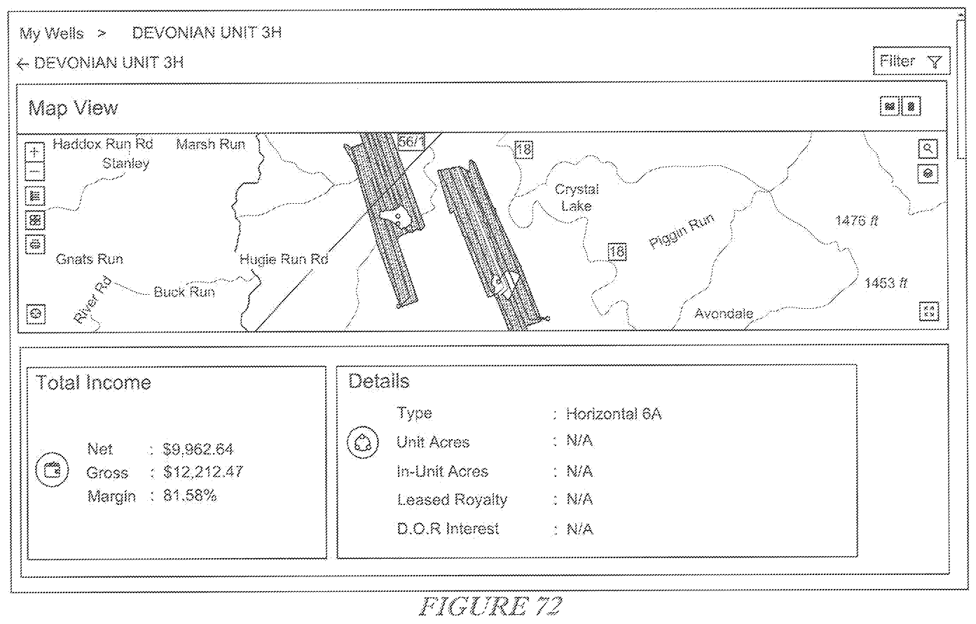

Below the volume sections may be provided well list data (see FIG. 71), that provides a comprehensive list of all wells that encumbers each of the user's properties. The displayed data may include, for example, (1) API ID, (2) well name, (3) producer name, (4) gross income, (5) lease bonus, (6) deductions, (7) net income, and (8) margin. Further, a user may see a total income section for the well, a detail section which includes the type of well, unit acreage, lease royalty, division royal interest. Below the list, a user may have the familiar bar graph with a user's monthly income from that well, which is sortable by check and production date.

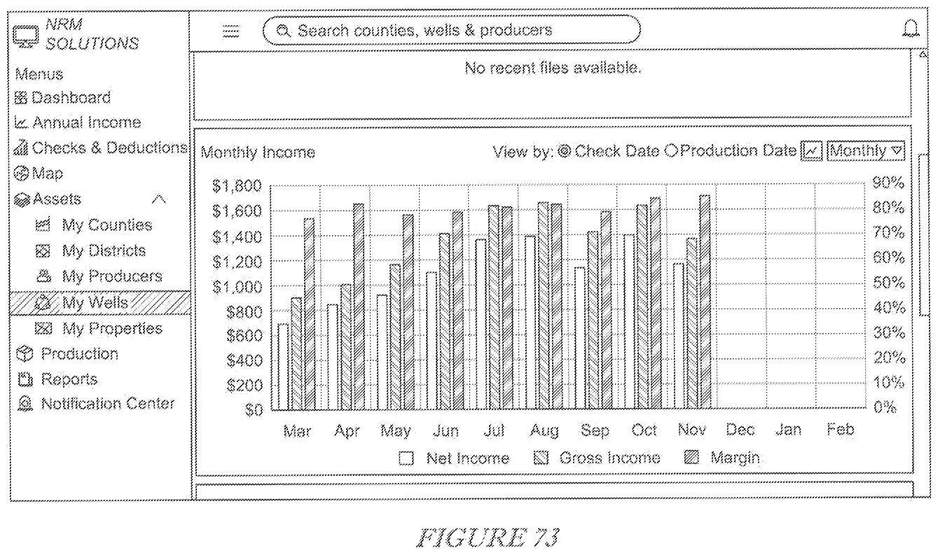

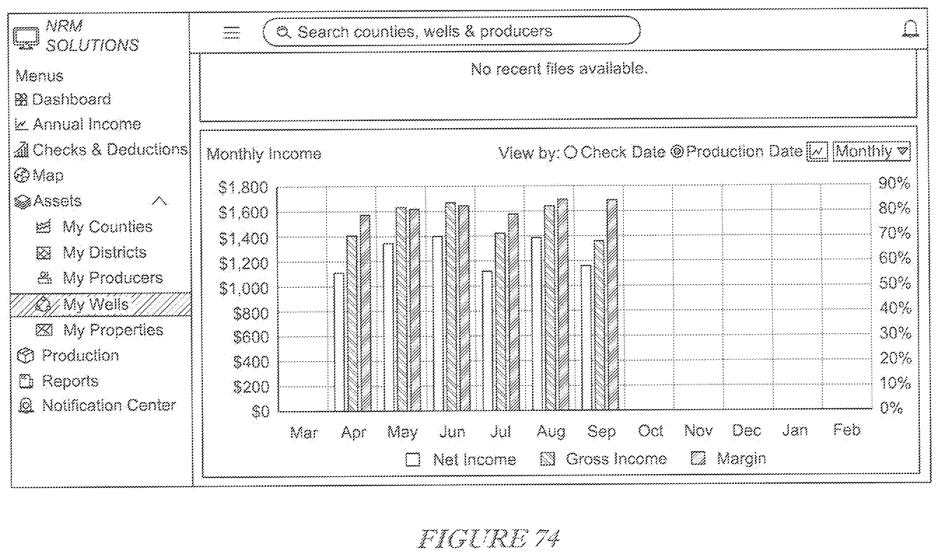

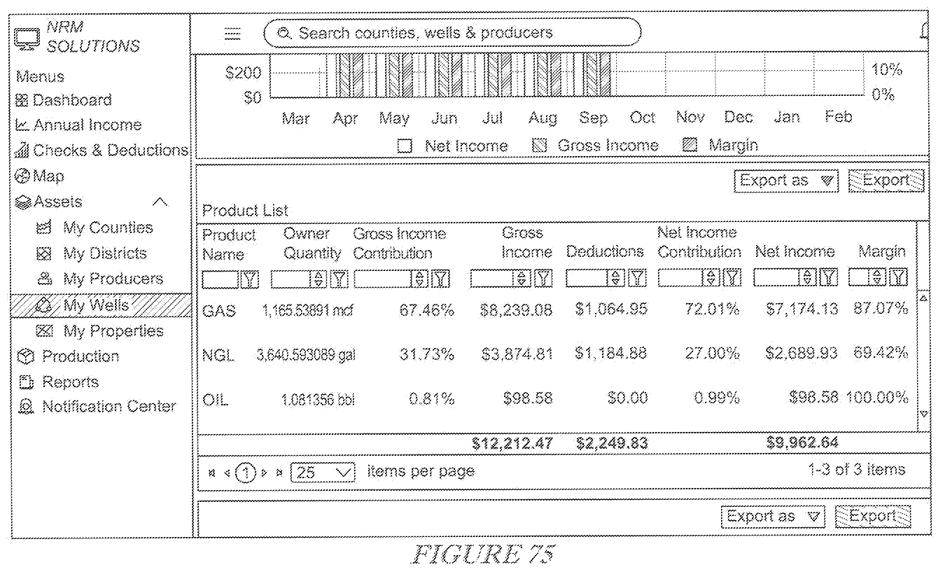

If a user selects or click on a particular listed well, a display of a geographical location of the well may be displayed (see FIG. 72) with associated income and geographic details if entered into the system. This display, in turn, may be used to enable the user to review monthly income data associated with the particular well (on a check basis in FIG. 73 and a production basis in FIG. 74) along with data indicating the constituent composition of product recovered from the well (see FIG. 75). This list may show a user each product produced by the well, being gas, NGL, and/or oil. Additionally, a user may see the owner quantity, gross income contribution, gross income, deductions, net income contribution, net income, and margin for each well.

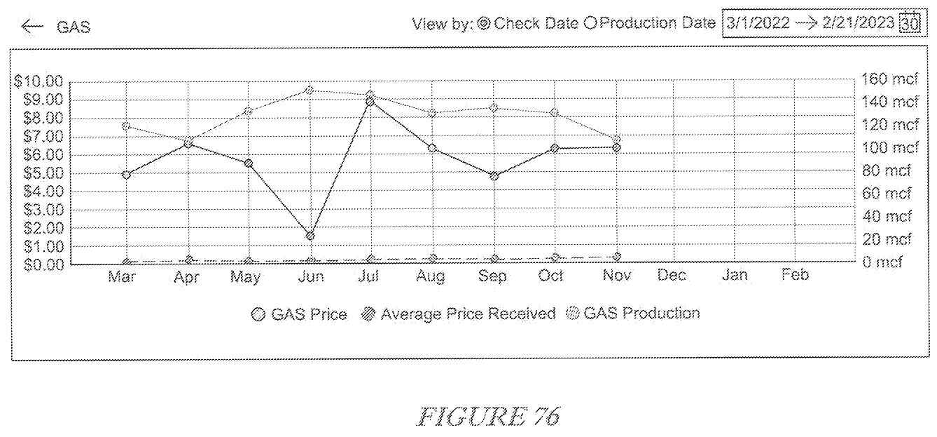

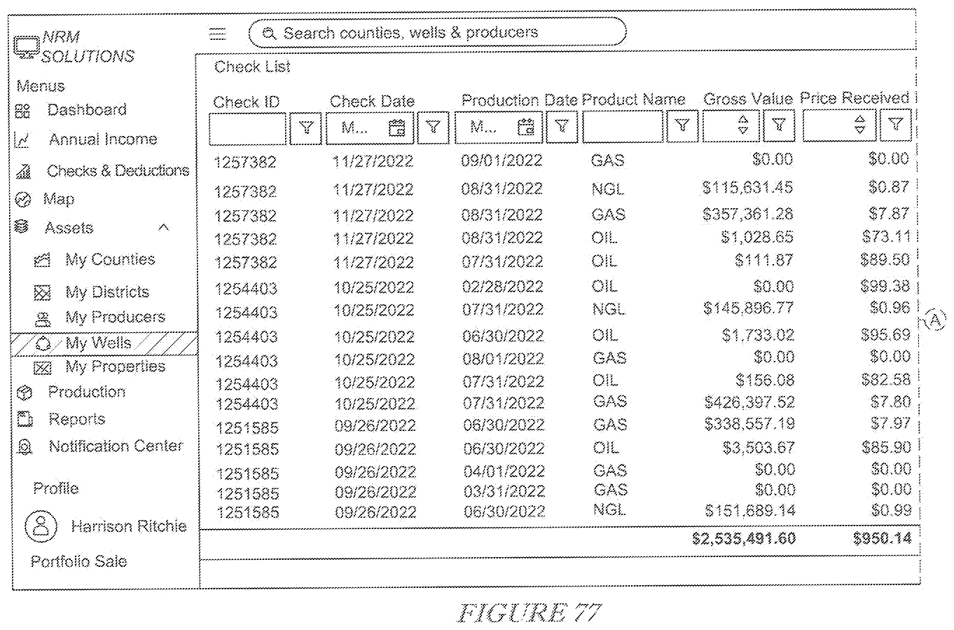

Of particular, note, a unique feature of the inventive system is that, in response to a user clicking on a product such as gas, a user may see a chart that shows the price of gas a user received by month over the last twelve months, the owner volume produced by the well, and the NYMEX price of the product over the past twelve months (see FIG. 76). This functionality is particularly significant because a user can immediately analyze if the price the operator paid a user correlates with the market price. If the price is out of line, a user can quickly review the production and prices paid by other operators in the area and compare the price per unit payments. This is critical to a landowner or royalty owner being able to determine whether they are being underpaid. Such data is particularly useful in determine whether and how to proceed with further extraction of material, negotiating of contracts with various operators regarding the same and providing evidence in connection with business and business related litigation.

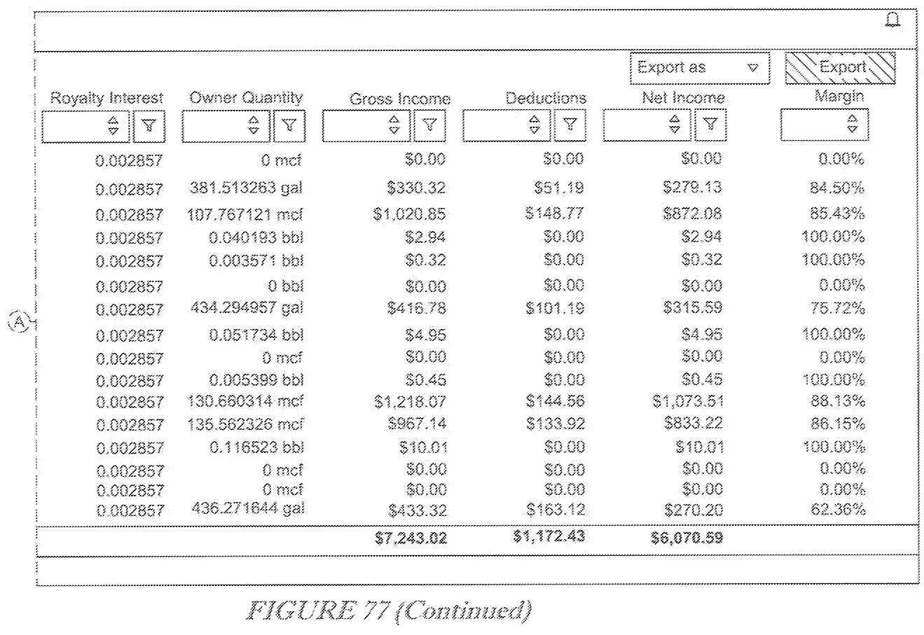

Still further, my wells screens may include display of check lists including a comprehensive list of every check that a user has received and has been entered into the disclosed system for storage, documentation and analysis. The check list may include, for example, various types of data including (1) check ID. (2) check date, (3) production date, (4) product name, (5) gross value, (6) price received, (7) royalty interest, (8) owner quantity, (9) gross income, (10) deductions, (11) net income, and (12) margin (see FIG. 77).

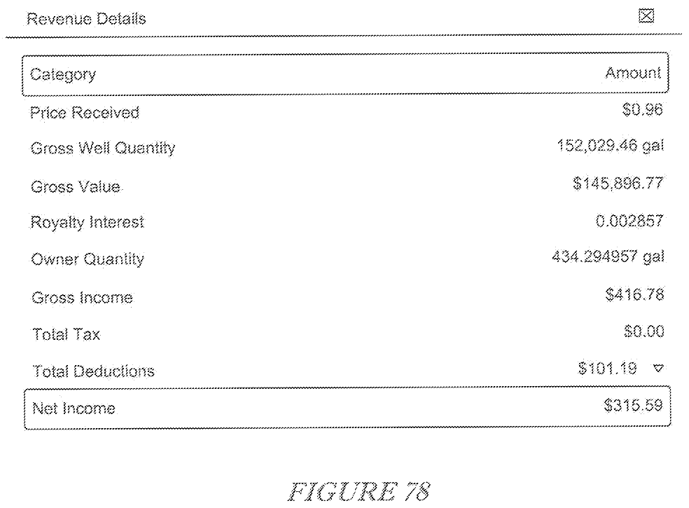

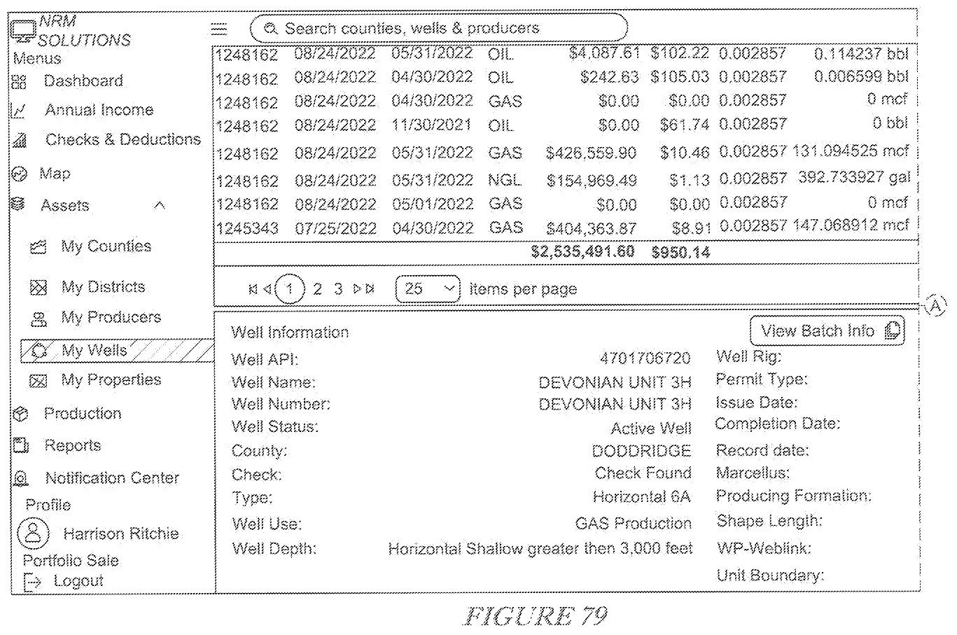

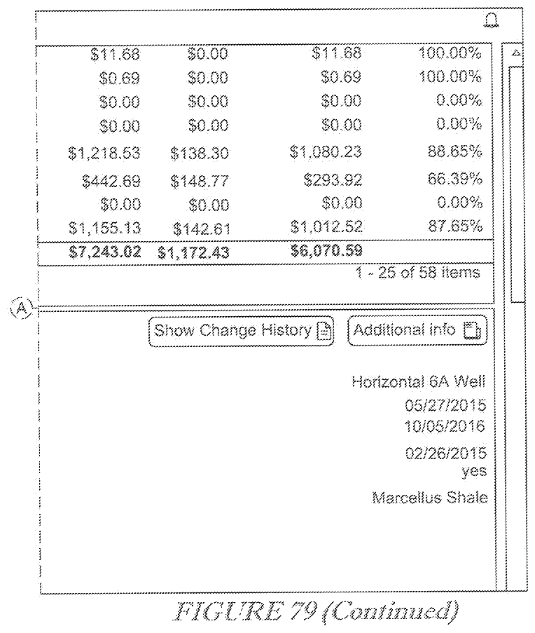

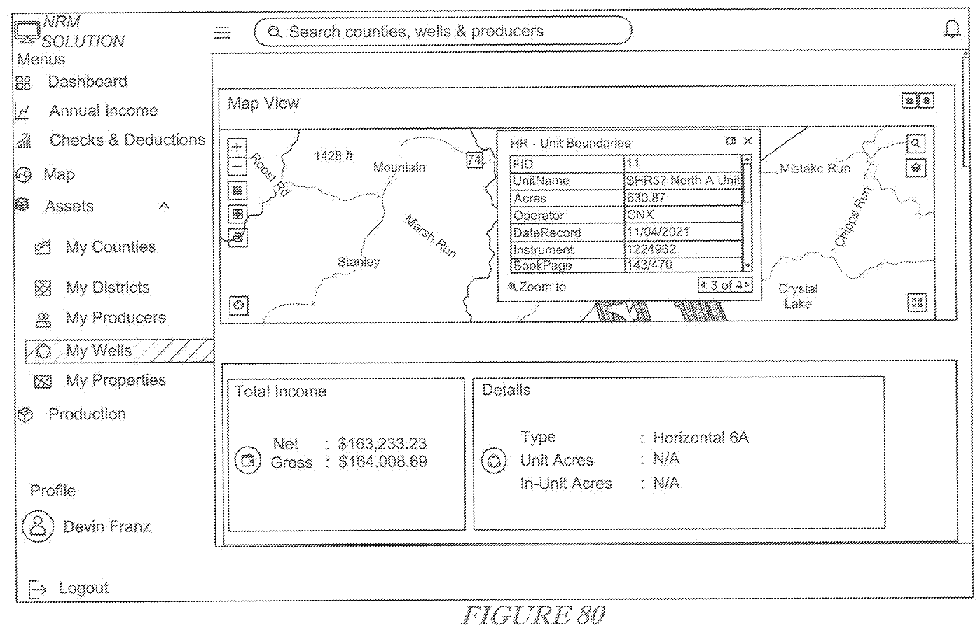

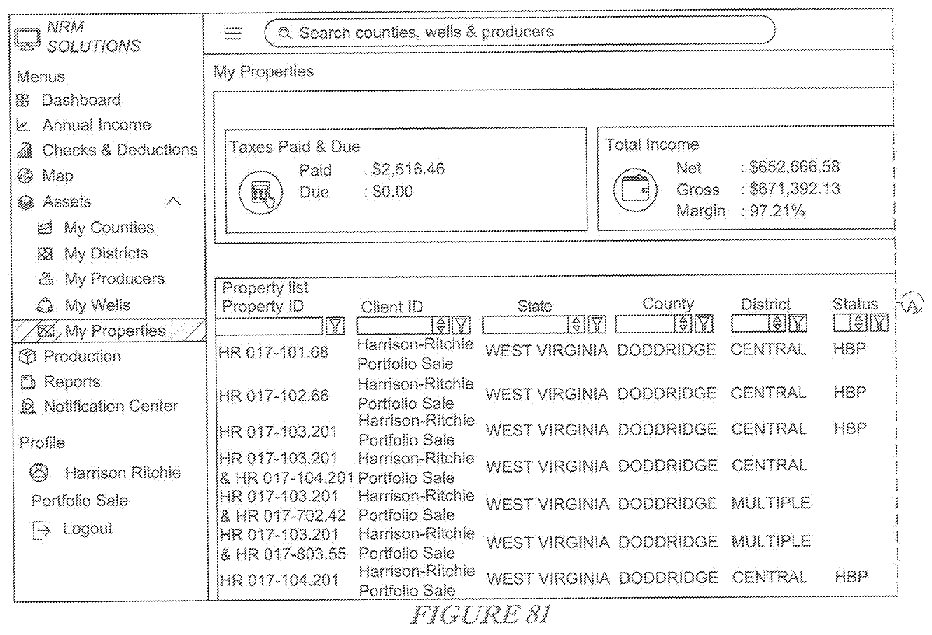

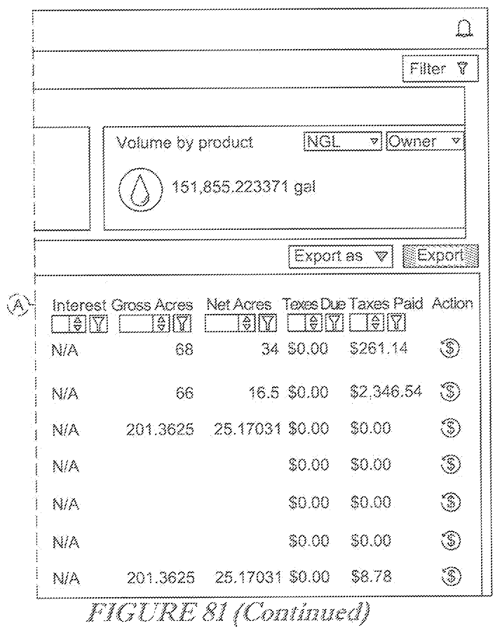

A user may also have the ability to click on check entries to trigger display of data indicating exactly what came from that check, price receive, quantity, values, a user's interest, deductions, etc. (see FIG. 78) with associated well list details (sec. FIG. 79), and map view data (FIG. 80).

This concept of a check list for display to a user is technically useful for two reasons. First, display of this comprehensive data enables a user to determine if an operator has missed a periodic, e.g., monthly payment based on the check date or production date. Second, and more importantly, the check list provides data that enables the ability to determine the division order interest. As illustrated, this is identified as the “royalty interest.”

Division Order Interest is the proportional ownership interest of the production a user owns in the well. Thus, if the royalty interest is different than the Division Order Interest (also referred to as the Division Order Royalty Interest and referred to herein as DOI) elsewhere in the system data, the system may be configured to automatically flag the check data and generate an alert to the user regarding the potential miscalculation of a royalty payment. For example, this notification may be generated when the payment is more than a 2% difference from the data listed elsewhere in the system.

Below the check list may be a well information section. This section may include various data including the well API, well name, well number, well status, county, check status, well type, well depth, issue date, record date, and producing formation. As with other pulling of data from publicly available resources, the system may pull and aggregate this information from, for example, the West Virginia Department of Environmental Protection (WVDEP) website. Additionally, the software utilized in the system may be configured to scrape documents from the WVDEP website that are normally difficult and time consuming to find; this is possible because the system is configured to utilize various combinations of subsets of all the search criteria previously aggregated in repeated searching of the databases accessible via the publicly accessible website to identify and download relevant data.

The last screen under the assets screens may be the my properties screen, examples of which being illustrated in FIGS. 81-96. At the top of the my properties screen, three sections may be displayed relating to overall information for a user's properties: (1) taxes paid & due, (2) total income, and (3) volume by product. These sections operate similarly to the other sections with the same names throughout the system.

As shown in FIG. 81, below the overview sections, is a property list that lists every property a user owns and has entered into inventive system for documentation, storage and analysis. Optionally, the system may identify the property under a user's preferred naming convention, for example, listing a property or group of properties with a name or nickname under the client ID header. The list also includes the company or owner name, state, county, district, property status, ownership interest, gross acres, net acres, tax due, and tax paid.

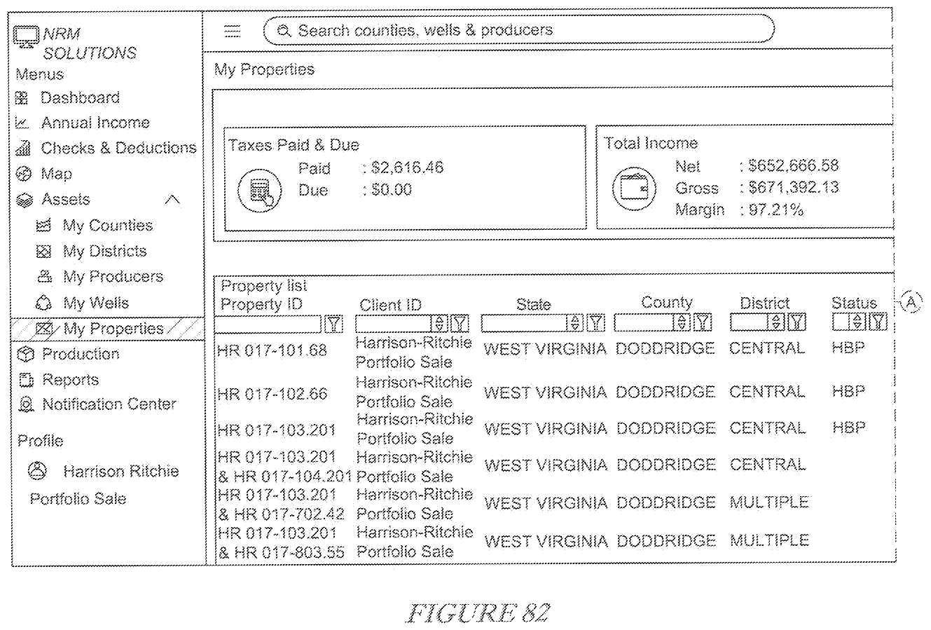

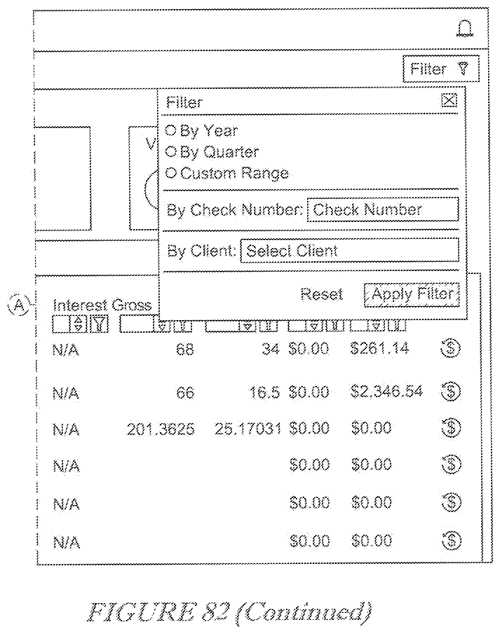

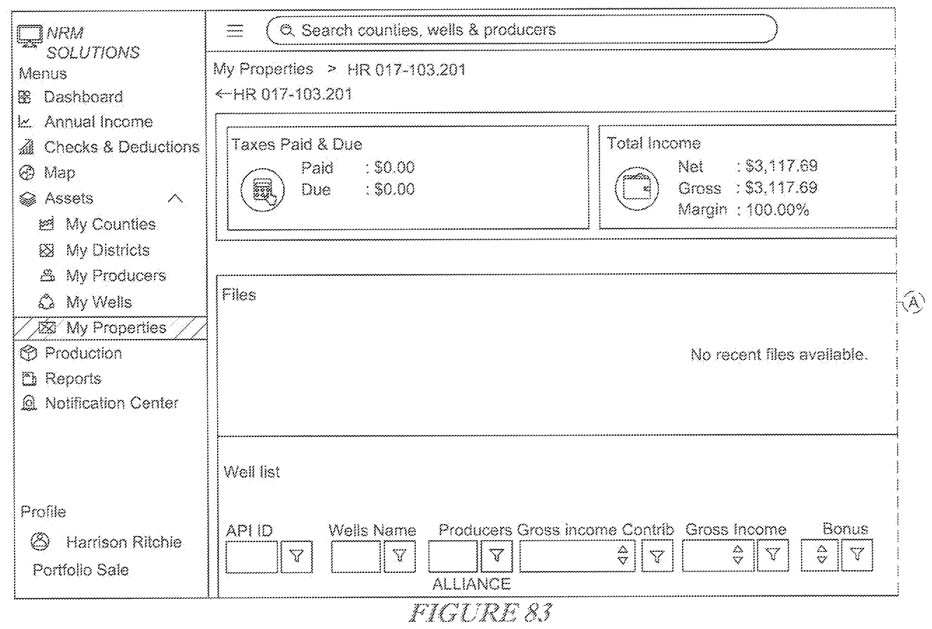

The displayed properties may be filtered as shown in FIG. 82.

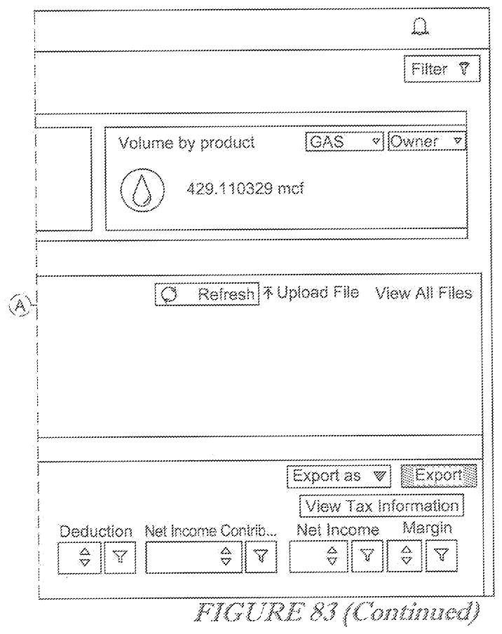

If a user click on an individual property, a user may be directed to that property's screen (see FIG. 83), which displays the aforementioned overview sections but for this particular property along with a list of wells on the property and any files or other documentation uploaded to the system regarding the property.

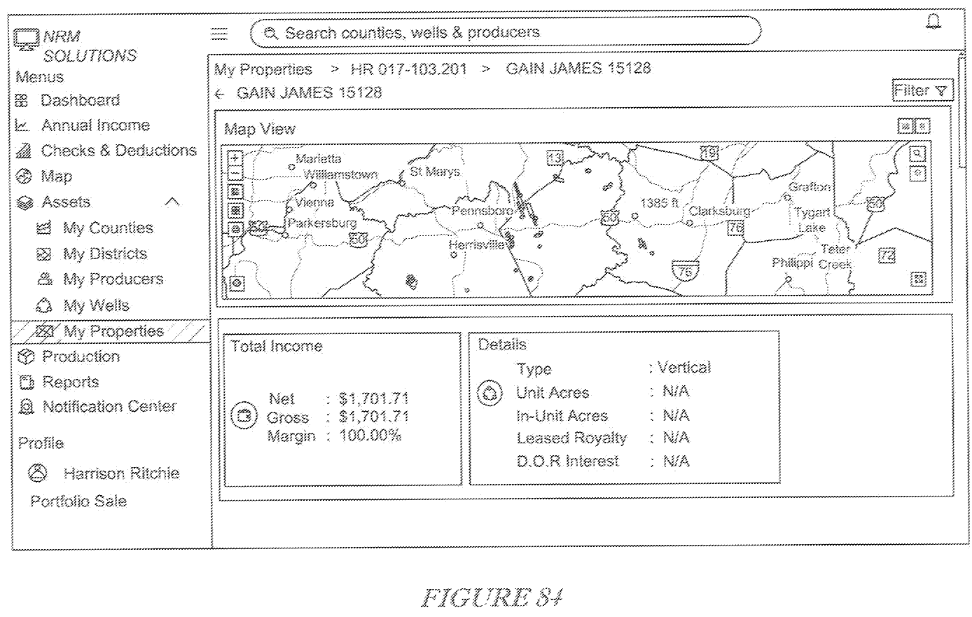

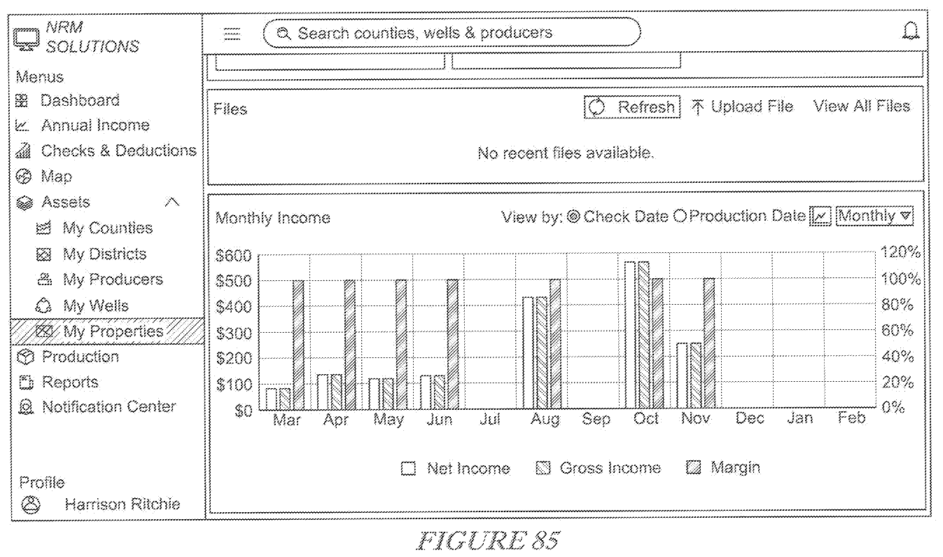

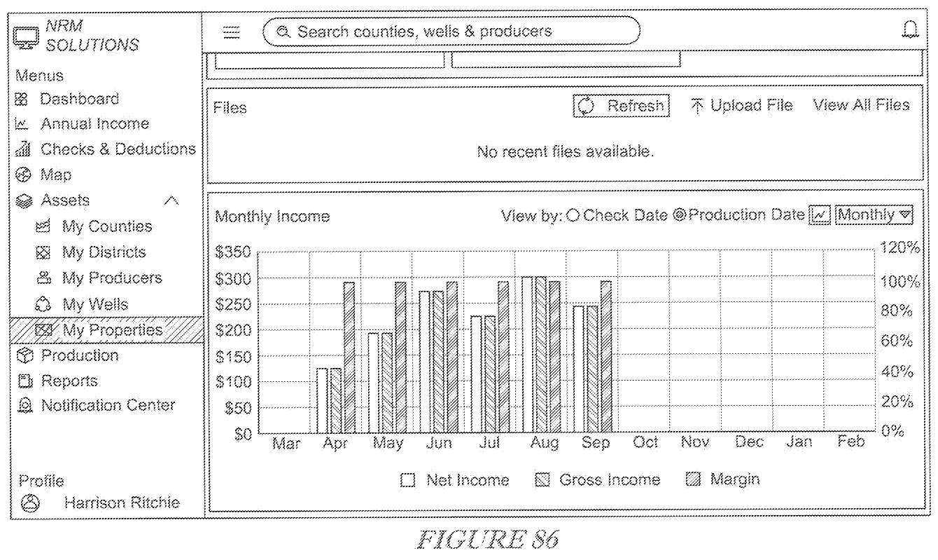

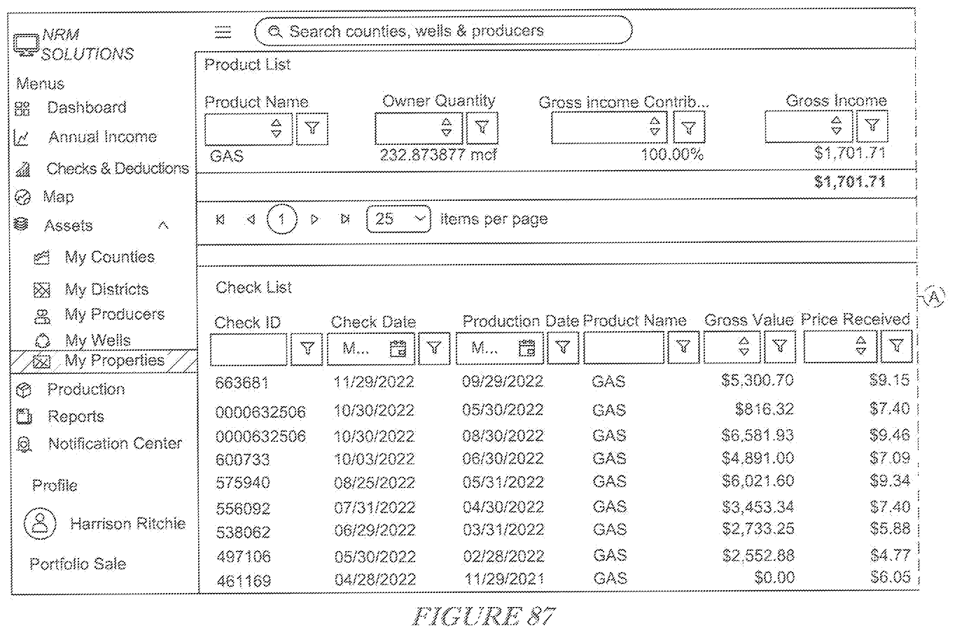

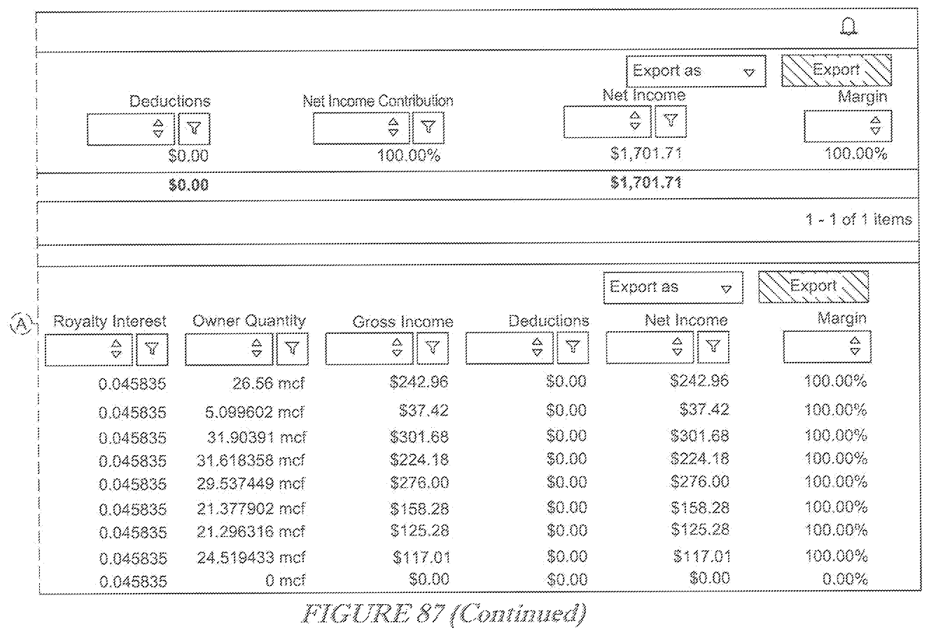

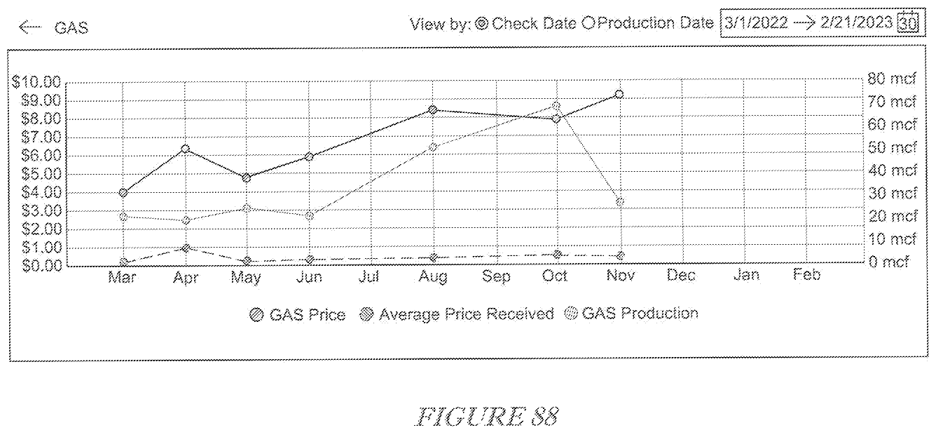

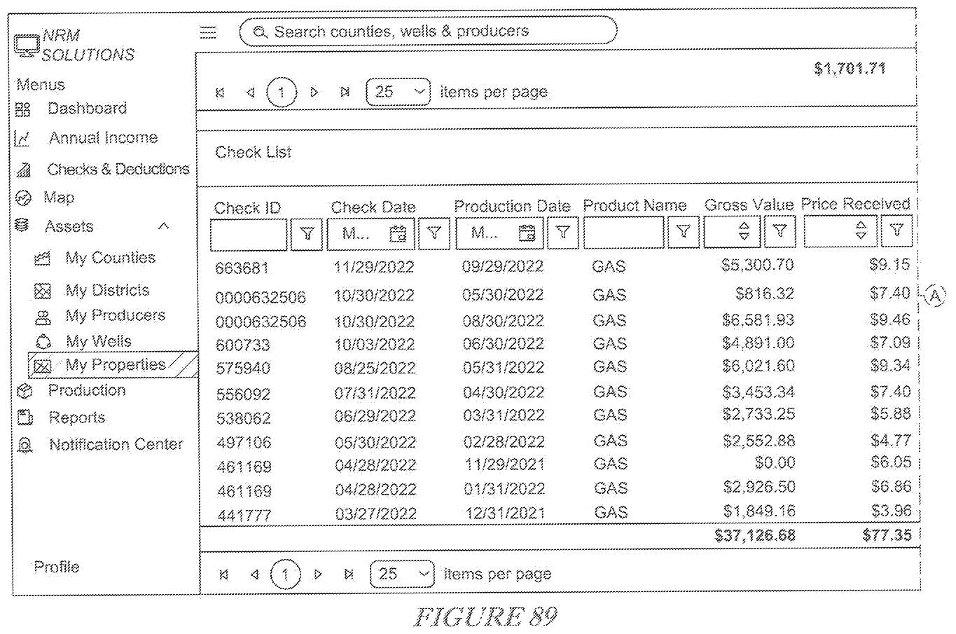

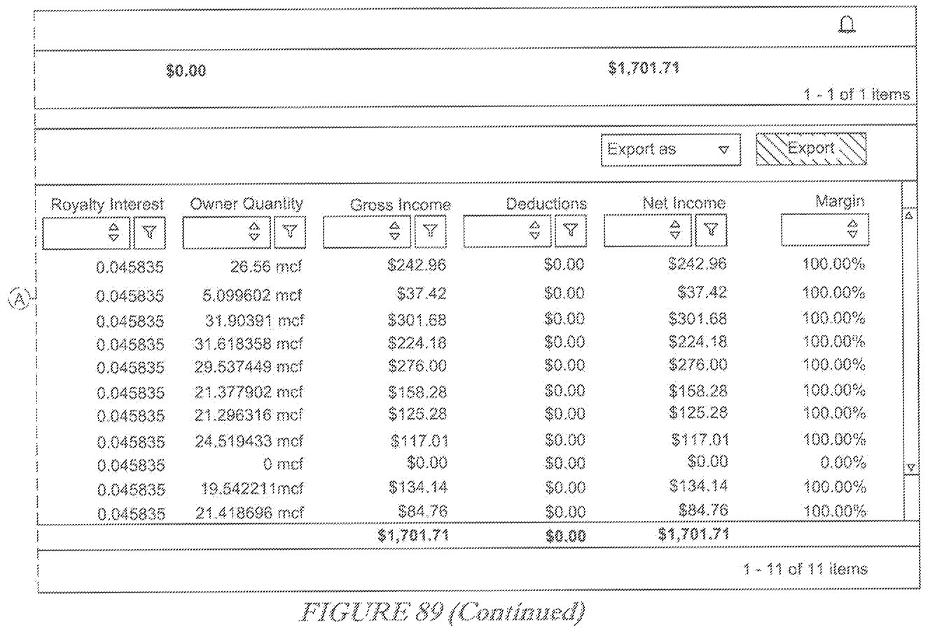

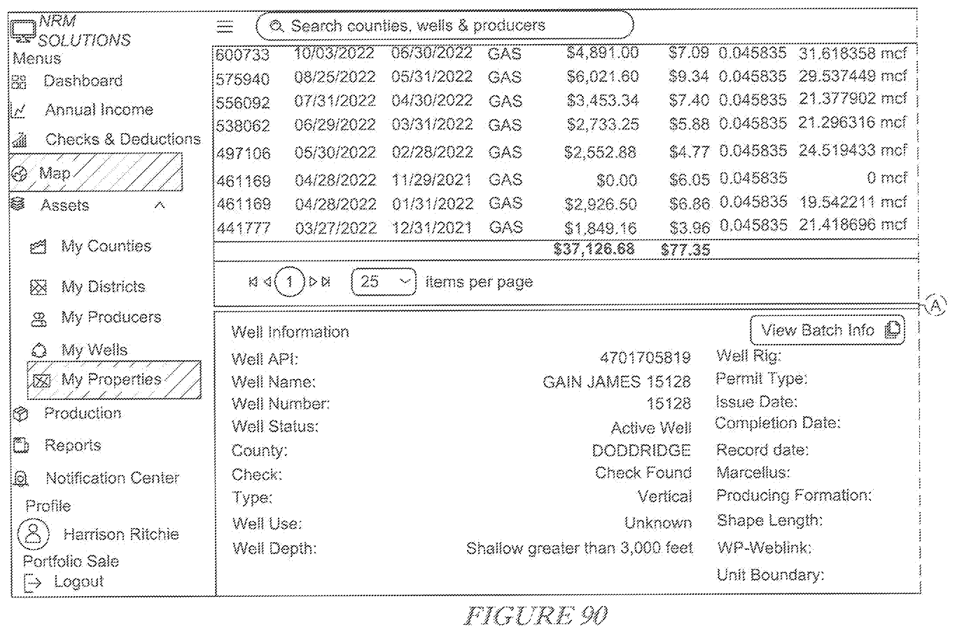

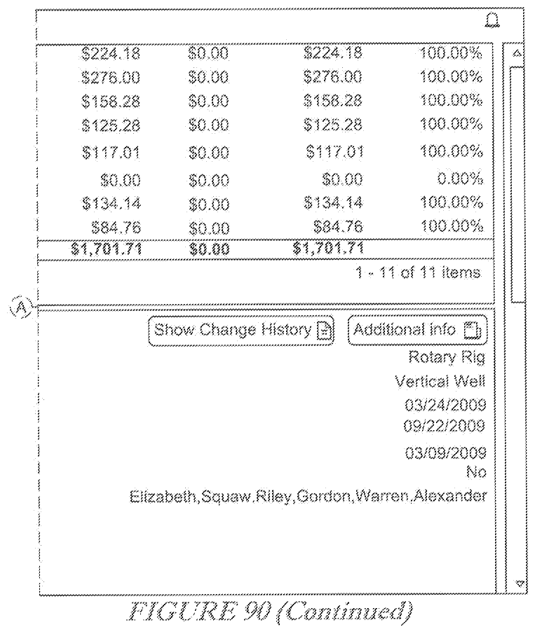

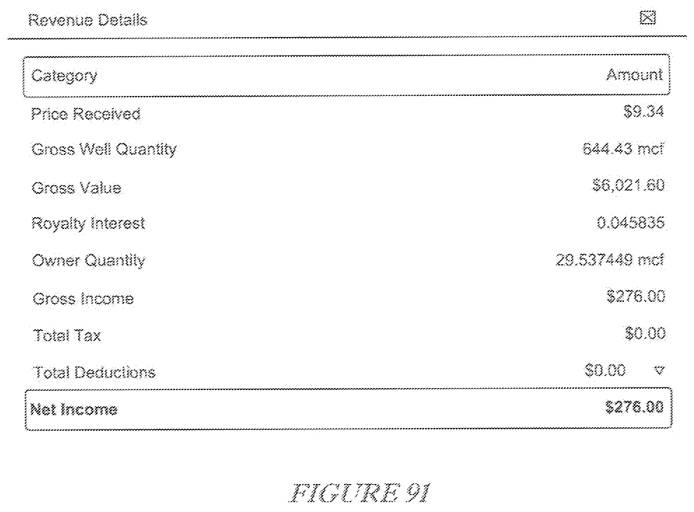

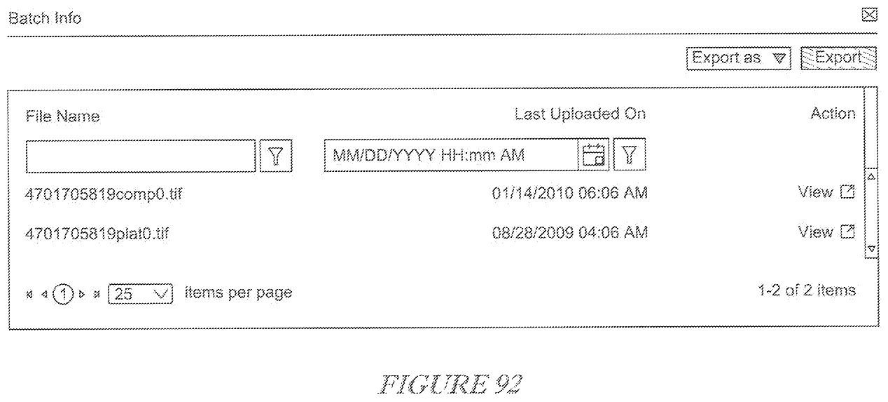

Additionally, user's may select information on the property screen to trigger display of a geographic mapping data for the property (FIG. 84), monthly income for the property (by check date in FIG. 85 or production date in FIG. 86), product list associated with the property including associated check lists (FIG. 87), graphical representations of constituent products generated at the property (FIG. 88) and a summed total of income provided by the wells of the property (sec FIG. 89). Additionally, with regard to each check listed in the check list, various additional data items may be displayed below the total check list when a user selects a particular check (see FIG. 90). Additionally, by selecting one of the icons in the upper right of the well information section, a user may trigger display of additional information (see Revenue Details of FIG. 91), trigger display of a screen in which stored documents may be exported from the system (FIG. 92), or a history of changes for the data may be reviewed (see FIG. 93).

By clicking the “view tax information” icon shown in the lower right hand of the screen in FIG. 83, one can trigger display of another screen that displays various information: (1) property information, (2) taxes, (3) assessment, and (4) payments. A user can view the current years or past years depending on when the county information came online. Additionally, a user can click “pay tax due” icon, which will trigger opening up the relevant county's tax website where a user can directly pay any unpaid property tax tickets.

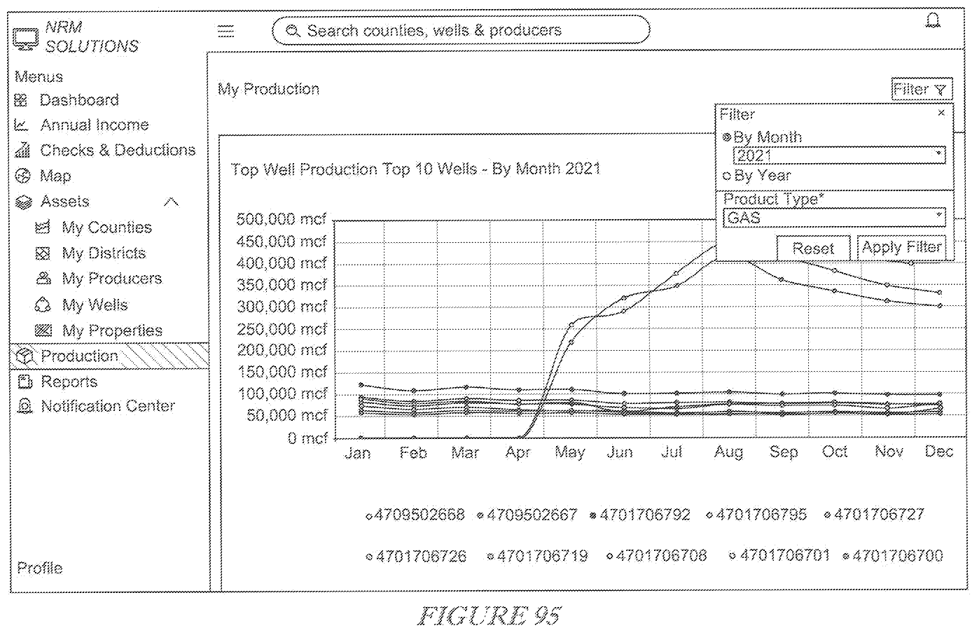

Within the overall menu of the inventive system's front end, a production screen(s) may be used to display aggregated data from publicly available regulatory agencies, e.g., the WVDEP, regarding reported production for each horizontal well in a user's portfolio. With this information, the owner or their service provider such as an analyst can view the production or decline curves for the top ten, fifteen, twenty or twenty-five wells (see FIG. 94). The production information may be displayed as a line graph or other types of graph customizable by the user. The user can view this information by month, year, and product type. The displayed information may be altered by filtering the constituent data as shown in FIG. 95.

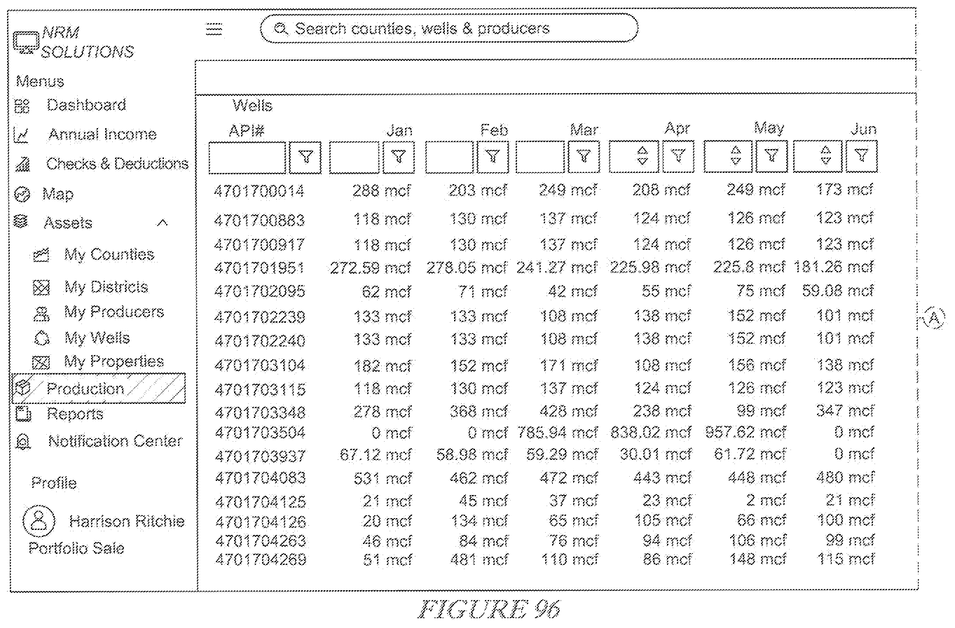

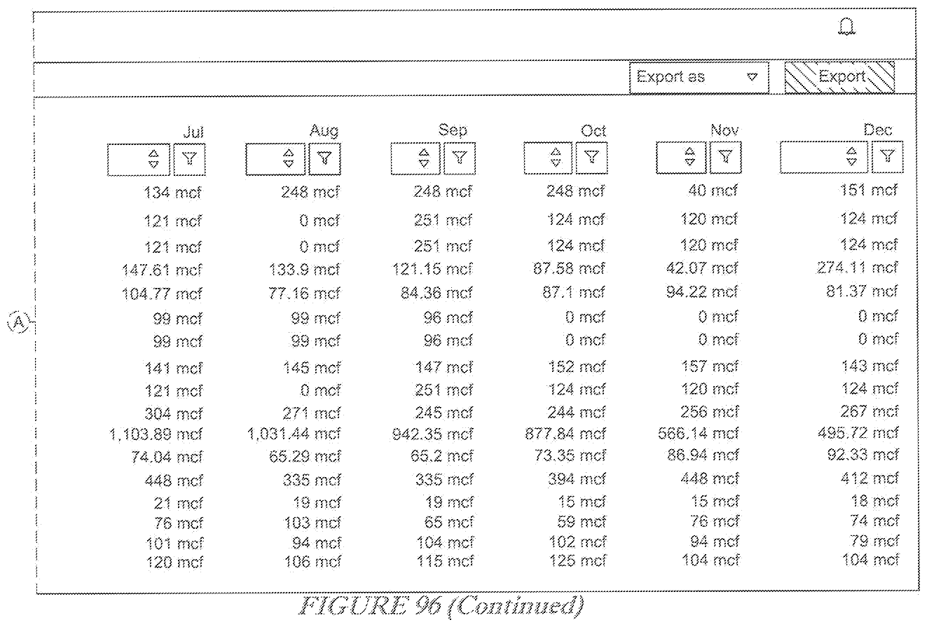

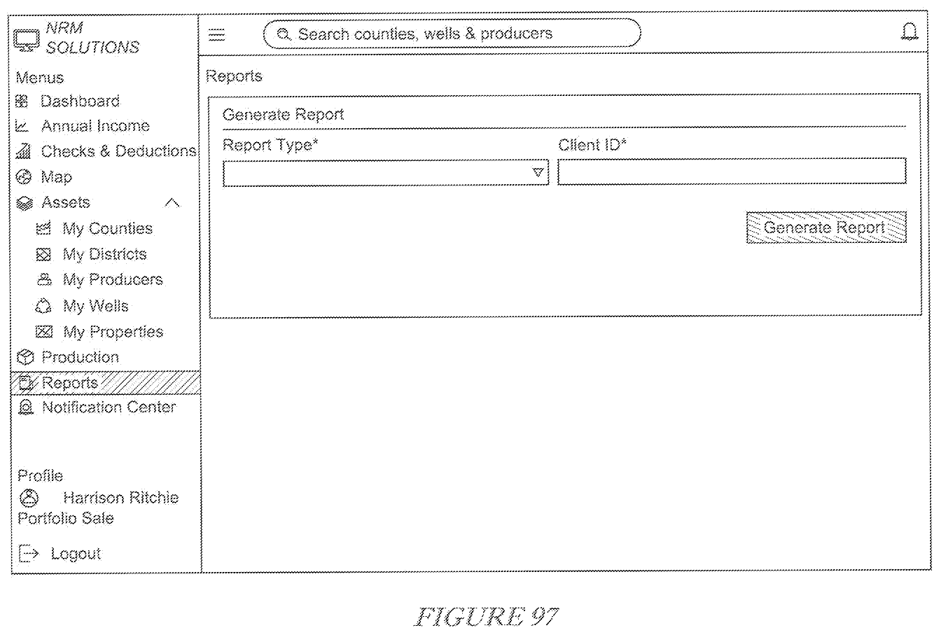

Below the graph, a comprehensive list of all horizontal wells within a user's portfolio may be listed (see FIG. 96). The system may aggregate the reported production for each well over the trailing twelve months so that, for example, a user can export this data in PDF or excel format. This feature has particular technical utility because the only other way to retrieve this data is by searching for and downloading the data for each individual well in a user's portfolio, which is too labor intensive and error prone to be feasible. Additionally, once complete, a user would then need to scrub the data (cleaning up for extraneous and inconsistent data format types) and place the data within a single spreadsheet. Thus, use of the inventive system drastically reduces the work and time required to provide this data even for a skilled analyst, let alone an untrained property owner.

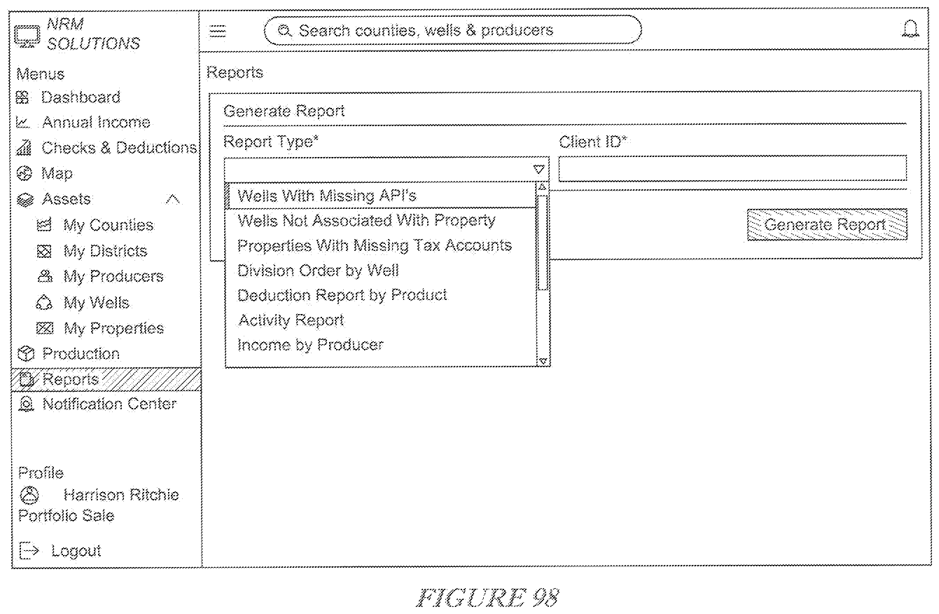

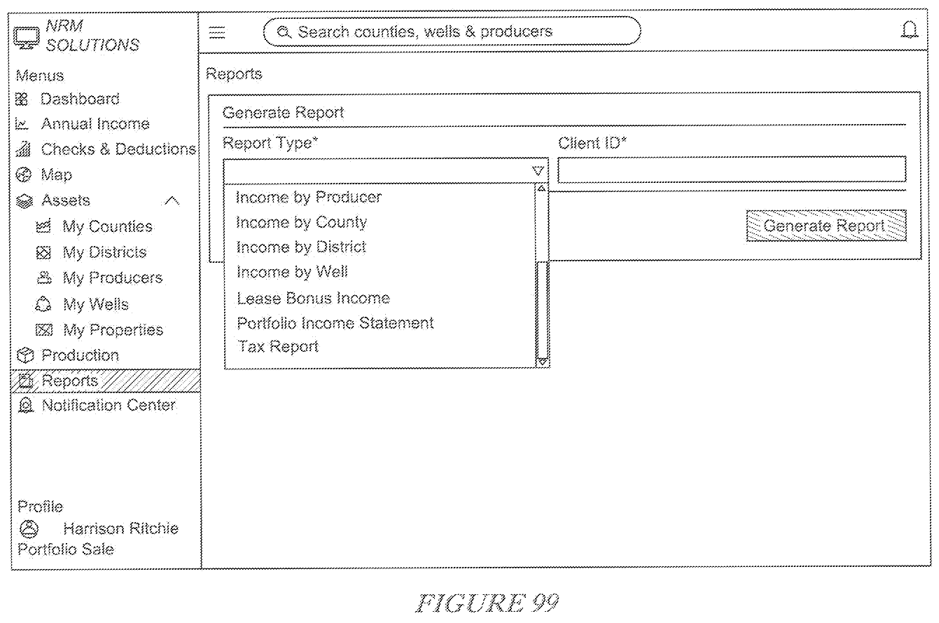

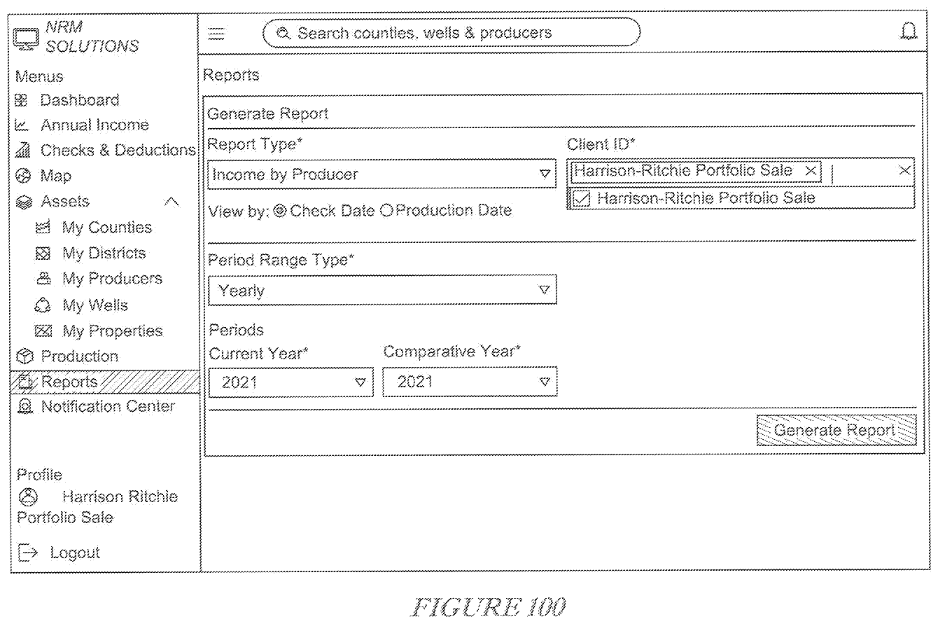

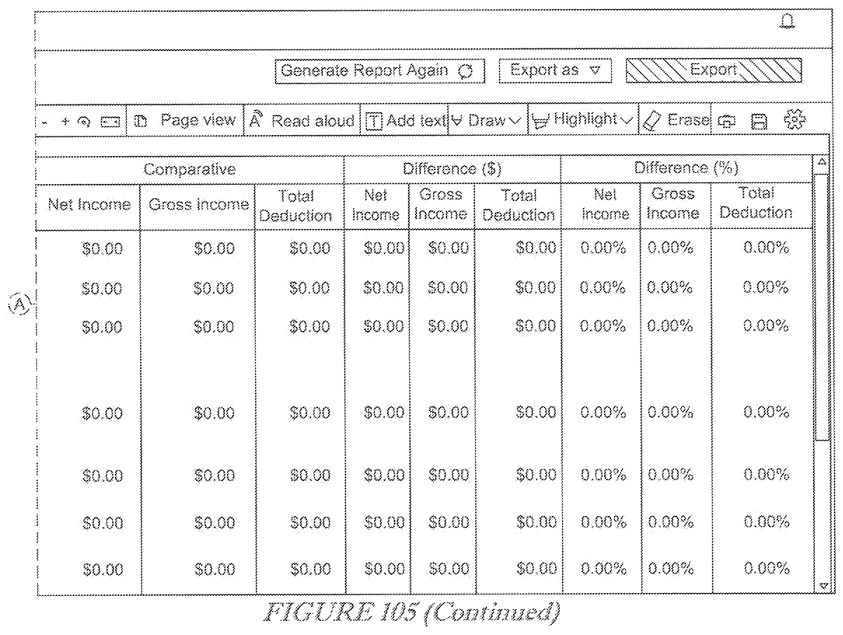

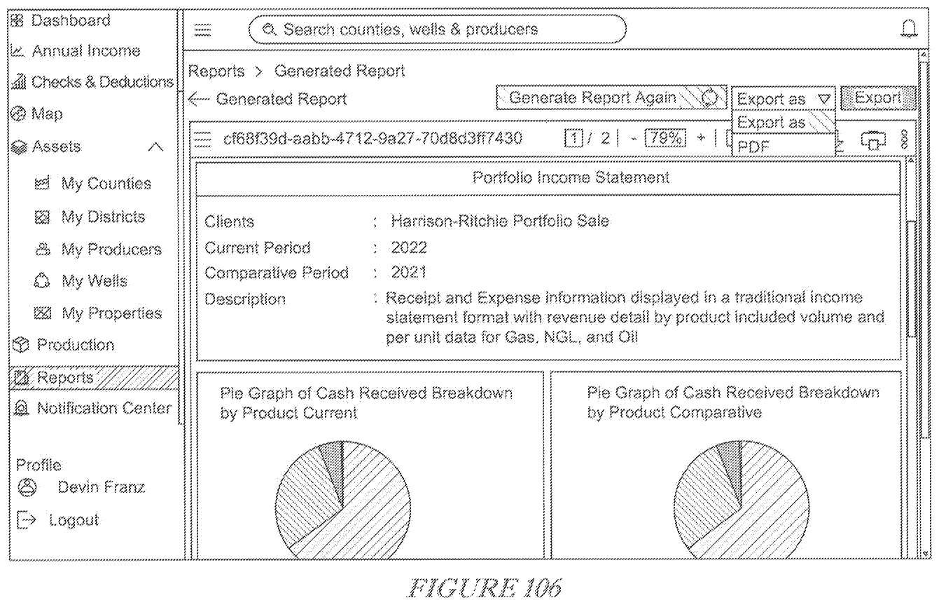

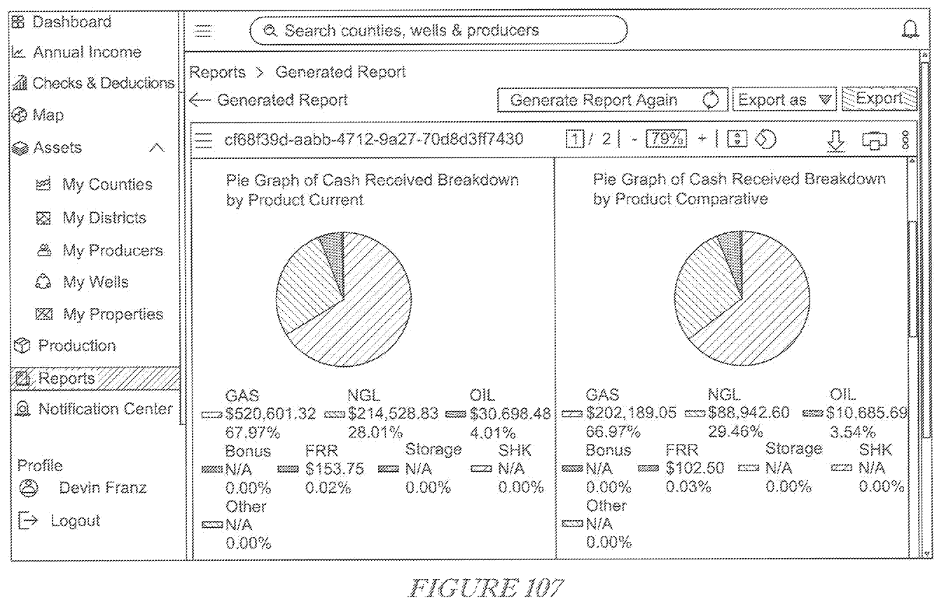

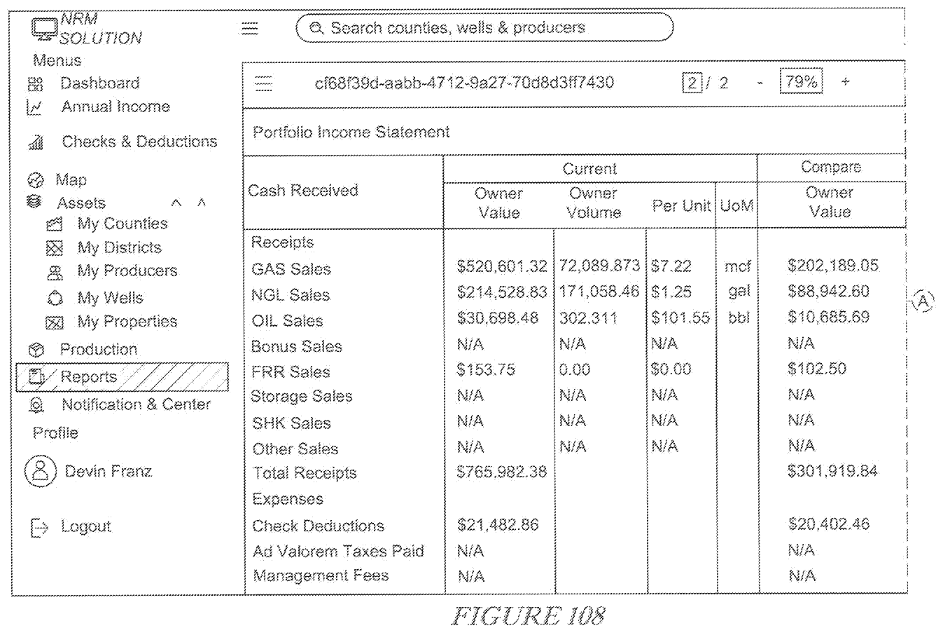

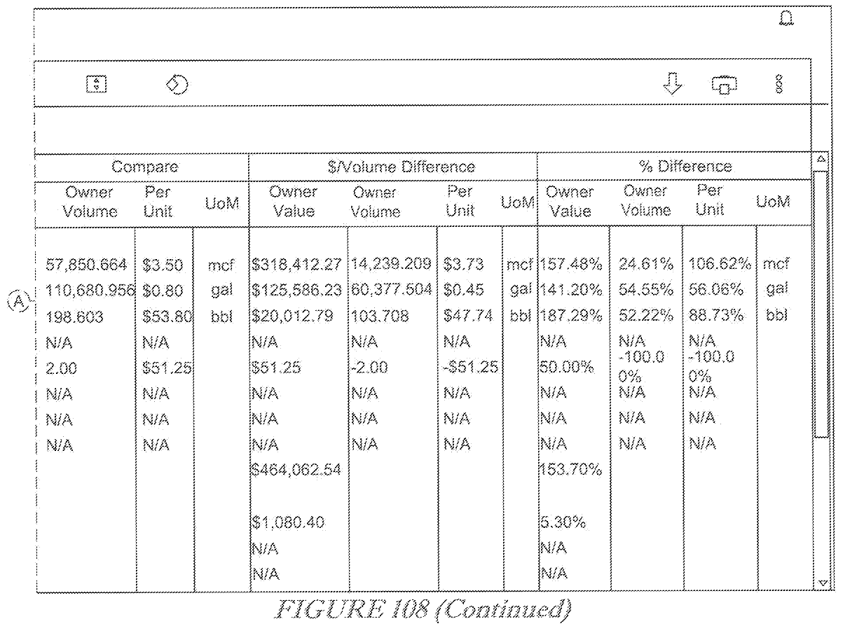

With this understanding of the difficulty and error prone conventional nature to analyzing this data in mind, the technical utility of the report functionality should be readily apparent. As shown in FIGS. 97-108, the system is configured to provide the ability generate various different types of reports simply by a user indicating a report type and specifying their client ID, e.g., property, well, district, etc. (see FIGS. 97-99). Based on the specified type of report and constituent data, additional information may be specified (e.g., reporting based on check data or production date, period range type and specified period for data to be included in the report; see FIG. 100).

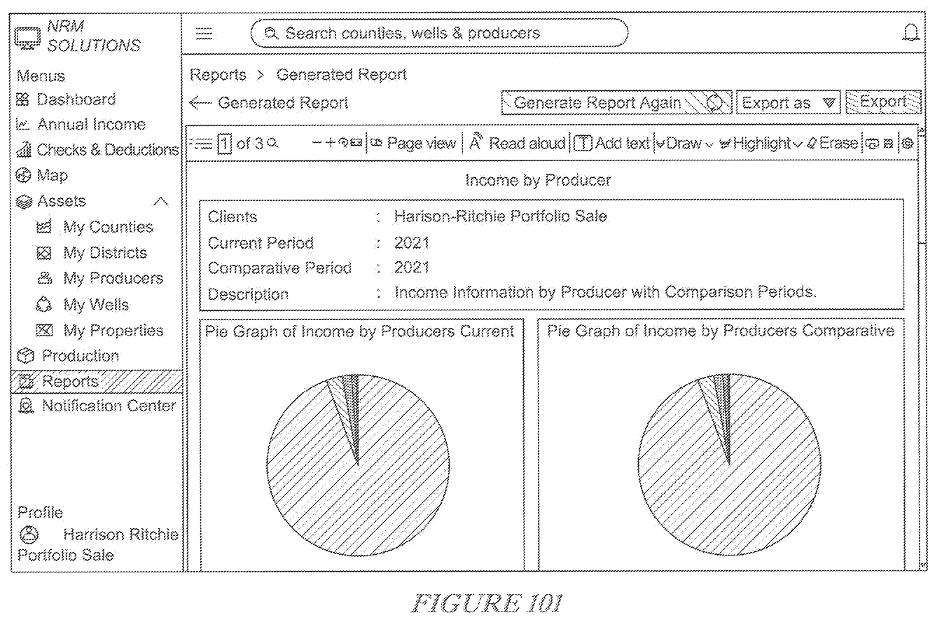

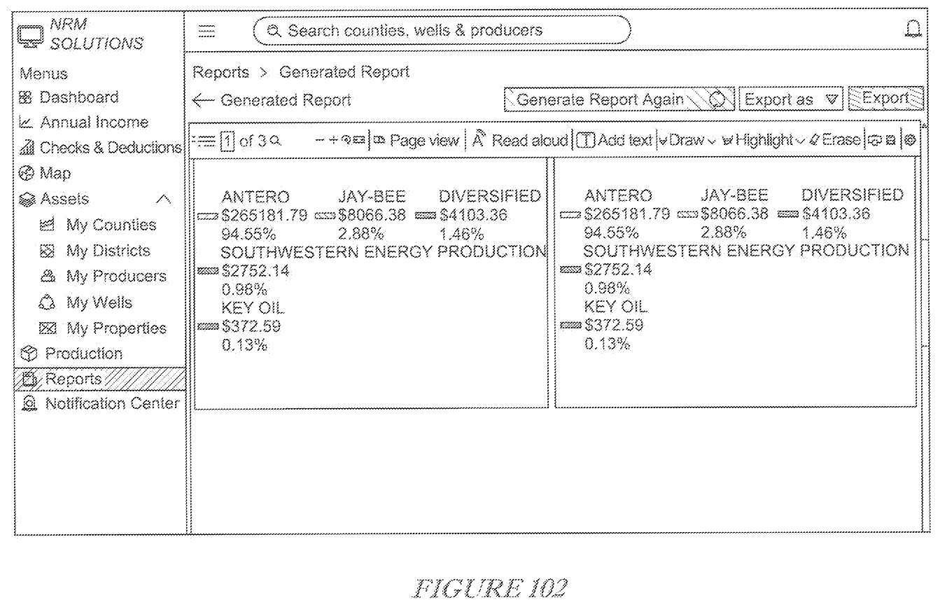

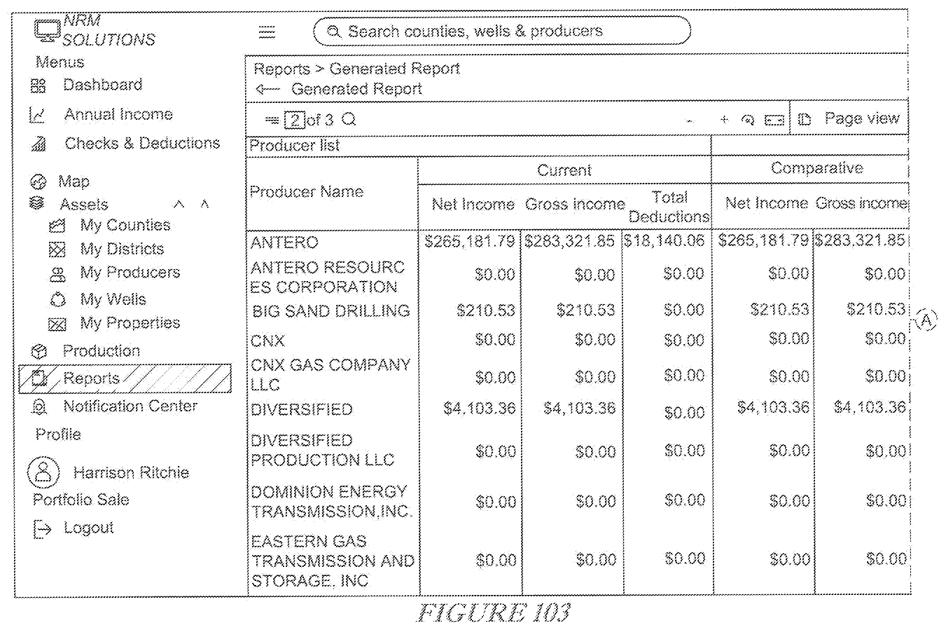

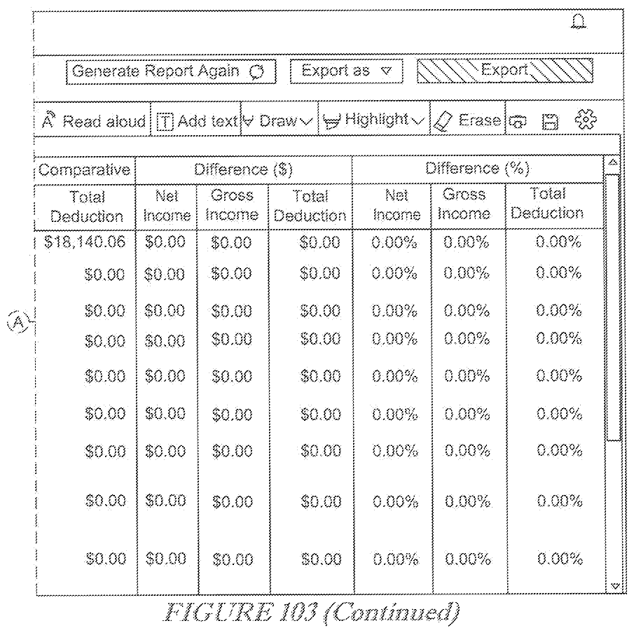

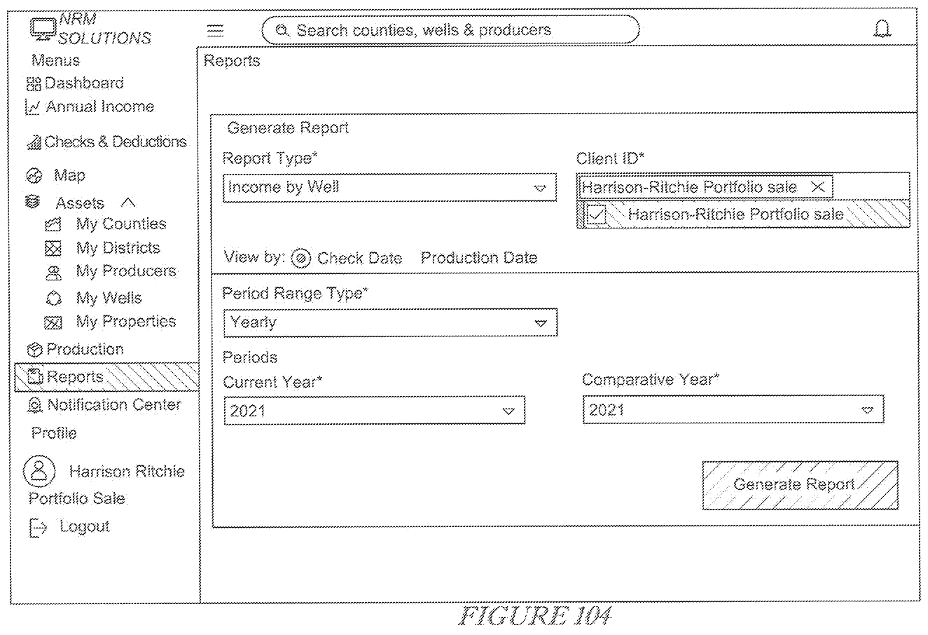

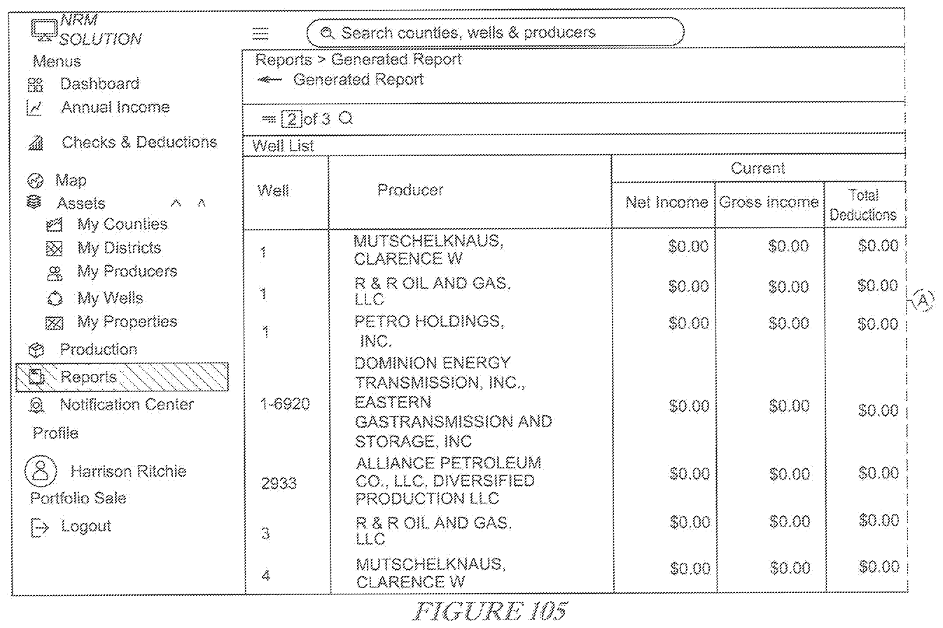

The report screen(s) provides the ability to generate thirteen pre-produced reports that are in the system including income reports, statements, tax information, mapping reports, API information, orphan wells, etc. Various reports include the possibility of generating associated graphical representations of the associated report data (see FIGS. 101-102), as well as generating a comprehensive list of all the producer/operators the user works with details enabling meaningful comparisons on user income and producer/operator deductions diminishing that income by percentage and dollar figures (see FIG. 103).

FIGS. 104-108 illustrate similar functionality and generated report data on income on a per well basis.

Of particular technical utility are two specific reports: a tax report and an income portfolio statement.

The tax report includes a comprehensive list of a user's tax information and taxes due for each individual county. By using the inventive system, the user can generate and submit this report with a check to the county where a user owes taxes for a user's property, thereby saving a user time because a user no longer needs to collect their tax tickets by hand or identify each tax ticket through a county website. Additionally, having the ability to individually and proactively address tax charges can save a user a percentage surcharge, e.g., three percent, if a user pays their taxes by check rather than electronically though the county's tax website.

Another interesting report is the income portfolio statement, which provides a user with an income statement for user properties for the current year compared to a past year. This is critically important because a user now has all information in one place and no longer needs to pay a Certified Public Accountant (CPA) for hours of labor to aggregate and generate a similar report. As a result, the user's tax or estate service provider can now leverage this information to help a user in a more efficient manner.

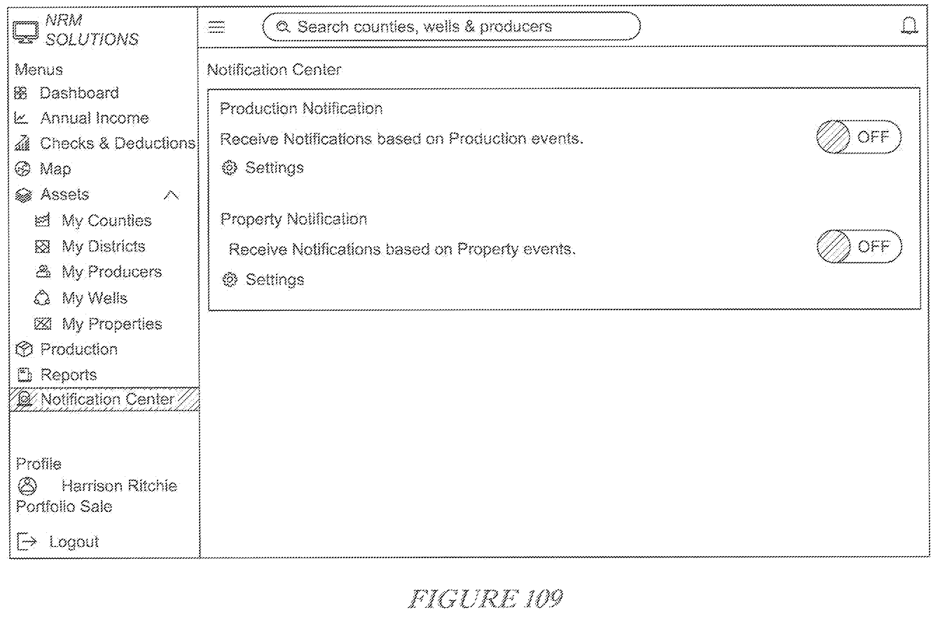

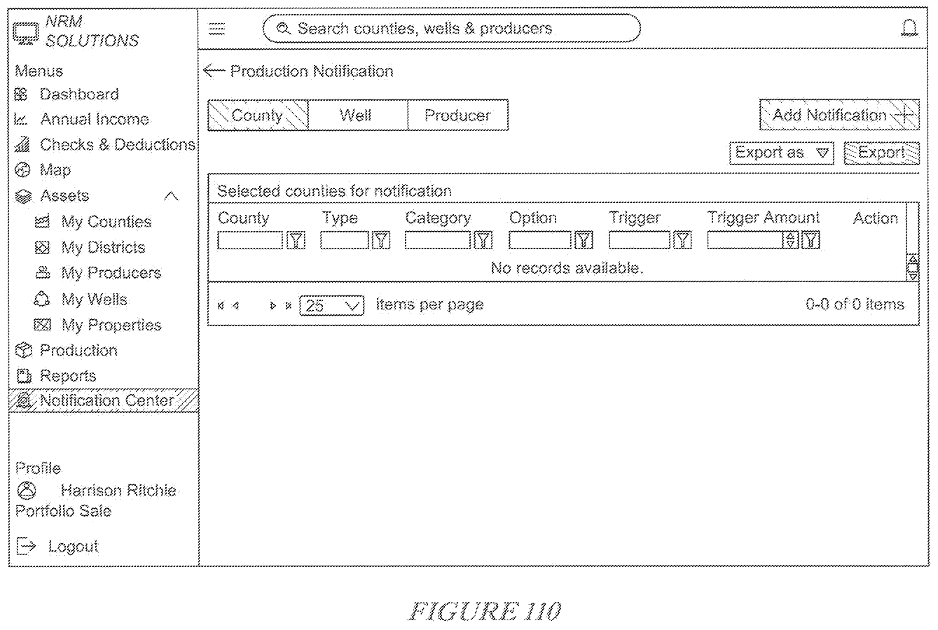

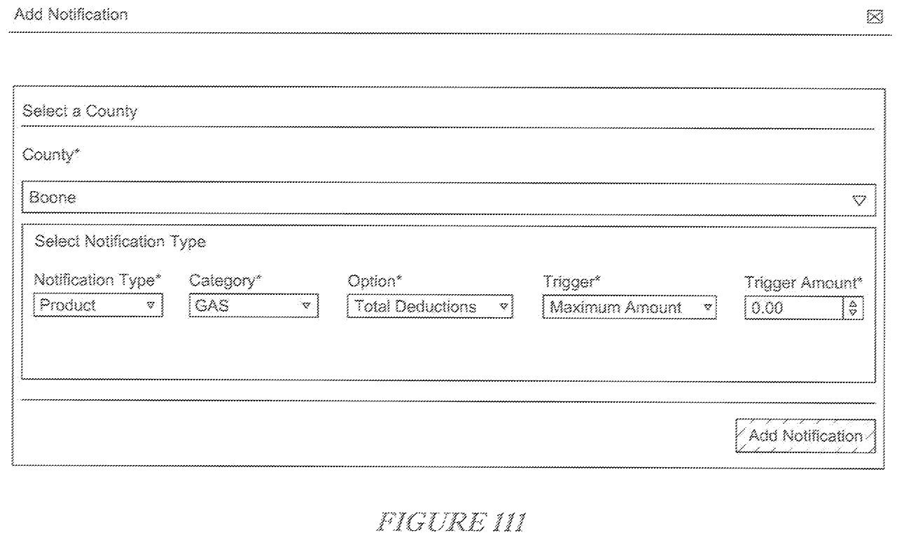

As illustrated in FIGS. 109-111, the inventive system may also include various screens associated with user notifications through a notification center. Under the Notification Center, a user can turn on various notifications that are automatically generated by the system based on monitored production, tax, income or other status data based on a property basis or well basis.

For example, with regard to production notification, a user can add a notification by county, well or producer. For example, if a user choose to add a county notification, a user would then select the county, select the product such as gas, select the option such as price received, quantity, taxes due, or total deduction, select the trigger (maximum or minimum) and the trigger amount.

In addition, and of particular technical utility, property specific notifications enable a user to select a property that is not producing and set a trigger for production, e.g., 1 mcf of gas. Thus, when a new well comes online and produces any amount of gas, the system generates an alert for the user so that they will know to look for a new royalty check.

The term “user interface” is used throughout the present disclosure and is meant to refer to a human-machine interface that may be implemented in various different technological implementations, for example via a Graphical User Interface (GUI) by, e.g., a HyperText Markup Language (HTML) code served by a server, e.g., through a browser resident on a user's computing device.

Disclosed embodiments of the invention may be provided by various different technical implementations, for example, a computer program product implemented as a computer readable storage medium (or media) having computer readable program instructions thereon for causing a processor to provide the functionality disclosed herein.

Such computer readable storage mediums may be implemented in whole or in part as, e.g., electronic storage devices, a magnetic storage device, an optical storage device, an electromagnetic storage device, a semiconductor storage device, or the like such as a portable memory device, a Random Access memory (RAM), a Read-Only Memory (ROM), etc.

Reference is made throughout the disclosure to the Internet; however, it should be understood that various data sources may be accessed through any number of communication networks including local area networks, wide area networks and/or a wireless networks. Likewise, it should be understood that the present invention's functionality is disclosed in its comprehensive technical context and may be implemented in any of a variety of computer languages known to one of ordinary skill that enable the disclosed functionality.

It should be understood that the functionality disclosed herein may be implemented in whole or in part using computer readable program instructions stored in memory and provided to a computer processor to transform the constituent parts into a special purpose computer configured to provide the specialized functionality disclosed herein.

It should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously. Thus, various components of the invention may be provided in alternative combinations operated by, under the control of or on the behalf of various different entities or individuals.

It should be understood that various aspects of the disclosed embodiments and the disclosed functionality are implemented using software running on a plurality of networked computers.

It should further be understood that various connections are set forth between elements in the description herein; however, these connections in general, and, unless otherwise specified, may be either direct or indirect, either permanent or transitory, and either dedicated or shared, and that this specification is not intended to be limiting in this respect.

Additionally, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on a plurality of general purpose equipment via software implementations providing the functionality described herein. Thus, it should be understood that components disclosed herein may be used in conjunction with, as described above, other components, for example a computer processor.

It should be understood that the operations explained herein may be implemented in conjunction with, or under the control of, one or more general purpose computers running software algorithms to provide the presently disclosed functionality and turning those computers into specific purpose computers.

Moreover, those skilled in the art will recognize, upon consideration of the above teachings, that the above exemplary embodiments may be based upon use of one or more programmed processors programmed with a suitable computer program. However, the disclosed embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Moreover, it should be understood that control and cooperation of the above-described components may be provided using software instructions that may be stored in a tangible, non-transitory storage device such as a non-transitory computer readable storage device storing instructions which, when executed on one or more programmed processors, carry out the above-described method operations and resulting functionality. In this case, the term non-transitory is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments. Such alternative storage devices should be considered equivalents.

While certain illustrative embodiments have been described, it is evident that many alternatives, modifications, permutations and variations will become apparent to those skilled in the art in light of the foregoing description. Accordingly, the various embodiments of, as set forth above, are intended to be illustrative, not limiting. Various changes may be made without departing from the spirit and scope of the invention.

As a result, it will be apparent for those skilled in the art that the illustrative embodiments described are only examples and that various modifications can be made within the scope of the invention as defined in the appended claims.

We claim:

1. A mineral rights management system configured to provide user interface enabled data analysis of associated data to facilitate owner and analyst understanding of data input from disparate data sources and in disparate data formats, the system comprising:
one or more communication interfaces configured to request, access and receive the data input from the disparate data sources;
one or more modules for analyzing and altering the data received from the disparate data sources to conform the disparate data formats to enable aggregation of the data for subsequent storage, analysis and display, wherein conformance eliminates or alters publicly available but inconsistent format/structured data as well as data input by a user for consistency and aggregation;
at least one database for storing the aggregated data;
one or more processing modules for generating and outputting a user interface coupled to the database of aggregated data, the user interface being populated with the aggregated data and analytics data derived from the aggregated data; and
at least one computer processor configured to run software controlling the operation of the one or more communication interfaces, the one or more pre-processing data analytics modules, the one or more processing modules for generating user interface data,
wherein the user interface displays analytics data on a dashboard that outputs data on a user's per property and per well basis that is sortable by state, county and district criteria and is displayable base on associated financial note date or production date criteria over a user set, customizable time period and user set, customizable reporting periods, and
wherein the user interface is configured to receive input data from a user specifying at least one automated alert generated based on the aggregated data and analysis of the aggregated data performed by the one or more processing modules.

2. The mineral rights management system of claim 1, wherein the user interface includes a plurality of screens including fields and functionality associated with annual income received by a user for aggregated data relating to mineral rights of the user.

3. The mineral rights management system of claim 2, wherein the user interface is configured to include fields and functionality associated with checks and deductions for the annual income received by a user for aggregated data relating to mineral rights of the user.

4. The mineral rights management system of claim 2, wherein the user interface is configured to include geographic mapping data associated the aggregated data relating to mineral rights of the user.

5. The mineral rights management system of claim 2, wherein the user interface is configured to include analytics data generated based on the received data for the annual income received by the user relating to mineral rights.

6. The mineral rights management system of claim 5, wherein the analytics data generated based on the received data for the annual income received by the user relating to mineral rights includes data aggregated and displayed on a per county basis.

7. The mineral rights management system of claim 5, wherein the analytics data generated based on the received data for the annual income received by the user relating to mineral rights includes data aggregated and displayed on a per district basis.

8. The mineral rights management system of claim 5, wherein the analytics data generated based on the received data for the annual income received by the user relating to mineral rights includes data aggregated and displayed on a per property basis.

9. The mineral rights management system of claim 5, wherein the analytics data generated based on the received data for the annual income received by the user relating to mineral rights includes data aggregated and displayed on a per well basis.

10. The mineral rights management system of claim 5, wherein the analytics data generated based on the received data for the annual income received by the user relating to mineral rights includes data aggregated and displayed on a per producer basis.

11. The mineral rights management system of claim 2, wherein the user interface includes search functionality for searching for and locating any data point stored within the database of the system.

12. The mineral rights management system of claim 2, wherein the user interface includes functionality for a user to control generation and export of a report providing data indicating reported production for each well within a user's mineral rights portfolio over a trailing twelve month period.

13. The mineral rights management system of claim 2, wherein the user interface includes functionality enabling the user to export tax report data and pay for tax fees owed by the user for properties included in the user's mineral rights portfolio.

14. The mineral rights management system of claim 2, wherein the user interface includes functionality enabling the user to export an income statement for user properties for the current year compared to a past year for properties included in the user's mineral rights portfolio.

15. A method of providing a mineral rights management system configured to provide user interface enabled data analysis of associated data to facilitate owner and analyst understanding of data input from disparate data sources and in disparate data formats, the method comprising:
requesting, accessing and receiving the data input from the disparate data sources using one or more communication interfaces;
analyzing and altering the data received from the disparate data sources to conform the disparate data formats to enable aggregation of the data for subsequent storage, analysis and display, wherein conformance eliminates or alters publicly available but inconsistent format/structured data as well as data input by a user for consistency and aggregation;
storing the aggregated data in at least one database; and
generating and outputting a user interface coupled to the database of aggregated data, the user interface being populated with the aggregated data and analytics data derived from the aggregated data;
wherein the user interface displays analytics data on a dashboard that outputs data on a user's per property and per well basis that is sortable by state, county and district criteria and is displayable base on associated financial note date or production date criteria over a user set, customizable time period and user set, customizable reporting periods, and
wherein the user interface is configured to receive input data from a user specifying at least one automated alert generated based on the aggregated data and analysis of the aggregated data performed by the one or more processing modules.

16. The mineral rights management method of claim 15, wherein the user interface includes a plurality of screens including fields and functionality associated with annual income received by a user for aggregated data relating to mineral rights of the user.

17. The mineral rights management method of claim 16, wherein the user interface is configured to include fields and functionality associated with checks and deductions for the annual income received by a user for aggregated data relating to mineral rights of the user.

18. The mineral rights management method of claim 16, wherein the user interface is configured to include geographic mapping data associated the aggregated data relating to mineral rights of the user.

19. The mineral rights management method of claim 16, wherein the user interface is configured to include analytics data generated based on the received data for the annual income received by the user relating to mineral rights.

20. The mineral rights management method of claim 19, wherein the analytics data generated based on the received data for the annual income received by the user relating to mineral rights includes data aggregated and displayed on a per county basis.

21. The mineral rights management method of claim 19, wherein the analytics data generated based on the received data for the annual income received by the user relating to mineral rights includes data aggregated and displayed on a per district basis.

22. The mineral rights management method of claim 19, wherein the analytics data generated based on the received data for the annual income received by the user relating to mineral rights includes data aggregated and displayed on a per property basis.

23. The mineral rights management method of claim 19, wherein the analytics data generated based on the received data for the annual income received by the user relating to mineral rights includes data aggregated and displayed on a per well basis.

24. The mineral rights management method of claim 19, wherein the analytics data generated based on the received data for the annual income received by the user relating to mineral rights includes data aggregated and displayed on a per producer basis.

25. The mineral rights management method of claim 16, wherein the user interface includes search functionality for searching for and locating any data point stored within the database of the system.

26. The mineral rights management method of claim 16, wherein the user interface includes functionality for a user to control generation and export of a report providing data indicating reported production for each well within a user's mineral rights portfolio over a trailing twelve month period.

27. The mineral rights management method of claim 16, wherein the user interface includes functionality enabling the user to export tax report data and pay for tax fees owed by the user for properties included in the user's mineral rights portfolio.

28. The mineral rights management method of claim 16, wherein the user interface includes functionality enabling the user to export an income statement for user properties for the current year compared to a past year for properties included in the user's mineral rights portfolio.
